(19) United States
(12) Patent Application Publication
(10) Pub. No.: US 2023/0276296 A1
(43) Pub. Date: Aug. 31, 2023

(54) METHOD AND APPARATUS FOR OPERATION OF A MAC LAYER SUPPORTING A CELL GROUP DEACTIVATION/ACTIVATION PROCEDURE IN A NEXT-GENERATION MOBILE COMMUNICATION SYSTEM

(71) Applicant: Samsung Electronics Co., Ltd., Suwon-si (KR)

(72) Inventors: Donggun KIM, Suwon-si (KR); Jaehyuk JANG, Suwon-si (KR)

(21) Appl. No.: 18/173,442

(22) Filed: Feb. 23, 2023

(30) Foreign Application Priority Data
Feb. 25, 2022 (KR) 10-2022-0025036

(51) Int. Cl. H04W 28/02

(52) U.S. Cl. CPC H04W 28/0278

(57) ABSTRACT

The disclosure relates to a 5G or 6G communication system for supporting a higher data transmission rate. A method and an apparatus for quickly activating or deactivating a cell/cell group are provided. The method may include identifying whether an uplink (UL) data for a logical channel which belongs to a logical channel group (LCG) becomes available to a medium access control (MAC) entity associated with an activated cell group, identifying whether the UL data belongs to a first logical channel with higher priority than a priority of at least one logical channel containing available UL data which belongs to at least one LCG, in case that the UL data becomes available to the MAC entity associated with the activated cell group, and determining that a buffer state report (BSR) is triggered, in case that the UL data belongs to the first logical channel.

### CROSS-REFERENCE TO RELATED APPLICATION(S)

This application is based on and claims priority under 35 U.S.C. § 119(a) of a Korean patent application number 10-2022-0025036, filed on Feb. 25, 2022, in the Korean Intellectual Property Office, the disclosure of which is incorporated by reference herein in its entirety.

### BACKGROUND

### 1. Field

The disclosure relates to a method and apparatus capable of quickly activating a cell in a next-generation mobile communication system.

### 2. Description of Related Art

5G mobile communication technologies define broad frequency bands such that high transmission rates and new services are possible, and can be implemented not only in “Sub 6 GHz” bands, such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In a next-generation mobile communication system, carrier aggregation (CA) or dual connectivity (DC) may be used to provide a service with a high data rate and low transmission delay to a terminal. However, there is a need for a method for preventing a processing delay that may occur when carrier aggregation or dual connectivity is configured and activated for a terminal connected to a network, or when carrier aggregation or dual connectivity is used and then deactivated. Particularly, if a terminal maintains a plurality of cells active to use carrier aggregation or dual connectivity, the terminal needs to perform physical downlink control channel (PDCCH) monitoring for each cell, and thus battery consumption of the terminal may be significant. On the other hand, if the plurality of cells is maintained deactivated to reduce battery consumption of the terminal, a data transmission or reception delay may occur due to a delay occurring when activating the plurality of cells to use carrier aggregation or dual connectivity. In the above or in the disclosure, a cell may refer to a primary cell (PCell), a secondary cell (SCell) (e.g., SCell configured in a master cell group (MCG)), a primary secondary cell (PSCell) (e.g., PCell of a secondary cell group (SCG)), or an SCell (e.g., SCell configured in a secondary cell group (SCG)).

Aspects of the disclosure are to address at least the above-mentioned problems and/or disadvantages and to provide at least the advantages described below. Accordingly, an aspect of the disclosure is to provide a method and apparatus for operation of a mac layer supporting a cell group deactivation/activation procedure in a next-generation mobile communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes identifying whether an uplink (UL) data for a logical channel which belongs to a logical channel group (LCG) becomes available to a medium access control (MAC) entity associated with an activated cell group, identifying whether the UL data belongs to a first logical channel with higher priority than a priority of at least one logical channel containing available UL data which belongs to at least one LCG, in case that the UL data becomes available to the MAC entity associated with the activated cell group, and determining that a buffer state report (BSR) is triggered, in case that the UL data belongs to the first logical channel.

In accordance to another aspect of the disclosure, a terminal is provided. The terminal includes at least one processor configured to identify whether UL data for a logical channel which belongs to a LCG becomes available to a MAC entity associated with an activated cell group, identify whether the UL data belongs to a first logical channel with higher priority than a priority of at least one logical channel containing available UL data which belongs to at least one LCG, in case that the UL data becomes available to the MAC entity associated with the activated cell group, and determine that a BSR is triggered, in case that the UL data belongs to the first logical channel.

According to one embodiment of the disclosure, in a next-generation mobile communication system, a new dormant or suspension mode or a deactivated mode may be configured to enable a terminal in a RRC connected mode, which has established a connection with a network, to quickly activate and deactivate carrier aggregation or dual connectivity.

In addition, according to one embodiment of the disclosure, by operating a new dormant (hibernation, dormancy, or suspension) mode in a bandwidth part-level, cell-level, or cell group-level (e.g., for a secondary cell group), the terminal can quickly activate carrier aggregation or dual connectivity, and can reduce battery consumption.

In addition, according to one embodiment of the disclosure, when a base station indicates the terminal to activate a cell (PCell, PSCell, or SCell), the terminal temporarily configures, allocates, or sends many transmission resources capable of performing channel measurement, and the terminal reports the channel measurement results to the base station based on the channel measurement, thereby quickly activating a cell or cell group.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a long-term evolution (LTE) system to which according to an embodiment of the disclosure;

FIG. 2 is a diagram illustrating a radio protocol structure in a long term evolution (LTE) system to which according to an embodiment of the disclosure;

FIG. 3 is a diagram illustrating a next generation mobile communication system to which according to an embodiment of the disclosure;

FIG. 4 is a diagram illustrating a radio protocol structure of a next generation mobile communication system to which according to an embodiment of the disclosure;

FIG. 5 is a diagram illustrating a procedure for providing a service to a terminal by efficiently using a very wide frequency bandwidth in the next-generation mobile communication system according to an embodiment of the disclosure;

FIG. 6 is a diagram illustrating a procedure for a terminal to switch from a radio resource control (RRC) idle mode to an RRC connected mode, and a procedure for configuring bearer configuration information, cell group or cell configuration information, or channel measurement configuration information for connection to a terminal, in the next-generation mobile communication system according to an embodiment of the disclosure;

FIG. 7 is a diagram illustrating a bandwidth part-specific state transition procedure or a bandwidth part switching procedure according to an embodiment of the disclosure;

FIG. 8 is a diagram illustrating a discontinuous reception (DRX) configuration or a DRX operation method capable of saving a battery power of a terminal according to an embodiment of the disclosure;

FIG. 9 is a diagram illustrating a concept of a method of operating a dormant bandwidth part in an activated secondary cell (SCell) or primary cell (PSCell) proposed according to an embodiment of the disclosure;

FIG. 10 is a diagram illustrating an embodiment in which the embodiments proposed in the disclosure are extended and applied to a terminal in an RRC inactive mode according to an embodiment of the disclosure;

FIG. 11 is a diagram illustrating an example of a signaling procedure of configuring or releasing dual connectivity, or activating, resuming, suspending, or deactivating a secondary cell group for which dual connectivity is configured in a next-generation mobile communication system according to an embodiment of the disclosure;

FIG. 12 is a diagram illustrating a second signaling procedure of configuring or releasing dual connectivity, or configuring, releasing, activating, resuming, suspending, or deactivating a secondary cell group for which dual connectivity is configured according to an embodiment of the disclosure;

FIG. 13 is a diagram illustrating a third signaling procedure of configuring or releasing dual connectivity, or configuring, releasing, activating, resuming, suspending, or deactivating a secondary cell group for which dual connectivity is configured according to an embodiment of the disclosure;

FIG. 14 is a diagram illustrating an operation of a terminal according to an embodiment of the disclosure;

FIG. 15 illustrates a structure of a terminal to which according to an embodiment of the disclosure; and

FIG. 16 is a block diagram illustrating a structure of a base station in a communication system to which according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description of the disclosure, when it is determined that a detailed description of related functions or configurations may unnecessarily obscure the subject matter of the disclosure, the detailed description will be omitted.

Terms for identifying access nodes, terms referring to network entities, terms referring to messages, terms referring to interfaces between network entities, and terms referring to various kinds of identification information, used in the following description, are examples for convenience of description. Therefore, the disclosure may not be limited by the terminologies provided below, and other terms that indicate subjects having equivalent technical meanings may be used.

Hereinafter, terms and names defined by the 3rd generation partnership project long term evolution (3GPP LTE) will be used in the disclosure for convenience of description. However, the disclosure is not limited to the terms and names, and is identically applicable to other systems following different standards. The term “eNB” as used in the disclosure may be used interchangeably with the term “gNB” for convenience of description. For example, a base station described as the eNB may represent the gNB.

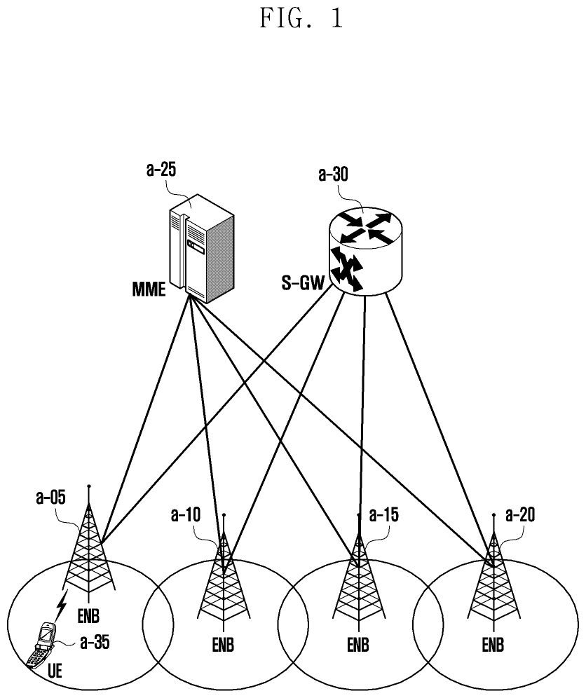

FIG. 1 is a diagram illustrating a structure of an LTE system to which according to an embodiment of the disclosure.

Referring to FIG. 1, a radio access network of the LTE system is configured to include next-generation base stations (evolved node B, hereinafter, ENB, Node B, or base station) a-05 and a-10, a-15 and a-20, a mobility management entity (MME) a-25, and a serving-gateway (S-GW) a-30. User equipment (hereinafter, UE or terminal) a-35 may access an external network through the ENBs a-05 to a-20 and the S-GW a-30.

Referring to FIG. 1, the ENBs a-05 to a-20 correspond to the existing node B of a universal mobile telecommunications system (UMTS). The ENB is connected to the UE a-35 through a radio channel and performs more complicated role than the existing node B. In the LTE system, in addition to a real-time service like a voice over internet protocol (VoIP) through the Internet protocol, all the user traffics are served through a shared channel and therefore an apparatus for collecting and scheduling status information, such as a buffer status, an available transmission power status, and a channel state of the UEs is required. Hence, the ENBs a-05 to a-20 take charge of the collecting and scheduling. One ENB generally controls a plurality of cells. For example, to implement a data transmission rate of 100 megabits per second (Mbps), the LTE system uses, as a radio access technology, orthogonal frequency division multiplexing (hereinafter, OFDM) in a bandwidth of for, e.g., 20 megahertz (MHz). Further, an adaptive modulation and coding (hereinafter, AMC) determining a modulation scheme and a channel coding rate depending on the channel status of the terminal is applied. The S-GW a-30 is an apparatus for providing a data bearer and generates or removes the data bearer according to the control of the MME a-25. The MME is an apparatus for performing a mobility management function for the terminal and various control functions and is connected to a plurality of base stations.

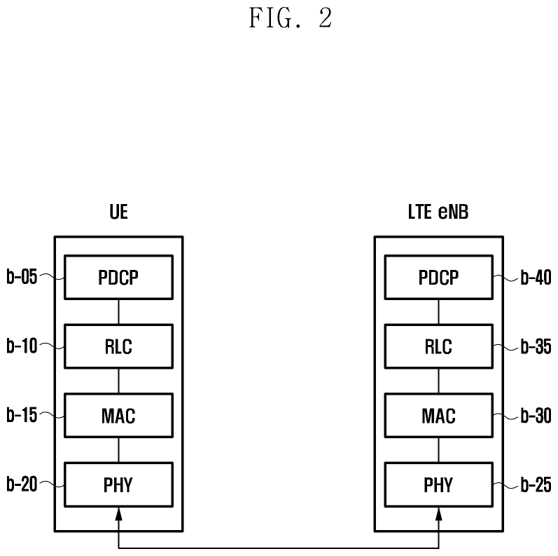

FIG. 2 is a diagram illustrating a radio protocol structure in an LTE system to which according to an embodiment of the disclosure.

Referring to FIG. 2, the radio protocol of the LTE system consists of packet data convergence protocols (PDCPs) b-05 and b-40, radio link controls (RLCs) b-10 and b-35, and medium access controls (MACs) b-15 and b-30 in the terminal and the ENB, respectively. The PDCPs b-05 and b-40 take charge of the operation of the IP header compression/recovery, or the like. The main functions of the PDCP are summarized as follows.
Header compression and decompression functions (Header compression and decompression: ROHC only)
transfer function of user data (Transfer of user data)
In-sequence delivery function (In-sequence delivery of upper layer PDUs at PDCP re-establishment procedure for RLC AM)
Reordering function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU discard function (Timer-based SDU discard in uplink.)

The radio link controls (hereinafter, RLCs) b-10 and b-35 reconfigures the PDCP protocol data unit (PDU) or RLC service data unit (SDU) to an appropriate size to perform the automatic repeat request (ARQ) operation or the like. The main functions of the RLC are summarized as follows.
Data transfer function (Transfer of upper layer PDUs)
ARQ function (Error Correction through ARQ (only for AM data transfer))
Concatenation, segmentation, reassembly functions (Concatenation, segmentation and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer)
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

The MACs b-15 and b-30 are connected to several RLC layer apparatuses configured in one terminal and perform an operation of multiplexing RLC PDUs into an MAC PDU and demultiplexing the RLC PDUs from the MAC PDU. The main functions of the MAC are summarized as follows.
Mapping function (Mapping between logical channels and transport channels)
Multiplexing/demultiplexing function (Multiplexing/demultiplexing of MAC SDUs belonging to one or different logical channels into/from transport blocks (TB) delivered to/from the physical layer on transport channels)
Scheduling information reporting function (Scheduling information reporting)
HARQ function (Error correction through HARQ)
Priority handling function between logical channels (Priority handling between logical channels of one UE)
Priority handling function between terminals (Priority handling between UEs by means of dynamic scheduling)
MBMS service identification function (MBMS service identification)
Transport format selection function (Transport format selection)
Padding function (Padding)

Physical layers b-20 and b-25 may perform channel-coding and modulating higher layer data, making the higher layer data as an OFDM symbol and transmitting them to a radio channel, or demodulating and channel-decoding the OFDM symbol received through the radio channel and transmitting the demodulated and channel-decoded OFDM symbol to the higher layer.

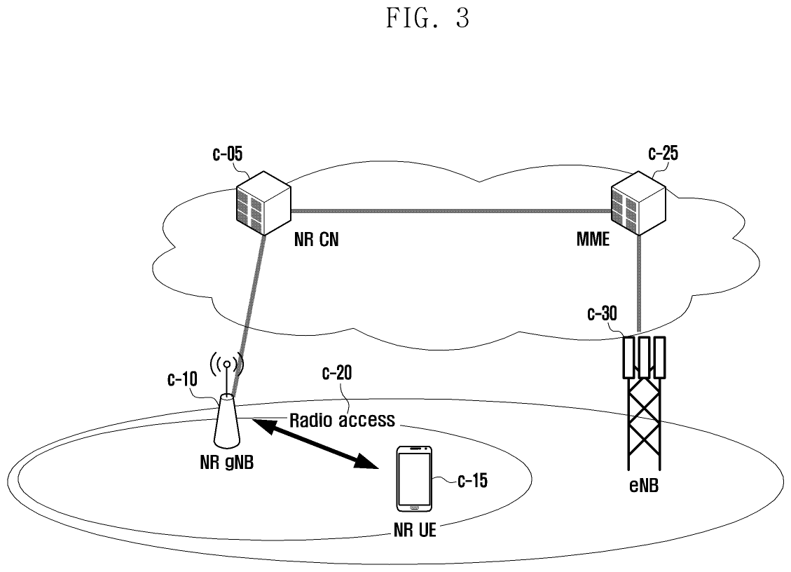

FIG. 3 is a diagram illustrating a next generation mobile communication system to which according to an embodiment of the disclosure.

Referring to FIG. 3, as illustrated, a radio access network of a next generation mobile communication system (hereinafter, a new radio (NR) or 5G) may be configured to include a next generation base station (new radio node B, hereinafter, NR gNB or NR base station) c-10 and a new radio core network (NR CN) c-05. The user terminal (new radio user equipment, hereinafter, NR UE or UE) c-15 may access the external network through the NR gNB c-10 and the NR CN c-05.

Referring to FIG. 3, the NR gNB c-10 corresponds to an evolved node B(eNB) of the existing LTE system. The NR gNB is connected to the NR UE c-15 via a radio channel and may provide a service superior to the existing node B. In the next generation mobile communication system, since all user traffics are served through a shared channel, an apparatus for collecting status information, such as a buffer status, an available transmission power status, and a channel status of the UEs to perform scheduling is required. Hence, the NR NB c-10 takes charge of the collecting and scheduling. One NR gNB generally controls a plurality of cells. In order to realize high-speed data transmission compared with the current LTE, the NR gNB may have an existing maximum bandwidth, and may be additionally incorporated into a beamforming technology using an orthogonal frequency division multiplexing (hereinafter, OFDM) as a radio access technology. Further, an adaptive modulation & coding (hereinafter, AMC) scheme determining a modulation scheme and a channel coding rate depending on a channel status of the terminal is applied. The NR CN c-05 performs functions, such as mobility support, bearer setup, quality of service (QoS) setup, and the like. The NR CN is a device for performing a mobility management function for the terminal and various control functions and is connected to a plurality of base stations. In addition, the next generation mobile communication system can interwork with the existing LTE system, and the NR CN c-05 is connected to the MME c-25 through the network interface. The MME is connected to the eNB c-30 which is the existing base station.

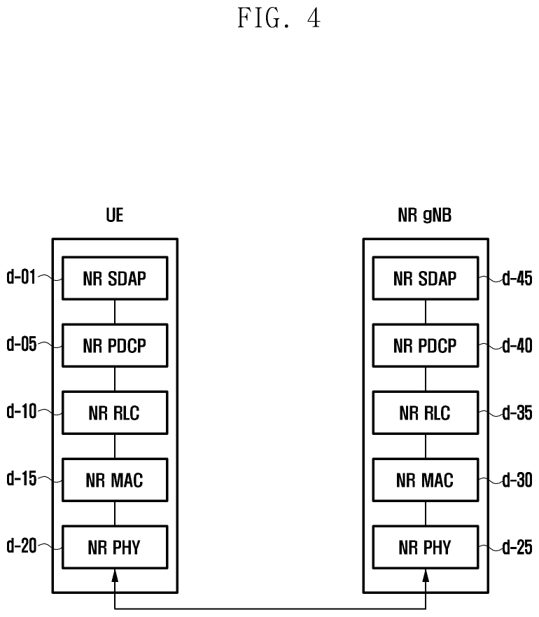

FIG. 4 is a diagram illustrating a radio protocol structure of a next generation mobile communication system to which according to an embodiment of the disclosure.

Referring to FIG. 4, the radio protocol of the next generation mobile communication system may be configured to include NR SDAPs d-01 and d-45, NR PDCPs d-05 and d-40, NR RLCs d-10 and d-35, NR MACs d-15 and d-30 and NR PHYs d-20 and d-25 in the terminal and the NR base station.

The main functions of the NR PDCPs d-05 and d-40 may include some of the following functions.
Transfer function of user data (transfer of user plane data)
Mapping function between a QoS flow and a data bearer for both DL and UL (mapping between a QoS flow and a DRB for both DL and UL)
Marking function of QoS flow ID for both DL and UL (marking QoS flow ID in both DL and UL packets)
Mapping function of Reflective QoS flow to DRB for the UL SDAP PDUs (reflective QoS flow to DRB mapping for the UL SDAP PDUs).

With regard to the SDAP layer, the UE may be configured, through an RRC message, whether to use a header of the SDAP layer or to use functions of the SDAP layer per each PDCP layer, per bearer, or per logical channel. In the case that the SDAP header is configured, a 1-bit non access stratum (NAS) reflective QoS indicator and a 1-bit access stratum (AS) reflective QoS indicator of the SDAP header may indicate the UE to update or reconfigure UL and DL QoS flow and data bearer mapping information. The SDAP header may include QoS flow ID information indicating QoS. The QoS information may be used as data processing priority information or scheduling information for appropriately supporting a service.

Main functions of the NR PDCP d-05 or d-40 may include some of the following functions.

Header Compression and Decompression Functions (Header Compression and Decompression: ROHC Only)
Transfer function of user data (Transfer of user data)
In-order delivery function (In-order delivery of upper layer PDUs)
Out-of-order delivery function (Out-of-order delivery of upper layer PDUs)
Reordering function (PDCP PDU reordering for reception)
Duplication detection function (Duplicate detection of lower layer SDUs)
Retransmission function (Retransmission of PDCP SDUs)
Ciphering or deciphering function (Ciphering and deciphering)
Integrity protection and verification function (integrity protection and verification)
Timer-based SDU discard function (Timer-based SDU discard in uplink.)

The reordering function of the NR PDCP device may indicate a function of reordering PDCP PDUs received from a lower layer, on a PDCP sequence number (SN) basis. The reordering function may include a function of delivering the reordered data to an upper layer in order or directly delivering the data to an upper layer in out of order, a function of recording missing PDCP PDUs by reordering the received PDCP PDUs, a function of reporting status information of the missing PDCP PDUs to a transmitter, or a function of requesting to retransmit the missing PDCP PDUs.

Main functions of the NR RLC d-10 or 1 d-35 may include some of the following functions.
Transfer function of data (Transfer of upper layer PDUs)
In-order delivery function (In-order delivery of upper layer PDUs)
Out-of-order delivery function (Out-of-order delivery of upper layer PDUs)
ARQ function (Error Correction through ARQ)
Concatenation, segmentation and reassembly functions (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The in-order delivery function of the NR RLC device may indicate a function of delivering RLC SDUs received from a lower layer, to an upper layer in order. The in-order delivery function may include a function of reassembling the RLC SDUs and delivering the reassembled RLC SDU in the case that a plurality of RLC SDUs segmented from one RLC SDU are received, a function of reordering received RLC PDUs on a RLC sequence number (SN) or PDCP SN basis, a function of recording missing RLC PDUs by reordering the received RLC PDUs, a function of reporting status of the missing RLC PDUs to a transmitter, a function of requesting to retransmit the missing RLC PDUs, a function of delivering only RLC SDUs prior to a missing RLC SDU, to an upper layer in order in the case that the missing RLC SDU exists, a function of delivering all RLC SDUs received before a timer starts, to an upper layer in order although a missing RLC SDU exists when a certain timer expires, or a function of delivering all RLC SDUs received up to a current time, to an upper layer in order when a certain timer expires, even when a missing RLC SDU exists. In addition, the NR RLC device may process the RLC PDUs in order of reception (in the order of their arrival regardless of the order of the sequence number) and deliver the RLC PDUs to the PDCP device in an out-of-sequence (out-of-order delivery), and in the case of a segment, the NR RLC device may reassemble the segments stored in a buffer or received later into one whole RLC PDU, process it, and deliver the RLC PDU to the PDCP device.

The NR RLC layer may not include a concatenation function, and this function may be performed by the NR MAC layer or may be replaced with a multiplexing function of the NR MAC layer. In the above, whether to perform in-order delivery or out-of-order delivery may be configured through an RRC message.

The out-of-sequence delivery function of the NR RLC device may include a function of directly delivering RLC SDUs received from a lower layer, to an upper layer out of order. The function may include a function of reassembling a plurality of RLC SDUs and delivering the reassembled RLC SDU in the case that the plurality of RLC SDUs is segmented from one RLC SDU and is received, or a function of recording missing RLC PDUs by storing RLC SNs or PDCP SNs of received RLC PDUs and reordering the received RLC PDUs.

The NR MAC d-15 or d-30 may be connected to a plurality of NR RLC layers configured for one UE, and main functions of the NR MAC may include some of the following functions.
Mapping function (Mapping between logical channels and transport channels)
Multiplexing/demultiplexing function (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handing function between UEs (Priority handling between UEs by means of dynamic scheduling)
MBMS service identification function (MBMS service identification)
Transport format selection function (Transport format selection)
Padding function (Padding)

An NR PHY layer d-20 or 1 d-25 may channel-code and modulate upper layer data into OFDM symbols and may transmit the OFDM symbols through a radio channel, or may demodulate OFDM symbols received through a radio channel and channel-decode and may deliver the OFDM symbols to an upper layer.

Since a frequency of a notably high band frequency can be used in the next-generation mobile communication system, a frequency bandwidth may also be very wide. However, in UE implementation, completely supporting the very wide bandwidth requires high implementation complexity, which incurs high costs. Accordingly, the next-generation mobile communication system may introduce the concept of a bandwidth part (BWP), and thus a plurality of BWPs may be configured in one cell (SPCell or SCell) and the UE may transmit and receive data in one or a plurality of BWPs according to an indication of the base station.

The disclosure proposes a status transition method or bandwidth part switching method or a detailed operation considering a status of an SCell and a plurality of bandwidth parts configured in the SCell when a dormant bandwidth part proposed in the disclosure is introduced. Further, the disclosure manages a dormant mode in units of bandwidth parts (BWP-levels) and proposes a status transition method or a bandwidth part switching method, and also proposes a detailed operation in a bandwidth part according to a status of each SCell or a status or a mode (active, deactivated, or dormant) of each bandwidth part. In addition, for quick activation of a cell (SCell) or BWP, a first channel measurement configuration information for the cell or BWP is configured as an RRC message or MAC CE, and the UE is indicated to apply and use (activate) the first channel measurement configuration information through the RRC message or MAC CE so that the UE can quickly measure a channel signal (e.g., reference signal) for the cell or BWP and quickly report the measurement result to the base station. Thus, it is possible to quickly activate the cell or BWP.

In the above, activating the cell or BWP may mean procedures in which the UE monitors a PDCCH in the cell or BWP, or the base station transmits the PDCCH to the UE, or the base station transmits downlink data (PDSCH) to the UE, or the UE transmits the uplink data (PUSCH), or the UE transmits a measurement result or HARQ ACK or NACK through PUCCH, or the UE transmits a sounding reference signal (SRS), or the UE measures a channel measurement signal (synchronization signal block (SSB) or channel state information reference signal (CSI-RS)) transmitted by the base station, or the UE measures the channel measurement signal transmitted by the base station and reports the measurement result.

In the above, the first channel measurement configuration information may be included in configuration information for a channel measurement signal for a specific UE (or UEs) in the cell or BWP by a base station. For example, the first channel measurement configuration information may include a cycle of the channel measurement signal or the number of times the signal is transmitted, an interval in which the signal is transmitted, an offset for the time during which the signal is transmitted, a time interval between signals to be transmitted, a list of plurality of channel measurement signals that can be transmitted, a time transmission resource (or frequency transmission resource) indicating the location of the signal to be transmitted, a transmission resource (time transmission resource or frequency transmission resource) for reporting measurement results, a cycle for reporting measurement results, or the like. In addition, the first channel measurement configuration information configured as an RRC message may include a plurality of channel measurement signal information, and any one channel measurement signal information of the plurality of channel measurement signal information configured above as an RRC message or MAC CE or DCI, or beam configuration information may be indicated so that the UE may perform channel measurement or channel measurement reporting by applying or using the indicated channel measurement signal information or beam configuration information. As another method, by configuring or indicating the channel measurement signal information through the RRC message or MAC CE, the UE may perform channel measurement by applying or using the configured (or indicated) channel measurement signal information or perform the channel measurement reporting. In addition, the first channel measurement configuration information may be configured differently for each cell or for each BWP for a plurality of cells or BWPs configured in the RRC message, and the beam-related configuration information, such as a beam direction or a beam number or a beam location (e.g., transmission configuration indication (TCI) state or quasi co-location (QCL)) can be configured together so that the UE can easily measure transmission resources for channel measurement. In addition, the first channel measurement configuration information may be configured with a timing advance (TA) value (or offset value) for synchronizing the downlink signal of the base station or the uplink signal of the base station, or a timer (time alignment timer (TAT)) or timer value (TAT value) that indicates the validity of the TA value, so that channel measurement or channel measurement reporting can be correctly performed.

The first channel measurement configuration information proposed in the disclosure may be configured only for downlink BWP configuration information of each cell. For example, the first channel measurement configuration information proposed in the disclosure may not be configured for uplink BWP configuration information of each cell. This is because the UE must first measure the channel for the downlink so that it can correctly receive the PDCCH and follow the indications for the base station after reporting the measurement result for the channel or cell.

The first channel measurement configuration information proposed in the disclosure may be initially deactivated when configured as an RRC message or after handover, and may be activated later by the MAC control information or DCI information of PDCCH DCI or RRC message proposed in the disclosure. In the case that the first channel measurement configuration information is configured as the RRC message as described above, the base station can easily manage the cell state or channel measurement procedure of the UE only when the initial state is a deactivated state, and the timing of when and how the UE performs channel measurement can also be accurately performed without a processing delay problem of the RRC message.

In addition, the disclosure configures a plurality of bandwidth parts for downlink or uplink in one cell (SPCell, PCell, PSCell, or SCell) and configures and operates active bandwidth part (active DL or UL BWP) a dormant BWP (or dormant DL BWP), or an inactive bandwidth part (inactive or deactivated DL/UL BWP) through bandwidth part switching. For example, it is possible to increase a data transmission rate through a method similar to the carrier aggregation by transitioning a downlink or uplink BWP to an activated state for one cell. Further, the UE may not monitor a PDCCH for the cell to save a battery by transitioning or switching the downlink BWP to a dormant BWP. Further, the UE may measure a channel for the downlink BWP and report a channel measurement result, thereby supporting rapid activation of a cell or a BWP in the future. Further, it is possible to save the battery of the UE by transitioning the downlink (or uplink) BWP to a deactivated state in one cell. An indication of the state transition between BWPs for each cell or BWP switching may be configured or indicated through an RRC message, a MAC CE, or downlink control information (DCI) of a PDCCH.

The dormant BWP may also be extended and applied to dual connectivity. For example, the dormant BWP may be applied to a PSCell of a secondary cell group. As another method, the dormant BWP is extended to the concept of cell group suspension or cell group deactivation, and cell group suspension or cell group deactivation is indicated to one cell group (e.g., secondary cell group) of a UE for which dual connectivity has been configured, so that the UE may reduce power consumption thereof by suspending data transmission or reception, suspending PDCCH monitoring, or intermittently performing PDCCH monitoring based on a very long cycle in the indicated cell group. When the cell group suspension or deactivation is indicated to the UE, the UE may perform channel measurement in a cell group for which cell group suspension or deactivation has been indicated, and may report a channel measurement result to a network (e.g., to a master cell group or a secondary cell group), so as to support quick activation of dual connectivity. With respect to the cell group for which cell group suspension or deactivation has been indicated, the UE performs the above procedures, or the UE may maintain and store cell group configuration information without discarding or releasing the same, or according to the cell group activation or resumption indication of the network, the UE may restore the cell group configuration information. For example, the cell group configuration information (e.g., configuration information or bearer configuration information of each of PDCP, RLC, or MAC layer) or cell-specific configuration information configured for the UE may be stored or maintained as it is. However, if a cell group is suspended or deactivated, the UE may suspend bearers or RLC bearers of the bearers or may suspend transmission (or data transmission, such as SCG transmission) in the cell group. If the UE receives a cell group resumption or activation indication for the cell group for which cell group suspension or deactivation has been indicated, the UE may resume, restore, or reapply configuration information of the cell group, or may resume the transmission for a bearer or RLC bearer or cell group (e.g., SCG transmission) or resume data transmission or data reception, or resume PDCCH monitoring, or perform chancel measurement reporting, or reactive a periodically configured transmission resource.

In the above, in the case that the cell group is suspended or deactivated, suspending the bearer (a bearer using an RLC Un-Acknowledged Mode (UM mode) or a bearer using an RLC Acknowledged Mode (AM mode)) means suspending a PDCP layer or an RLC layer (or suspending data transmission or reception or data processing), and not transmitting (or receiving) data for the bearer (or corresponding to a logical channel identifier corresponding to the bearer) at a MAC layer (or not selecting the logical channel identifier as a target in a logical channel prioritization (LCP) procedure). In the above, the procedure for suspending the PDCP layer may apply the embodiments specifically proposed in the following of the disclosure.

In the above, in the case that the cell group is suspended or deactivated, suspending the RLC bearer (a RLC bearer using an RLC UM mode or an RLC bearer using an RLC AM mode) means suspending an RLC layer (or suspending data transmission or reception or data processing), and not transmitting (or receiving) data for the bearer (or corresponding to a logical channel identifier corresponding to the bearer) at a MAC layer (or in an LCP procedure, not selecting the logical channel identifier as a target). In the above, suspending the RLC bearer may mean that the PDCP layer connected to the RLC layer can continue to process data. For example, the PDCP layer connected to the suspended RLC bearer processes and transmit data or receive and process data through another RLC bearer (e.g., an RLC bearer belonging to a cell group (e.g., MCG) different from the cell group (e.g., SCG)).

In the above, in the case that the cell group is suspended or deactivated, suspending transmission (e.g., SCG transmission) for the cell group may mean not transmitting (or receiving) data for a bearer belonging to the cell group (a bearer using an RLC UM mode or a bearer using an RLC AM mode) (or corresponding to the logical channel identifier corresponding to the bearer) at the MAC layer (or in an LCP procedure, not selecting the logical channel identifier as a target). However, suspending the transmission (e.g., SCG transmission) for the cell group may mean that data processing or data pre-processing is possible in a PDCP layer or an RLC layer. For example, although data (or uplink data) of an upper layer is not transmitted in the cell group, data processing can be performed in advance for transmission in the PDCP layer, RLC layer or MAC layer.

In the above, in the case that the cell group is resumed or activated, resuming the bearer (a bearer using an RLC UM mode or a bearer using an RLC AM mode) may mean resuming the PDCP layer or the RLC layer (or resuming data transmission or reception or data processing), and transmitting (or receiving) data for the bearer (or corresponding to the logical channel identifier corresponding to the bearer) (or in an LCP procedure, the logical channel identifier is selected as a target) at the MAC layer.

In the above, in the case that the cell group is resumed or activated, resuming the RLC bearer (an RLC bearer using an RLC UM mode or an RLC bearer using an RLC AM mode) may mean resuming the RLC layer (or resuming data transmission or reception or data processing), and transmitting (or receiving) data for the bearer (or corresponding to the logical channel identifier corresponding to the bearer) at the MAC layer (or selecting the logical channel identifier as a target in an LCP procedure). In the above, resuming the RLC bearer may mean transmitting data to the PDCP layer connected to the RLC layer or receiving data from the PDCP layer.

In the above, in the case that the cell group is resumed or activated, resuming transmission (e.g., SCG transmission) for the cell group may means transmitting (or receiving) data for the bearer (a bearer using an RLC UM mode or a bearer using an RLC AM mode) (or corresponding a logical channel identifier corresponding to the bearer) belonging to the cell group at the MAC layer (or selecting the logical channel identifier as a target in an LCP procedure). However, resuming transmission (e.g., SCG transmission) for the cell group may mean that data processing or data pre-processing is possible in the PDCP layer or the RLC layer. For example, data (or uplink data) of an upper layer can be transmitted in the cell group, and data processing can be performed in advance for transmission in the PDCP layer, RLC layer, or MAC layer.

As another method, in the above, in the case that the cell group is suspended or deactivated, the bearer (or an RLC bearer) using an RLC UM mode is suspended and the PDCP layer or RLC layer is suspended, so that data transmission or reception or data processing may be suspended, or data transmission or reception in the MAC layer may be suspended. However, for the bearer (or an RLC bearer) using an RLC AM mode, transmission for the cell group is suspended so that data processing can be continuously performed for the PDCP layer or RLC layer, or data transmission or reception in the MAC layer can be suspended. This is because in the case that a security key is changed, there is a retransmission (or regeneration) procedure for the RLC AM bearer in a PDCP re-establishment procedure (thus, in the case that the security key is not changed, a data processing speed may be reduced. In addition, in the case that the security key is changed, data loss does not occur due to the retransmission (or regeneration) procedure), and there is no retransmission (or regeneration) procedure for the RLC UM bearer so that if the data processing procedure is performed in advance in the RLC UM bearer, data loss within the UE may occur (in the case that a security key is not changed, a data processing speed may be reduced). However, in the case that the security key is changed, there is no retransmission (or regeneration) procedure, and in re-establishment procedure of the PDCP layer and RLC layer, all data is discarded, so that data loss occurs. Therefore, different procedures may be applied to the bearer (or an RLC bearers) using an RLC AM mode and the bearer (or an RLC bearer) using an RLC UM mode. In the above, the procedure for suspending the PDCP layer may be applied to the embodiments specifically proposed in the following of the disclosure.

The cell group configuration information or cell (SPCell (PCell or PSCell) or SCell) configuration information, or in previously configured cell group configuration information or cell (SPCell (PCell or PSCell) or SCell) configuration information, or in a message (e.g., an RRC message or RRCReconfiguration or MAC control information or downlink control information (DCI) of PDCCH) indicating the activation or resumption of a cell group or cell (SPCell (PCell or PSCell) or SCell) may be configured to include the first channel measurement configuration information for quick activation of the cell group or cell (SPCell (PCell or PSCell) or SCell). For quick activation of the cell group, in the configuration information of the cell (e.g., PCell or PSCell or SCell) of the cell group so that the base station is able to transmit many channel measurement signals temporarily or transmit a channel measurement signal frequently to enable quick channel measurement in the cell, the first cell channel measurement configuration information may include a cycle for a frequent channel measurement signal (e.g., radios resource or temporary reference signal (TRS), synchronization signal block (SSB) or channel state information reference signal (CSI-RS) or reference signal (RS)), transmission resource information for transmission (frequency or time transmission resource via which the frequent channel measurement signal is transmitted), an interval or frequency (the number of times the frequent channel measurement signal is transmitted), a timer value (time at which the frequent channel measurement signal is transmitted), a time interval (interval in which the frequent channel measurement signal is transmitted (e.g., an offset of time unit (slot, subframe, symbol, or the like)), or a transmission resource, period, interval, timing, offset, or the like via which the UE should report a measurement result. In the above, the first channel measurement configuration information may configure a short reporting cycle (or transmission resource) for the UE to report the channel measurement result, or transmission resource for channel measurement so that the base station is able to transmit many channel measurement signals (or transmission resources or (e.g., radios resource or temporary reference signal (TRS))) or transmit a channel measurement signal frequently to support the quick channel measurement or many signal measurement of the UE. In the above, the first channel measurement configuration information may include configuration information for a channel measurement signal for a specific UE (or UEs) in the cell or BWP by a base station. For example, the first channel measurement configuration information may include a cycle of the channel measurement signal or the number of times the signal is transmitted, an interval in which the signal is transmitted, an offset for the time during which the signal is transmitted, a time interval between signals to be transmitted, a list of plurality of channel measurement signals that can be transmitted, a time transmission resource (or frequency transmission resource) indicating the location of the signal to be transmitted, a transmission resource (time transmission resource or frequency transmission resource) for reporting measurement results, a cycle for reporting measurement results, or the like. In addition, the first channel measurement configuration information may be configured differently for each cell or for each BWP for a plurality of cells or BWPs configured in the RRC message, and the beam-related configuration information, such as a beam direction or a beam number or a beam location (e.g., transmission configuration indication (TCI) state or quasi co-location (QCL)) can be configured together so that the UE can easily measure transmission resources for channel measurement. In addition, the first channel measurement configuration information may be configured with a timing advance (TA) value (or offset value) for synchronizing the downlink signal of the base station or the uplink signal of the base station, or a timer (time alignment timer (TAT)) or timer value (TAT value) that indicates the validity of the TA value, so that channel measurement or channel measurement reporting can be correctly performed. In addition, the first channel measurement configuration information configured as an RRC message may include a plurality of channel measurement signal information, and any one channel measurement signal information of the plurality of channel measurement signal information configured above as an RRC message or MAC CE or DCI, or beam configuration information may be indicated so that the UE may perform channel measurement or channel measurement reporting by applying or using the indicated channel measurement signal information or beam configuration information. In the above, the method for indication may define a mapping between a bitmap, index, or identifier and each channel measurement signal information configured above, and may make an indication based on this. As another method, by configuring or indicating the channel measurement signal information through the RRC message or MAC CE, the UE performs channel measurement by applying or using the configured (or indicated) channel measurement signal information or channel measurement reporting.

The first channel measurement configuration information proposed in the disclosure may be initially deactivated when configured as an RRC message or after handover, and may be activated later by the MAC control information or DCI information of PDCCH or RRC message proposed in the disclosure. In the case that the first channel measurement configuration information is configured as the RRC message as described above, the base station can easily manage the cell state or channel measurement procedure of the UE only when the initial state is a deactivated state, and the timing of when and how the UE performs channel measurement can also be accurately performed without a processing delay problem of the RRC message.

The first channel measurement configuration information proposed in the disclosure may be configured only for downlink BWP configuration information of each cell. For example, the first channel measurement configuration information proposed in the disclosure may not be configured for uplink BWP configuration information of each cell. This is because the UE must first measure the channel for the downlink so that it can correctly receive the PDCCH and follow the indications for the base station after reporting the measurement result for the channel or cell.

In addition, a second channel measurement configuration information for measuring a signal of a cell (PSCell, PCell or SCell) of a cell group is included in a message (e.g., an RRC message or RRCReconfiguration or MAC control information or downlink control information (DCI) of PDCCH) that indicates the activation or resumption of the cell group or cell (SPCell (PCell or PSCell) or SCell). The second channel measurement configuration information may include general channel measurement configuration information, such as a transmission resource, cycle, time interval, or frequency of channel measurement signal, or a transmission resource, cycle, or time interval for channel measurement reporting.

In the disclosure, the UE may perform channel measurement by applying the first channel measurement configuration information or the second channel measurement configuration information according to the following conditions, and may report a measurement result to the base station.
1> If the UE has received a message (e.g., PDCCH indicator, MAC control information, or RRC message) indicating to activate (or resume) a cell (PCell, PSCell, or SCell) or a cell group (or if the cell group was previously deactivated),
   2> If the first channel measurement configuration information is configured for the UE,
      3> The UE determines that the base station is to transmit many channel measurement signals or transmit a channel measurement signal frequently according to the first channel measurement configuration information, and may measure many or frequent channel measurement signals temporarily (e.g., up to a time interval (e.g., subframe, slot, or symbol) configured in the first channel measurement configuration information, during an appointed (or predetermined) time interval based on an offset, for a specific time (e.g., while a timer is running), or until a first condition is satisfied, according to the first channel measurement configuration information. In addition, the UE may report an obtained channel measurement result according to the cycle or transmission resource configured in the first channel measurement configuration information, up to a time interval (e.g., subframe, slot, or symbol) configured in the first channel measurement configuration information, during an appointed (or predetermined) time interval based on an offset, for a specific time (e.g., while a timer is running), or until the first condition is satisfied. Therefore, as the UE is able to quickly measure the frequent channel measurement signal and quickly report the measurement result, the cell (e.g., PCell, SCell, or PSCell) or the cell group may be quickly activated (or resumed), or scheduling information may be quickly indicated. If second channel measurement configuration information is configured for the UE after the time interval (e.g., subframe, slot, or symbol) configured in the first channel measurement configuration information, after the appointed (or predetermined) time interval, after the specific time (e.g., if the timer expires), or after the first condition is satisfied, the UE may suspend or release application of the first channel measurement configuration information, and may measure the channel measurement signal according to the second channel measurement configuration information. For example, fallback may be performed from the first channel measurement configuration information to the second channel measurement information, or the second channel information may be applied instead of the first channel measurement configuration information. In addition, the obtained channel measurement result may be reported to the base station according to the cycle or transmission resource configured in the second channel measurement configuration information. If the second channel measurement configuration information is not configured, the UE may not perform the channel measurement.
   2> Otherwise (if the first channel measurement configuration information is not configured for the UE),
      3> If the second channel measurement configuration information is configured for the UE, a channel measurement signal may be measured according to the second channel measurement configuration information. In addition, the obtained channel measurement result may be reported according to the cycle or transmission resource configured in the second channel measurement configuration information. If the second channel measurement configuration information is not configured, the UE may not perform the channel measurement.

The first condition of the disclosure may be one of the following conditions. Hereinafter, the disclosure proposes effective conditions under which the base station is required to transmit neither an unnecessarily large amount of transmission resources nor unnecessarily frequent transmission resources when, under the first condition, a cell is activated, a cell group is activated or resumed (or when activating the cell group from deactivated state), or the UE in an RRC inactive mode resumes a connection in RRC connection resumption. For example, channel measurement or channel measurement reporting may be performed by applying the first channel measurement configuration information until one of the following conditions is satisfied.
The UE may determine that the first condition is satisfied, when the UE successfully completes random access (e.g., 4-step random access or 2-step random access) in the cell (e.g., PCell, SCell, or PSCell) or in a cell (e.g., PSCell or SCell) of the cell group, when random access is successfully completed and a first uplink transmission resource is allocated, or when an uplink transmission resource is indicated to the UE for the first time.
   ▪ More specifically, for example, if the UE performs contention-free random access (CFRA) (e.g., if a dedicated preamble or a UE cell identifier (e.g., C-RNTI) is assigned),
      ♦ It may be considered that random access is successfully completed when the UE transmits a dedicated preamble to the cell and receives a random access response (RAR) message or receives an indication of PDCCH for the random access response, and therefore the UE may determine that the first condition is satisfied. As another method, when an uplink transmission resource is received for the first time after RAR reception, the UE may determine that the first condition is satisfied.
   ▪ As another example, if the UE performs contention-based random access (CBRA) (e.g., if neither a dedicated preamble nor a UE cell identifier (e.g., C-RNTI) is assigned),
      ♦ when the UE transmits a preamble (e.g., random preamble) to the cell, receives a random access response (RAR) message, transmits Message 3 (e.g., handover completion message) by using an uplink transmission resource allocated or included or indicated in the random access response message, and receives, from a target base station via Message 4, a MAC CE (contention resolution MAC CE) indicating that contention has been resolved, or when an uplink transmission resource is received via PDCCH corresponding to C-RNTI of the UE, it may be considered that random access to the target base station has been successfully completed, and the UE may thus determine that the first condition is satisfied. As another method, if the size of the uplink transmission resource allocated in the random access response message is sufficient so that the UE may transmit Message 3 and may additionally transmit uplink data, the UE may determine that the uplink transmission resource is received for the first time and may determine that the first condition is satisfied. For example, when the RAR is received, the UE may determine that the uplink transmission resource is received for the first time, and may determine that the first condition is satisfied.
1> In the case that the UE performs 2-step random access as configured or indicated,
1> or in the case that the UE supports 2-step random access in a UE capability even if 2-step random access is not configured or indicated in the message, and when 2-step random access is supported in system information of the cell, and information (e.g., random access resource, threshold value for determination of whether to perform or not perform 2-step random access, or the like) for 2-step random access is broadcasted in system information, or when the UE receives the system information, and the UE performs 2-step random access for the cell due to a signal strength that is sufficient or is greater than the threshold value broadcast in the system information,
   ▪2> when 2-step random access is successfully completed, the UE may determine that the first condition is satisfied.
   ▪2> The 2-step random access may be performed specifically by one of contention-based random access (CBRA) and contention-free random access (CFRA).
      ♦3> If the UE performs CBRA-based 2-step random access,
         •4> the UE may transmit a preamble in a transmission resource (e.g., PRACH occasion, transmission resource configured by the base station via the RRC message, or transmission resource broadcast in the system information) for 2-step random access, and may transmit data (e.g., MsgA MAC PDU) in a transmission resource (e.g., PUSCH occasion) for data transmission. The data may include MAC control information (C-RNTI MAC CE) including a UE identifier (C-RNTI) or an RRC message (RRCReconfigurationComplete message or handover completion message).
         •4> The UE may monitor PDCCH scrambled with the UE identifier (C-RNTI) or with a first identifier (MsgB-RNTI) derived by a time or frequency at which the preamble is transmitted.
         •4> If the UE receives PDCCH scrambled with the UE identifier, receives an allocation of a downlink transmission resource via the PDCCH, or receives MAC control information (timing advance command MAC CE) for timing adjustment in the downlink transmission resource,
         ▪5> the UE may determine that the 2-step random access has been successfully completed, and may determine that the first condition is satisfied.
         •4> If the UE receives PDCCH scrambled with the first identifier (MsgB-RNTI), if the UE receives an allocation of a downlink transmission resource via the PDCCH, or if a fallback random access response for the preamble transmitted by the UE is received in the downlink transmission resource (e.g., in the case that the base station has received the preamble but has failed to receive MsgA, a fallback RAR indicating to transmit MsgA via another transmission resource is received),
         ▪5> the UE may transmit data (MsgA MAC PDU) via the transmission resource indicated in the fallback random access response.
         ▪5> The UE may monitor PDCCH scrambled with the UE identifier (C-RNTI).
         ▪5> If the UE receives PDCCH scrambled with the UE identifier, or receives an allocation of an uplink transmission resource via the PDCCH, the UE may determine that the 2-step random access has been successfully completed, and may determine that the first condition is satisfied.
      ♦3> In the case that the UE performs CFRA-based 2-step random access,
         •4> the UE may transmit a preamble in a transmission resource (e.g., PRACH occasion, or transmission resource designated by the base station via the RRC message) for 2-step random access, and may transmit data (e.g., MsgA MAC PDU) in a transmission resource (e.g., PUSCH occasion) for data transmission. The data may include MAC control information (C-RNTI MAC CE) including a UE identifier (C-RNTI) or an RRC message (RRCReconfigurationComplete message or handover completion message).
         •4> In the above, the UE may monitor PDCCH scrambled with the UE identifier (C-RNTI) or with the first identifier (MsgB-RNTI) derived by a time or frequency at which the preamble is transmitted.
         •4> If the UE receives PDCCH scrambled with the UE identifier, receives an allocation of a downlink transmission resource via the PDCCH, or receives MAC control information (timing advance command MAC CE) for timing adjustment in the downlink transmission resource,
         ▪5> the UE may determine that the 2-step random access has been successfully completed, and may determine that the first condition is satisfied.
         •4> If the UE receives PDCCH scrambled with the first identifier (MsgB-RNTI), if the UE receives an allocation of a downlink transmission resource via the PDCCH, or if a fallback random access response for the preamble transmitted by the UE is received in the downlink transmission resource (e.g., in the case that the base station has received the preamble but has failed to receive MsgA, if a fallback RAR indicating to transmit MsgA via another transmission resource is received),
         ▪5> the UE may determine that the 2-step random access has been successfully completed, and may determine that the first condition is satisfied.
         ▪5> The UE may transmit data (MsgA MAC PDU) via the transmission resource indicated in the fallback random access response.
1> When random access is started or when a preamble for random access is transmitted, the UE may determine that the first condition is satisfied.
1> As another method, in the case that 2-step random access is configured or indicated for the UE via the message, the UE may determine that the first condition is satisfied. For example, in the above case, before starting 2-step random access, the UE may determine that the first condition is satisfied.
1> As another method, if 2-step random access is configured or indicated for the UE via the message, and a transmission resource (PUSCH) configured for data transmission in 2-step random access is greater than a first threshold, or if a configuration value (timing advance value) for timing adjustment is included in the RRC message, the UE may determine that the first condition is satisfied. The first threshold value may be configured by the base station via the RRC message (e.g., RRCReconfiguration message), may be broadcast in the system information, or may be configured to the size of data that the UE has for transmission. For example, in the above case, before starting 2-step random access, the UE may determine that the first condition is satisfied. As another method, if a configuration value (timing advance value) for timing adjustment is included in the RRC message, or if 2-step random access is configured, the UE may transmit data directly from the configured transmission resource (e.g., transmission resource configured via the RRC message, or transmission resource indicated by PDCCH of the target base station, where the UE monitors the PDCCH) without transmitting a preamble. Therefore, in the above case, before starting 2-step random access, when transmitting the data, or before transmitting the data, the UE may determine that the first condition is satisfied. As another method, if a configuration value (timing advance value) for timing adjustment is included in the RRC message, or if 2-step random access is configured, the UE may transmit data directly via the configured transmission resource (PUSCH) (e.g., transmission resource configured via the RRC message, or transmission resource indicated by PDCCH of the target base station, where the UE monitors the PDCCH) without transmitting a preamble. In the above case, if the configured transmission resource (PUSCH) (e.g., transmission resource configured via the RRC message, or transmission resource indicated by PDCCH of the target base station, where the UE monitors the PDCCH) is greater than the first threshold value, or if the RRC message includes the configuration value (timing advance value) for timing adjustment, the UE may determine that the first condition is satisfied, before starting 2-step random access, when transmitting the data, or before transmitting the data.
1> In the case that the UE in the RRC inactive mode transmits an RRCResumeRequest message and then receives an RRCResume message (or RRCSetup message) in response thereto, the UE may determine that the first condition is satisfied.
1> In the case that the timer indicating an interval for channel measurement expires while the UE performs the channel measurement based on the first channel measurement configuration information configured in the RRC message, the UE may determine that the first condition is satisfied.
1> In the case that a timer interval indicating an interval for channel measurement is passed (or expired) or all time intervals are used (or applied) while the UE performs the channel measurement based on the first channel measurement configuration information configured in the RRC message, the UE may determine that the first condition is satisfied.
1> In the case that all signals for channel measurement are measured (or completed) as many times as configured or signals are received as many times as configured above while the UE performs the channel measurement based on the first channel measurement configuration information configured in the RRC message, the UE may determine that the first condition is satisfied.
1> In the case that the channel measurement is completed (the channel measurement is expired) or the channel measurement reporting is completed (or the channel measurement reporting is expired) based on the configuration information when the UE performs the channel measurement based on the first channel measurement configuration information configured in the RRC message, the UE may determine that the first condition is satisfied.

If the first condition is satisfied, an upper layer (e.g., RRC layer) may perform indication using an indicator to a lower layer (e.g., PDCP layer, RLC layer, MAC layer, or PHY layer), or the lower layer (e.g., PDCP layer, RLC layer, MAC layer, or PHY layer) may perform indication to the upper layer (e.g., RRC layer).

The methods for configuring or applying the first channel measurement configuration information proposed in the disclosure may be extended to be configured and used when activating or resuming a cell group (e.g., PSCell), activating a SCell, resuming an RRC connection in an RRC inactive mode (e.g., using an RRCResume message), or performing a handover procedure (e.g., using an RRCReconfiguration message).

In the disclosure, a bandwidth part (BWP) may be used regardless of distinction between an uplink and a downlink, and the bandwidth part may indicate each of an uplink BWP and a downlink BWP according to context.

In the disclosure, a link may be used regardless of distinction between an uplink and a downlink, and the link may indicate each of an uplink and a downlink according to context.

In the disclosure, a cell may indicate a PCell, an SCell (e.g., SCell configured in a master cell group (MCG)), a PSCell (e.g., PCell of a secondary cell group (SCG)), or an SCell (e.g., SCell configured in a secondary cell group (SCG)). In the disclosure, for an SCell or PSCell of the UE performing carrier aggregation or dual connectivity, a dormant bandwidth part (dormant BWP) may be configured or introduced, and battery consumption may be thus reduced by preventing the UE from performing PDCCH monitoring in the dormant BWP. The UE may perform channel measurement in the dormant BWP, may report (e.g., channel state information (CSI) or channel quality information (CQI) measurement or reporting) a channel measurement result, and may perform beam measurement, beam tracking, or beam operation, so that, in the case that data transmission is required, the UE may perform switching to a normal bandwidth part (normal BWP) or perform activation to the normal BWP, so as to quickly start data transmission in the normal BWP. The dormant BWP may be neither configured for nor applied to an SPCell (PCell of MCG or PCell (or PSCell) of SCG) or an SCell for which PUCCH has been configured, where the SPCell needs to continuously monitor a signal, transmit or receive feedback, or identify and maintain synchronization.

If the UE receives, via a PCell, an indication of switching to a dormant BWP or activation to a dormant BWP with respect to an SCell of a master cell group, the UE may perform channel measurement for the dormant BWP of the SCell, and may report an obtained channel measurement result via a transmission resource of a PCell of the master cell group (MCG) (e.g., via a physical uplink control channel (PUCCH) transmission resource of the PCell) or via a transmission resource of the SCell (e.g., via a physical uplink control channel (PUCCH) transmission resource) for which PUCCH of the MCG is configured. A transmission resource (e.g., PUCCH or PUSCH) of a cell, via which a channel measurement result for a certain cell or bandwidth part thereof is to be reported, may be configured for the UE via an RRC message for each cell or each bandwidth part.

If the UE receives, via the PSCell, an indication of switching to a dormant BWP or activation to a dormant BWP with respect to a SCell of a secondary cell group, the UE may perform channel measurement for the dormant BWP of the SCell, and may report an obtained channel measurement result via a transmission resource of the PSCell of the secondary cell group (SCG) (e.g., via a physical uplink control channel (PUCCH) transmission resource of the PSCell) or via a transmission resource of the SCell (e.g., via a physical uplink control channel (PUCCH) transmission resource) for which PUCCH of the SCG is configured. A transmission resource (e.g., PUCCH or PUSCH) of a cell, via which a channel measurement result for a certain cell or bandwidth part thereof is to be reported, may be configured for the UE via an RRC message for each cell or each bandwidth part.

If the UE receives, via the PCell, an indication of switching to a dormant BWP or activation to a dormant BWP with respect to the PSCell or SCell of the SCG, or if the UE receives a cell group suspension (SCG suspension or cell group suspension) indication for the secondary cell group (SCG or PSCell), the UE may perform channel measurement for the bandwidth part (bandwidth part configured via the RRC message or last active bandwidth part) or the dormant BWP of the PSCell or SCell, and may report an obtained channel measurement result via a transmission resource (e.g., via a physical uplink control channel (PUCCH) transmission resource of the PCell) of the PCell of the master cell group (MCG), via a transmission resource (e.g., via a physical uplink control channel (PUCCH) transmission resource) of the SCell for which PUCCH of the master cell group is configured, or via a transmission resource (e.g., via a physical uplink control channel (PUCCH) transmission resource of the PSCell) of the PSCell of the secondary cell group (SCG). A transmission resource (e.g., PUCCH or PUSCH) of a cell, via which a channel measurement result for a certain cell or bandwidth part thereof is to be reported, may be configured for the UE via an RRC message for each cell or each bandwidth part.

The disclosure proposes various embodiments of operations performed based on DCI of PDCCH, a MAC CE, or an RRC message in order to operate the dormant BWP or cell group suspension state, proposed above, with respect to an SCell (SCell of a mater cell group when carrier aggregation is configured, or SCell of a secondary cell group when dual connectivity is configured) or a PSCell (PCell of a secondary cell group when dual connectivity is configured) of the UE.

A network or a base station may configure an SPCell (PCell and PSCell) and a plurality of SCells for a UE. The SPCell may refer to a PCell when the UE communicates with one base station, and may indicate a PCell of a master base station or a PSCell of a secondary base station when the UE communicates with two base stations (master base station and secondary base station). The PCell or PSCell indicates a main cell used when the UE and the base station communicate in each MAC layer, and refers to a cell in which timing is performed for synchronization, random access is performed, HARQ ACK/NACK feedback is transmitted via a PUCCH transmission resource, and most control signals are exchanged. A technology, in which a base station operates a plurality of SCells with an SPCell so as to increase transmission resources and increase uplink or downlink data transmission resources, is referred to as carrier aggregation technique or dual connectivity.

In the disclosure, a PCell may refer to a master cell group (MCG), and a PSCell may refer to a secondary cell group (SCG). In addition, a MCG may include a PCell and SCells configured in the MCG, and a SCG may include a PSCell and SCells configured in the SCG. In addition, a cell may indicate a cell group, or a cell group may indicate a cell.

When an SPCell and a plurality of SCells are configured via an RRC message, a state or mode may be configured for the UE via the RRC message, MAC CE, or DCI of PDCCH with respect to each cell (e.g., PCell, PSCell, or SCells), each SCell, a bandwidth part of each SCell, or a cell group. The state or mode of the cell may be configured to be one of an active mode or activated state or a deactivated mode or deactivated state. A cell being in an active mode or activated state may represent that, in a cell in the active mode or in an activated cell, the UE may exchange uplink or downlink data with the base station in an activated bandwidth part, an activated normal bandwidth part, or a bandwidth part other than an activated dormant bandwidth part of the cell, may perform PDCCH for identifying an indication of the base station, may perform channel measurement for downlink of the cell (or activated bandwidth part, activated normal bandwidth part, or bandwidth part other than activated dormant bandwidth part of the cell) in the active mode or in the activated state, may report measurement information periodically to the base station, and may transmit a pilot signal (sounding reference signal (SRS)) periodically to the base station so that the base station can perform uplink channel measurement. Alternatively, the UE may activate or switch the bandwidth part of the activated cell to the dormant bandwidth part according to an indication (e.g., PDCCH, MAC CE, or RRC message) of the base station. If the dormant bandwidth part is activated in the activated cell, the UE may report channel measurement and may report a channel measurement result without PDCCH monitoring in the cell.

As another method, if the cell, in which the dormant bandwidth part is activated, is the SCell, the UE may: not monitor PDCCH, not receive downlink data, perform channel measurement or measurement result reporting; suspend a configured periodic transmission resource (e.g., type 1 periodic transmission resource (configured uplink grant type 1)), clear or initialize a configured periodic transmission resource (e.g., type 2 periodic transmission resource (configured uplink grant type 2)), not transmit a sounding reference signal (SRS), not transmit uplink data, or not transmit PUCCH (e.g., scheduling request (SR) or preamble for random access). However, if the cell, in which the dormant bandwidth part is activated or cell group suspension is indicated, is the PSCell, the UE may not monitor PDCCH, monitor PDCCH in a very long period, not receive downlink data; perform channel measurement or measurement result reporting, suspend the configured periodic transmission resource (e.g., type 1 periodic transmission resource (configured uplink grant type 1)), clear or initialize the configured periodic transmission resource (e.g., type 2 periodic transmission resource (configured uplink grant type 2)), transmit a sounding reference signal (SRS), not transmit uplink data; transmit PUCCH (e.g., scheduling request (SR) or preamble for random access); or perform random access.

If the cell, in which activation is performed to the bandwidth part other than the dormant bandwidth part, is the SCell, the UE may monitor PDCCH, receive downlink data, perform channel measurement or measurement result reporting; resume the configured periodic transmission resource (e.g., type 1 periodic transmission resource (configured uplink grant type 1)), configure or activate the configured periodic transmission resource (e.g., type 2 periodic transmission resource (configured uplink grant type 2)), transmit a sounding reference signal (SRS), transmit uplink data, transmit PUCCH (e.g., scheduling request (SR) or preamble for random access), or perform random access.

If the cell, in which activation is performed to the bandwidth part other than the dormant bandwidth part or cell group resumption (SCG resumption) is indicated, is the PSCell, the UE may monitor PDCCH, receive downlink data; perform channel measurement or measurement result reporting, resume the configured periodic transmission resource (e.g., type 1 periodic transmission resource (configured uplink grant type 1)), configure or activate the configured periodic transmission resource (e.g., type 2 periodic transmission resource (configured uplink grant type 2)), transmit a sounding reference signal (SRS); transmit uplink data, transmit PUCCH (e.g., scheduling request (SR) or preamble for random access), or perform random access.

However, the deactivated mode or deactivated state of the cell may mean that the bandwidth parts configured for the cell are inactive, the configured bandwidth parts are not active, or the configured bandwidth parts have no activated bandwidth part, so that the UE cannot exchange data with the base station, does not perform PDCCH monitoring to identify an indication of the base station, performs neither channel measurement nor measurement reporting, or transmits no pilot signal.

Therefore, in order to activate cells in a deactivated mode, the base station first configures frequency measurement configuration information for the UE via an RRC message, and the UE performs cell or frequency measurement based on the frequency measurement configuration information. The base station may receive a cell or frequency measurement report of the UE, and then may activate the deactivated cells based on the frequency/channel measurement information. Accordingly, a lot of latency occurs for the base station to activate carrier aggregation or dual connectivity for the UE and start data transmission or reception.

The disclosure proposes a dormant bandwidth part (dormant BWP) or a dormant state for a bandwidth part of each activated cell (e.g., activated SCell or activated PSCell) so as to save a battery power of the UE and quickly start data transmission or reception. Alternatively, the disclosure proposes configuration or introduction of a dormant BWP for each activated cell. Alternatively, the disclosure proposes configuration or introduction of an active state, a dormant state, a suspended state, a deactivated state, or a resumed state of a cell group state for each cell group when dual connectivity is configured for the UE, and proposes a method of performing an indication of cell group resumption (or SCG resumption) or cell group suspension (or SCG suspension), which indicates state transition of the cell group, and UE operations according thereto.

In the dormant bandwidth part (dormant BWP in activated SCell) or the bandwidth part in the dormant mode of the activated cell, or when the dormant bandwidth part is activated, the UE cannot exchange data with the base station, does not perform PDCCH monitoring to identify an indication of the base station, or does not transmit a pilot signal, but the UE performs channel measurement and reports a measurement result for a measured frequency/cell/channel periodically or when an event occurs, according to a configuration by the base station. Therefore, since the UE neither monitors PDCCH nor transmits a pilot signal in the dormant bandwidth part (dormant BWP) of the activated cell, the UE can save a battery power compared to a normal bandwidth part (or bandwidth part other than the dormant bandwidth part) of the activated cell or compared to when the normal bandwidth part (or bandwidth part other than the dormant bandwidth part) of the activated cell is activated. In addition, since the UE performs channel measurement reporting unlike when the cell is deactivated, the base station may quickly activate the normal bandwidth part of the activated cell based on a measurement report or based on a measurement report of the dormant bandwidth part of the activated cell, and may allow carrier aggregation to be used quickly, so as to reduce transmission latency.

Therefore, in the disclosure, the cell being in the active mode or activated state may represent that, in the cell in the active mode or in the activated cell, the UE may exchange uplink or downlink data with the base station in an activated bandwidth part, an activated normal bandwidth part, or a bandwidth part other than an activated dormant bandwidth part of the cell, may perform PDCCH monitoring to identify an indication of the base station, may perform channel measurement for downlink of the cell (or activated bandwidth part, activated normal bandwidth part, or activated bandwidth part other than the dormant bandwidth part of the cell) in the active mode or in the activated state, may report measurement information periodically to the base station, and may transmit a pilot signal (sounding reference signal (SRS)) periodically to the base station so that the base station can perform uplink channel measurement. In addition, in the disclosure, the cell being in the active mode or activated state may represent that, in the cell in the active mode or in the activated cell, the UE, in the dormant bandwidth part of the activated cell, cannot exchange uplink or downlink data with the base station or does not perform PDDCH monitoring to identify an indication of the base station, but may perform channel measurement for downlink of the activated dormant bandwidth part of the cell in the active mode or activated state, and may report measurement periodically to the base station.

If the cell, in which the dormant bandwidth part is activated or cell group suspension is indicated, is the PSCell, the UE may not monitor PDCCH, monitor PDCCH in a very long period, not receive downlink data; perform channel measurement or measurement result reporting, suspend the configured periodic transmission resource (e.g., type 1 periodic transmission resource (configured uplink grant type 1)), clear or initialize the configured periodic transmission resource (e.g., type 2 periodic transmission resource (configured uplink grant type 2)), transmit a sounding reference signal (SRS), not transmit uplink data, transmit PUCCH (e.g., scheduling request (SR) or preamble for random access), or perform random access.

As another method, if the cell, in which cell group deactivation (or suspension) is indicated, is the PSCell (or SCG), the UE may not monitor PDCCH, monitor PDCCH in a very long period, not receive downlink data, neither perform channel measurement nor measurement result reporting, suspend the configured periodic transmission resource (e.g., type 1 periodic transmission resource (configured uplink grant type 1)), clear or initialize the configured periodic transmission resource (e.g., type 2 periodic transmission resource (configured uplink grant type 2)), not transmit a sounding reference signal (SRS), not transmit uplink data, or not transmit PUCCH (e.g., scheduling request (SR) or preamble for random access). However, when cell group deactivation (or suspension) is indicated above, if frequency measurement configuration information is configured by the base station in the RRC message indicating cell group deactivation (or suspension), the UE may perform a frequency measurement procedure (radio resource management). Alternatively, in the case that radio link monitoring (RLM) configuration information is configured, the UE may operate a timer T310 when receiving an indication that the signal is not synchronized from the RLM procedure (lower layer (PHY layer)) based on the timer T310, and declare radio link failure when the timer T310 expires. If an indication that the signal is synchronized, the UE may suspend the running timer T310. In addition, when the cell group deactivation (or suspension) is indicated above, in the case that beam-related configuration information is configured to perform a beam failure detection in the RRC message indicating cell group deactivation (or suspension), the UE may transmit the beam failure detection.

In the disclosure, a dormant bandwidth part may indicate a state of a bandwidth part or may be used as a name of a logical concept indicating a specific bandwidth part. Therefore, the dormant bandwidth part may be activated, deactivated, or switched. For example, an indication of switching an activated second bandwidth part to a dormant bandwidth part in a first cell, an indication of shifting the first cell to a dormant state or a dormant mode, or an indication of activating the dormant bandwidth part of the first cell may be interpreted in the same way.

In addition, in the disclosure, a normal bandwidth part may indicate bandwidth parts other than a dormant bandwidth part from among bandwidth parts configured for each cell of the UE via an RRC message. In the normal bandwidth part, the UE may exchange uplink or downlink data with the base station, may monitor PDCCH to identify an indication of the base station, may perform channel measurement for a downlink, may periodically report measurement information to the base station, and may periodically transmit a pilot signal (sounding reference signal, SRS) to the base station so as to enable the base station to perform uplink channel measurement. In addition, the normal bandwidth part may indicate a first active bandwidth part, a default bandwidth part, a first active bandwidth part activated from dormancy, or an initial bandwidth part.

Only one dormant bandwidth part may be configured from among bandwidth parts configured for each cell of the UE, and the dormant bandwidth part may be configured for downlink. As another method, one dormant bandwidth part may be configured for uplink or downlink from among bandwidth parts configured for each cell of the UE.

In addition, in the disclosure, a state of a cell group may be configured to be activated, suspended, or deactivated. The state of the cell group may be indicated by a bitmap or an indicator of DCI of PDCCH, may be indicated via MAC control information, or may indicated by an indicator of an RRC message. In the case that the state of the cell group is indicated to be active, configuration information of the cell group configured or indicated via an RRC message (e.g., RRCReconfiguration message, RRCSetup message, or RRCResume message) may be stored and applied to the UE, or may be restored or resumed, and the UE may perform PDCCH monitoring according to the configuration via the RRC message in the PCell, PSCell, or configured SCell of the cell group, receive downlink data, perform channel measurement or measurement result reporting, resume the configured periodic transmission resource (e.g., type 1 periodic transmission resource (configured uplink grant type 1)), configure or activate the configured periodic transmission resource (e.g., type 2 periodic transmission resource (configured uplink grant type 2)), transmit a sounding reference signal (SRS), transmit uplink data, transmit PUCCH (e.g., scheduling request (SR) or preamble for random access), or perform random access.

In addition, in the case that the state of the cell group is indicated to be suspended (suspended state) or deactivated, configuration information of the cell group configured or indicated via the RRC message (e.g., RRCReconfiguration message, RRCSetup message, or RRCResume message) may be stored in the UE, or the configuration information may be not discarded but application thereof to the UE may be suspended, and the UE may not perform PDCCH monitoring according to the configuration via the RRC message in the PCell, PSCell, or configured SCell of the cell group, perform PDCCH monitoring in a very long period, not receive downlink data, perform channel measurement or measurement result reporting; suspend the configured periodic transmission resource (e.g., type 1 periodic transmission resource (configured uplink grant type 1)), clear or initialize the configured periodic transmission resource (e.g., type 2 periodic transmission resource (configured uplink grant type 2)), transmit a sounding reference signal (SRS), not transmit uplink data, transmit PUCCH (e.g., scheduling request (SR) or preamble for random access), or perform random access.

In addition, in the case that the state of the cell group is indicated to be deactivated, or release of cell group configuration information is indicated, the UE may clear or discard the configuration information of the cell group configured or indicated via the RRC message (e.g., RRCReconfiguration message, RRCSetup message, or RRCResume message).

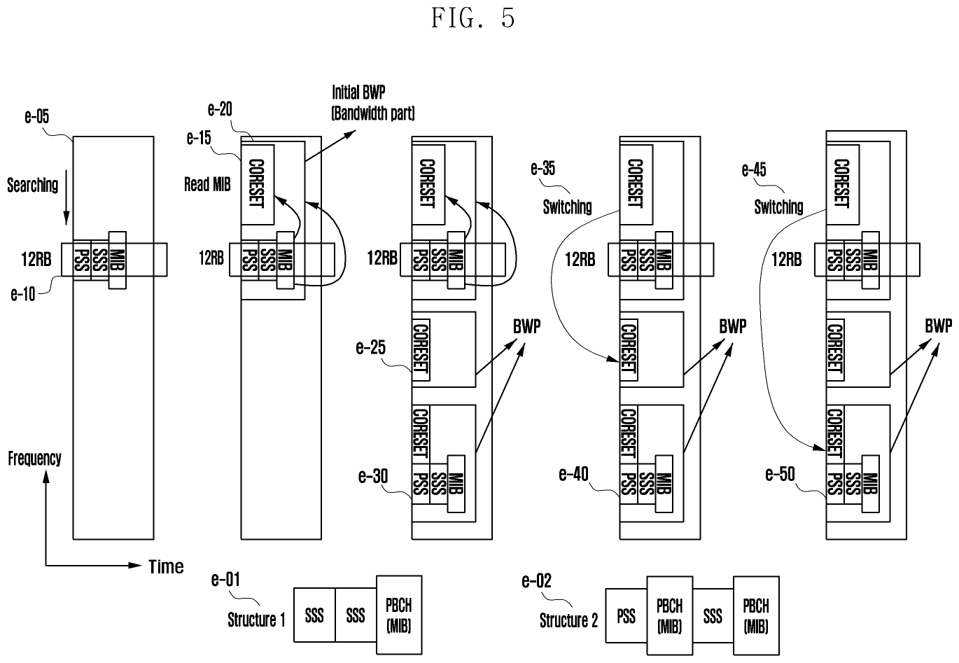

FIG. 5 is a diagram illustrating a procedure for providing a service to a UE by efficiently using a very wide frequency bandwidth in the next-generation mobile communication system according to an embodiment of the disclosure.

Referring to FIG. 5, a method of providing services to UEs having a plurality of different capabilities (or categories) and enabling battery saving by the next-generation mobile communication system by efficiently using a very wide frequency bandwidth.

One cell in which a base station provides a service may service a very wide frequency band, as shown in e-05. However, in order to provide services to UEs having different capabilities, one cell, in which the wide frequency band is divided into a plurality of bandwidth parts, may be managed.

First, a UE initially powered on may search the entire frequency band provided by a service provider (PLMN) in a unit of certain resource blocks (e.g., in a unit of 12 resource blocks (RBs)). For example, the UE may start searching for a primary synchronization sequence (PSS)/secondary synchronization sequence (SSS) in the entire system bandwidth in a unit of the resource blocks, e-10, e-30, e-40, or e-50. If the UE detects the PSS/SSS e-01 or e-02 while searching for the signals in the unit of resource blocks, the UE may read and interpret (decode) the signals, and may identify a boundary between a subframe and a radio transmission resource frame (radio frame). Accordingly, the UE may distinguish subframes in a unit of 1 ms, and may synchronize a downlink signal with the base station. A resource block (RB) corresponds to the size of a predetermined frequency resource and predetermined time resource, and may be defined to be a two-dimensional unit. For example, a unit of 1 ms may be defined for a time resource, and a unit of 12 subcarriers (1 carrier×15 kHz=180 kHz) may be defined for a frequency resource. When the UE completes synchronization, the UE may identify a master system information block (MIB) or minimum system information (MSI) to identify control resource set (CORESEST) information, and may identify initial access bandwidth part (initial BWP), e-15 and e-20. The CORESEST information e-25 refers to a location of a time/frequency transmission resource, via which a control signal is transmitted from the base station, and indicates, for example, a location of a resource via which PDCCH is transmitted. For example, the CORESET information is information indicating from where first system information (system information block 1, SIB1) is transmitted, and indicates a frequency/time resource via which PDCCH is transmitted. The UE may identify information on an initial bandwidth part (initial BWP) when reading the first system information. As described above, when the UE completes synchronization of the downlink signal with the base station and is able to receive a control signal, the UE may perform random access in an initial bandwidth part (initial BWP) of a cell on which the UE camps, may request an RRC connection configuration, and may receive an RRC message so as to perform RRC connection configuration.

In the RRC connection configuration, the plurality of bandwidth parts may be configured for one cell (PCell, PSCell, SPCell, or SCell). The plurality of bandwidth parts may be configured for downlink within one cell, and regardless thereof, the plurality of bandwidth parts may be separately configured for uplink.

The plurality of bandwidth parts may be indicated and configured by a bandwidth part identifier (BWP identifier) so as to be used as an initial bandwidth part (initial BWP), a default bandwidth part (default BWP), a first active bandwidth part (first active BWP), a dormant bandwidth part (dormant BWP), or a first active bandwidth part activated from dormancy (first active BWP from dormant).

The initial bandwidth part (initial BWP) may be used as a bandwidth part determined at a cell level (cell-specific) existing one for each cell, and may be used as a bandwidth part in which a UE accessing the cell for the first time may configure a connection to the cell via random access, or a UE having configured a connection may perform synchronization. In addition, the base station may configure, for each cell, each of an initial downlink bandwidth part (initial downlink BWP) to be used in downlink and an initial uplink bandwidth part (initial uplink BWP) to be used in uplink. In addition, configuration information for the initial bandwidth part may be broadcast in the first system information (system information 1, SIB1) indicated by CORESET, and may be reconfigured for a connected UE by the base station via an RRC message. In addition, the initial bandwidth part may be designated with a bandwidth part identifier of 0 so as to be used in each of uplink and downlink. For example, all UEs accessing the same cell may use the same initial bandwidth part by designating the same bandwidth part identifier of 0. This is because, when random access is performed, the base station may transmit a random access response (RAR) message via the initial bandwidth part, which enables all UEs to read the RAR message, so that there may be an advantage in facilitating contention-based random access.

The first active bandwidth part (first active BWP) may be configured to be different for each UE (UE-specific), and may be designated and indicated by a bandwidth part identifier from among the plurality of bandwidth parts. The first active bandwidth part may be configured for each of downlink and uplink, and may be configured, by a bandwidth part identifier, as each of a first active downlink bandwidth part (first active downlink BWP) and a first active uplink bandwidth part (first active uplink BWP). The first active bandwidth part may be used for the purpose of indicating a bandwidth part which is to be initially activated and used, when the plurality of bandwidth parts are configured in one cell. For example, when a PCell or a PSCell and a plurality of SCells are configured for a UE, and the plurality of bandwidth parts are configured for each of the PCell, PSCell, or SCells, if the PCell, PSCell, or SCells are activated, the UE may activate and use a first active bandwidth part (first active BWP) among the plurality of bandwidth parts configured for the PCell, PSCell, or SCells. For example, the first active downlink bandwidth part (first active downlink BWP) may be activated and used for downlink, and the first active uplink bandwidth part (first active uplink BWP) may be activated and used for uplink.

An operation in which the UE switches the current or activated downlink bandwidth part of the cell so as to activate the first active downlink bandwidth part (or bandwidth part configured or indicated via an RRC message), or an operation in which the UE switches the current or activated uplink bandwidth part so as to activate the first active uplink bandwidth part (or bandwidth part configured or indicated via an RRC message), may be performed when the UE receives an indication of activating the cell or the bandwidth part, which has been deactivated, via an RRC message, MAC control information, or DCI. In addition, an operation may be also performed when an indication of shifting the cell or the bandwidth part to a dormant state or an indication of activation to a dormant bandwidth part is received via an RRC message, MAC control information, or DCI. It is because, when the cell or the bandwidth part is activated, the current or activated downlink bandwidth part is switched to activate the first active downlink bandwidth part (or bandwidth part configured or indicated by an RRC message), or the uplink bandwidth part is switched to activate the first active uplink bandwidth part (or bandwidth part configured or indicated by an RRC message), and therefore the base station can efficiently use carrier aggregation only if a frequency/channel should be measured and reported for the first active downlink/uplink bandwidth part even when channel measurement reporting is performed in a dormant state. The default bandwidth part (default BWP) may be configured to be different for each UE (UE-specific), and may be designated and indicated by a bandwidth part identifier from among the plurality of bandwidth parts. The default bandwidth part may be configured only for downlink. The default bandwidth part may be used as a bandwidth part, to which an activated bandwidth part among the plurality of downlink bandwidth parts falls back after a certain time. For example, a bandwidth part inactivity timer (BWP inactivity timer) may be configured for each cell or each bandwidth part via an RRC message, and the timer may start or restart when data transmission or reception occurs in an activated bandwidth part other than the default bandwidth part, or the timer may start or restart when the activated bandwidth part is switched to another bandwidth part. When the timer expires, the UE may cause the downlink bandwidth part activated for the cell to fall back or switch to the default bandwidth part. The switching e-35 or e-45 may refer to deactivating a currently activated bandwidth part and activating a bandwidth part indicated for switching, and the switching may be triggered by an RRC message, MAC control information (MAC control element), or L1 signaling (downlink control information (DCI) of PDCCH). The switching may be triggered by indicating a bandwidth part to be switched or to be activated, and the bandwidth part may be indicated by a bandwidth part indicator (e.g., 0, 1, 2, 3, or 4).

The default bandwidth part is applied and used only for downlink because the base station may cause the UE to fall back to the default bandwidth part for each cell after a certain time to receive an indication (e.g., DCI of PDCCH) from the base station, thereby facilitating base station scheduling. For example, if the base station configures, as initial bandwidth parts, default bandwidth parts of UEs accessing one cell, the base station may continuously indicate scheduling only for the initial bandwidth parts after a certain time. In the case that the default bandwidth parts are not configured in an RRC message, the UE considers initial bandwidth parts as the default bandwidth parts, and may perform fallback to the initial bandwidth parts when a bandwidth part inactivity timer expires.

As another method, in order to enhance the freedom of implementation of the base station, a default bandwidth part may be also defined and configured for uplink and may be used as a default bandwidth part of downlink.

The dormant bandwidth part (dormant BWP) refers to a bandwidth part in a dormant mode or a dormant bandwidth part (dormant BWP in activated SCell) in an activated cell, or when the dormant bandwidth part is activated, the UE cannot exchange data with the base station, does not perform PDCCH monitoring to identify an indication of the base station, or does not transmit a pilot signal, but the UE performs channel measurement and reports a measurement result for a measured frequency/cell/channel periodically or when an event occurs, according to a configuration by the base station. Therefore, since the UE neither monitors PDCCH nor transmits a pilot signal in the dormant bandwidth part (dormant BWP) of the activated cell, the UE can save a battery power compared to a normal bandwidth part (or bandwidth part other than the dormant bandwidth part) of the activated cell or compared to when the normal bandwidth part (or bandwidth part other than the dormant bandwidth part) of the activated cell is activated, and since the UE performs channel measurement reporting unlike when the cell is deactivated, the base station may quickly activate the normal bandwidth part of the activated cell based on a measurement report or based on a measurement report of the dormant bandwidth part of the activated cell, and may allow carrier aggregation to be used quickly, so as to reduce transmission latency.

For a first active bandwidth part (or first active non-dormant bandwidth part, or bandwidth part configured or indicated via an RRC message) that is activated by switching from a dormant state or a dormant bandwidth part, when the UE is operating, as a dormant bandwidth part, a bandwidth part of one activated cell, when an activated bandwidth part is a dormant bandwidth part in the activated cell, or when a bandwidth part other than a dormant bandwidth part is switched to a dormant bandwidth part in the cell, if the base station indicates, via DCI of PDCCH, a MAC CE, or an RRC message, the UE to switch the dormant bandwidth part, which is the bandwidth part of the activated cell, to a normal bandwidth part (or bandwidth part other than the dormant bandwidth part), indicates the UE to switch or change the active bandwidth part in the dormant bandwidth part to the normal bandwidth part, or indicates the UE to switch or change or activate the active bandwidth part in the dormant bandwidth part to a normal bandwidth part (e.g., first active bandwidth part activated from dormancy), the first active bandwidth part may be a bandwidth part, which should be activated by switching the current or activated bandwidth part of the activated cell by the UE according to the indication, or a bandwidth part which should be activated from the dormant state configured via the RRC message.

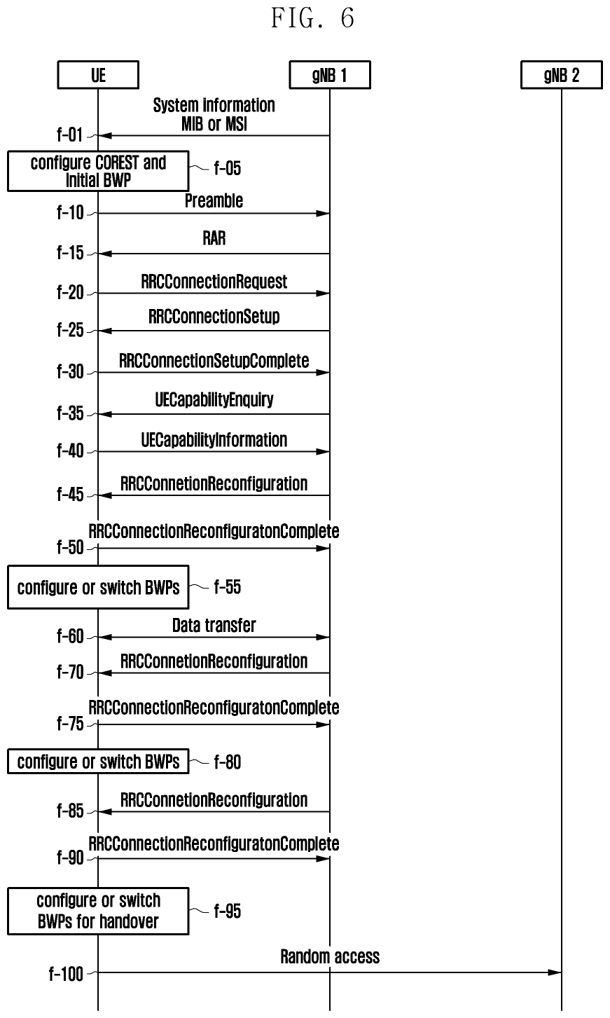

FIG. 6 is a diagram illustrating a procedure for a UE to switch from an RRC idle mode to an RRC connected mode, and a procedure for configuring bearer configuration information, cell group or cell configuration information, or channel measurement configuration information for connection to a UE, in the next-generation mobile communication system according an embodiment to the disclosure.

One cell in which a base station provides a service may service a very wide frequency band. First, a UE may search the entire frequency band provided by a service provider (PLMN) in a unit of certain resource blocks (e.g., in a unit of 12 resource blocks (RBs)). For example, the UE may start searching for a primary synchronization sequence (PSS)/secondary synchronization sequence (SSS) in the entire system bandwidth in a unit of the resource blocks. If the UE detects the PSS/SSS while searching for the signals in a unit of the resource blocks, the UE may read and interpret (decode) the signals, and may identify a boundary between a subframe and a radio transmission resource frame (radio frame). When the UE completes synchronization, the UE may read system information of a cell on which the UE currently camps. For example, information of a control resource set (CORESET) may be identified by identifying a master system information block (MIB) or minimum system information (MSI), and initial bandwidth part (initial BWP) information may be identified by reading system information, in f-01, f-05. The CORESEST information refers to a location of a time/frequency transmission resource, via which a control signal is transmitted from the base station, and may indicate, for example, a location of a resource via which PDCCH is transmitted.

As described above, if the UE completes synchronization of a downlink signal with the base station and may receive a control signal, the UE, in an initial bandwidth part, may perform random access, may receive a random access response, may request an RRC connection configuration, may receive an RRC message, and may perform RRC connection configuration, in f-10, f-15, f-20, f-25, f-30.

If basic RRC connection configuration is completed, the base station may transmit, to the UE, an RRC message (UECapabilityEnquiry, f-35) to inquire about the capability of the UE, so as to identify the capability of the UE (UE capability). As another method, the base station may inquire about the capability of the UE to an MME or an AMF so as to identify the capability of the UE. For example, the base station may transmit a message for requesting the capability of the UE to a core network entity, such as MME or AMF. And as a response, the base station may receive a message including capability information of the UE from the MME or AMF. This is because the MME or the AMF may have stored capability information of the UE if the UE had been previously connected. If there is no UE capability information desired by the base station, the base station may request UE capability from the UE. When the UE reports the UE capability, the UE may report the following information as the UE capability to the base station, where the information includes whether the UE supports a dormant bandwidth part for an SCell of each cell group (master cell group or secondary cell group), whether the UE supports the first, second, third, or fourth embodiment of the disclosure, whether the UE supports a dormant bandwidth part for a PSCell of each cell group, whether the UE supports cell group suspension or resumption for the PSCell of each cell group, the number of supporting cell groups, or the like. In addition, the UE may also report the following information as the UE capability to the base station, where the information includes whether it is possible, in RRC connection resumption procedure, to save and restore, discard, partially reconfigure, or activate configuration information of an SCell of a master cell group, an SCell of a secondary cell group, or a PSCell of a secondary cell group via an RRCResume message.

The reason that the base station transmits an RRC message to the UE to identify the capability of the UE is that the capability of the UE may be thus identified, for example, a frequency band which the UE is capable of read, or a readable frequency band area may be determined. After the capability of the UE is identified, an appropriate bandwidth part (BWP) may be configured for the UE. When the UE receives an RRC message inquiring about the capability of the UE, in response to the reception of the RRC message, the UE may indicate, using an offset from a reference center frequency, a range of a bandwidth supported by the UE, a range of a bandwidth supported by a current system bandwidth, or the like, may directly indicate a start point and an end point of a supported frequency bandwidth, or may indicate the start and end points by using a center frequency and a bandwidth, in f-40.

A bandwidth part may be configured via an RRCSetup message, an RRCResume message, or an RRCReconfiguration message f-45 and f-70 of RRC connection configuration, and the RRC message may include configuration information for a PCell, a PSCell, or a plurality of cells, and may configure a plurality of bandwidth parts for each of the cells (PCell, PSCell, or SCells). When the plurality of bandwidth parts are configured for each of the cells, the plurality of bandwidth parts to be used in downlink of each of the cells may be configured. In a case of an FDD system, the plurality of bandwidth parts to be used in uplink of each cell may be configured separately from the downlink bandwidth parts. In a case of a TDD system, the plurality of bandwidth parts to be commonly used in downlink and uplink of each of the cells may be configured.

Cell configuration information or information for configuring bandwidth parts of each of the cells (PCell, PSCell, or SCells) may include some of the following information.
Cell identifier (SCell index)
Cell configuration information
   ▪ First channel measurement configuration information for each cell or bandwidth part
   ▪ Second channel measurement configuration information for each cell or bandwidth part
Downlink bandwidth part configuration information of the cell
   ▪ Initial downlink bandwidth part (initial downlink BWP) configuration information
   ▪ Multiple pieces of bandwidth part configuration information, and bandwidth part identifier (BWP ID) corresponding to each bandwidth part
   ▪ Initial state configuration information of the cell or downlink bandwidth part (e.g., active state, dormant state, or deactivated state)
   ▪ Bandwidth part identifier indicating a first active downlink bandwidth part (first active downlink BWP)
   ▪ Bandwidth part identifier indicating a default bandwidth part (default BWP)
   ▪ Configuration information for PDCCH monitoring for each bandwidth part. For example, CORESET information, search space resource information, PDCCH transmission resource, period, subframe number information, or the like
   ▪ Bandwidth part identifier indicating a dormant bandwidth part
   ▪ Bandwidth part identifier indicating a first active bandwidth part activated from dormancy
   ▪ Bandwidth part inactivity timer configuration and timer value
   ▪ First channel measurement configuration information for each cell or bandwidth part
   ▪ Second channel measurement configuration information for each cell or bandwidth part
Uplink bandwidth part configuration information of the cell
   ▪ Initial uplink bandwidth part (initial uplink BWP) configuration information
   ▪ Multiple pieces of bandwidth part configuration information, and a bandwidth part identifier (BWP ID) corresponding to each bandwidth part
   ▪ Initial state configuration information of the cell or downlink bandwidth part (e.g., active state, dormant state, or deactivated state)
   ▪ Bandwidth part identifier indicating a first active uplink bandwidth part (first active uplink BWP)
Configuration information relating to a transmission resource via which channel measurement is performed in a dormant bandwidth part or in a bandwidth part other than the dormant bandwidth part, and a measurement result is reported (e.g., PUCCH transmission resource information of a PCell, a PUCCH SCell, or a PSCell).

For quick activation of the cell group, in the configuration information of the cell (e.g., PCell or PSCell or SCell) of the cell group so that the base station is able to transmit many channel measurement signals temporarily or transmit a channel measurement signal frequently to enable quick channel measurement in the cell, the first channel measurement configuration information included and configured in the RRC message (RRCReconfiguration or RRCResume) may include a cycle for a frequent channel measurement signal (e.g., radios resource or temporary reference signal (TRS), synchronization signal block (SSB), channel state information reference signal (CSI-RS) or reference signal (RS)), transmission resource information for transmission (frequency or time transmission resource via which the frequent channel measurement signal is transmitted), an interval or frequency (the number of times the frequent channel measurement signal is transmitted), a timer value (time at which the frequent channel measurement signal is transmitted), a time interval (interval in which the frequent channel measurement signal is transmitted (e.g., an offset of time unit (slot, subframe, symbol, or the like)), or a transmission resource, period, interval, timing, offset, or the like via which the UE should report a measurement result. In the above, the first channel measurement configuration information may configure a short reporting cycle (or transmission resource) for the UE to report the channel measurement result, or transmission resource for channel measurement so that the base station is able to transmit many channel measurement signals (or transmission resources or (e.g., radios resource or temporary reference signal (TRS))) or transmit a channel measurement signal frequently to support the quick channel measurement or many signal measurement of the UE. In the above, the first channel measurement configuration information may include configuration information for a channel measurement signal for a specific UE (or UEs) in the cell or BWP by a base station. For example, the first channel measurement configuration information may include a cycle of the channel measurement signal, the number of times the signal is transmitted, an interval in which the signal is transmitted, an offset for the time during which the signal is transmitted, a time interval between signals to be transmitted, a list of plurality of channel measurement signals that can be transmitted, a time transmission resource (or frequency transmission resource) indicating the location of the signal to be transmitted, a transmission resource (time transmission resource or frequency transmission resource) for reporting measurement results, a cycle for reporting measurement results, or the like. In addition, the first channel measurement configuration information may be configured differently for each cell or for each BWP for a plurality of cells or BWPs configured in the RRC message, and the beam-related configuration information, such as a beam direction, a beam number or a beam location (e.g., transmission configuration indication (TCI) state or quasi co-location (QCL)) can be configured together so that the UE can easily measure transmission resources for channel measurement. In addition, the first channel measurement configuration information may be configured with a timing advance (TA) value (or offset value) for synchronizing the downlink signal of the base station or the uplink signal of the base station, or a timer (time alignment timer (TAT)) or timer value (TAT value) that indicates the validity of the TA value, so that channel measurement or channel measurement reporting can be correctly performed. In addition, the first channel measurement configuration information configured as an RRC message may include a plurality of channel measurement signal information, and any one channel measurement signal information of the plurality of channel measurement signal information configured above as an RRC message or MAC CE or DCI, or beam configuration information may be indicated so that the UE may perform channel measurement or channel measurement reporting by applying or using the indicated channel measurement signal information or beam configuration information. In the above, the method for indication may define a mapping between a bitmap, index, or identifier and each channel measurement signal information configured above, and may make an indication based on this. As another method, by configuring or indicating the channel measurement signal information via the RRC message or MAC CE, the UE performs channel measurement by applying or using the configured (or indicated) channel measurement signal information or channel measurement reporting.

The first channel measurement configuration information proposed in the disclosure may be initially deactivated when configured as an RRC message or after handover, and may be activated later by the MAC control information or DCI information of PDCCH DCI or RRC message proposed later in the disclosure. In the case that the first channel measurement configuration information is configured as the RRC message as described above, the base station can easily manage the cell state or channel measurement procedure of the UE only when the initial state is a deactivated state, and the timing of when and how the UE performs channel measurement can also be accurately performed without a processing delay problem of the RRC message.

In addition, a second channel measurement configuration information may be included in the RRC message (RRCReconfiguration or RRCResume). The second channel measurement configuration information may include general channel measurement configuration information, such as a transmission resource, cycle, time interval, or frequency of channel measurement signal, or a transmission resource, cycle, or time interval for channel measurement reporting.

The initial bandwidth part (initial BWP), default bandwidth part (default BWP), or first active bandwidth part (first active BWP) configured above can be used for the following purposes, and can operate as follows to meet the purpose.

The initial bandwidth part (initial BWP) may be used as a bandwidth part determined at a cell level (cell-specific) existing one for each cell, and may be used as a bandwidth part in which a UE accessing the cell for the first time may configure a connection to the cell via random access, or a UE having configured a connection may perform synchronization. In addition, the base station may configure, for each cell, each of an initial downlink bandwidth part (initial downlink BWP) to be used in downlink and an initial uplink bandwidth part (initial uplink BWP) to be used in uplink. In addition, configuration information for the initial bandwidth part may be broadcast in the first system information (system information 1, SIB1) indicated by CORESET, and may be reconfigured for a connected UE by the base station via an RRC message. In addition, the initial bandwidth part may be designated with a bandwidth part identifier of 0 so as to be used in each of uplink and downlink. For example, all UEs accessing the same cell may use the same initial bandwidth part by designating the same bandwidth part identifier of 0. This is because, when random access is performed, the base station may transmit a random access response (RAR) message via the initial bandwidth part, which enables all UEs to read the RAR message, so that there may be an advantage in facilitating contention-based random access.

The first active bandwidth part (first active BWP) may be configured to be different for each UE (UE-specific), and may be designated and indicated by a bandwidth part identifier from among the plurality of bandwidth parts. The first active bandwidth part may be configured for each of downlink and uplink, and may be configured, by a bandwidth part identifier, as each of a first active downlink bandwidth part (first active downlink BWP) and a first active uplink bandwidth part (first active uplink BWP). The first active bandwidth part may be used for the purpose of indicating a bandwidth part which is to be initially activated and used, when the plurality of bandwidth parts are configured in one cell. For example, when a PCell or a PSCell and a plurality of SCells are configured for a UE, and the plurality of bandwidth parts are configured for each of the PCell, PSCell, or SCells, if the PCell, PSCell, or SCells are activated, the UE may activate and use a first active bandwidth part (first active BWP) among the plurality of bandwidth parts configured for the PCell, PSCell, or SCells. For example, the first active downlink bandwidth part (first active downlink BWP) may be activated and used for downlink, and the first active uplink bandwidth part (first active uplink BWP) may be activated and used for uplink.

An operation in which the UE switches the current or activated downlink bandwidth part of the cell so as to activate the first active downlink bandwidth part (or bandwidth part configured or indicated via an RRC message), or an operation in which the UE switches the current or activated uplink bandwidth part so as to activate the first active uplink bandwidth part (or bandwidth part configured or indicated via an RRC message), may be performed when the UE receives an indication of activating a bandwidth part of an activated cell or a cell, which has been deactivated or dormant, or when the UE receives an indication of switching or activating a deactivated or dormant bandwidth part to a normal bandwidth part, where the indications are received via an RRC message, MAC control information, or DCI of PDCCH. In addition, when the UE receives, via an RRC message, MAC control information, or DCI of PDCCH, an indication of shifting an activated cell or an activated bandwidth part to a dormant state, or receives an indication of switching or activating a dormant bandwidth part, the UE may switch or activate the bandwidth part to the dormant bandwidth part or may make the bandwidth part dormant.

In the above, dormant, switching to the dormant bandwidth part, or activating to the dormant bandwidth part may refer to performing operations proposed in the dormant state in the disclosure. For example, the UE does not perform PDCCH monitoring, but may perform channel measurement for a downlink bandwidth part (or dormant bandwidth part) and may report a channel measurement result to the base station. As another method, when the activated cell or activated bandwidth part is activated or switched to a normal bandwidth part, a downlink bandwidth part is switched so as to be activated to a first active downlink bandwidth part, and an uplink bandwidth part is switched so as to be activated to a first active uplink bandwidth part, and therefore the dormant bandwidth part may be configured as a default bandwidth part or the first active downlink or uplink bandwidth part. The default bandwidth part (default BWP) may be configured to be different for each UE (UE-specific), and may be designated and indicated by a bandwidth part identifier from among the plurality of bandwidth parts. The default bandwidth part may be configured only for downlink. The default bandwidth part may be used as a bandwidth part, to which an activated bandwidth part among the plurality of downlink bandwidth parts falls back after a certain time. For example, a bandwidth part inactivity timer (BWP inactivity timer) may be configured for each cell or each bandwidth part via an RRC message, and the timer may start or restart when data transmission or reception occurs in an active bandwidth part other than the default bandwidth part, or the timer may start or restart when the activated bandwidth part is switched to another bandwidth part. When the timer expires, the UE may cause the downlink bandwidth part activated for the cell to fall back or switch to the default bandwidth part. The switching may refer to a procedure for deactivating a currently activated bandwidth part and activating a bandwidth part indicated for switching, and the switching may be triggered by an RRC message, MAC control information (MAC control element), or L1 signaling (downlink control information (DCI) of PDCCH). The switching may be triggered by indicating a bandwidth part to be switched or to be activated, and the bandwidth part may be indicated by a bandwidth part indicator (e.g., 0, 1, 2, 3, or 4).

The default bandwidth part is applied and used only for downlink because the base station may cause the UE to fall back to the default bandwidth part for each cell after a certain time to receive an indication (e.g., DCI of PDCCH) from the base station, thereby facilitating base station scheduling. For example, if the base station configures, as initial bandwidth parts, default bandwidth parts of UEs accessing one cell, the base station may continuously indicate scheduling only for the initial bandwidth parts after a certain time. If the default bandwidth parts are not configured in an RRC message, initial bandwidth parts may be considered as the default bandwidth parts, and fallback may be performed to the initial bandwidth parts when a bandwidth part inactivity timer expires.

In another method, in order to enhance the freedom of implementation of the base station, a default bandwidth part may be also defined and configured for uplink and may be used as a default bandwidth part of downlink.

The dormant bandwidth part (dormant BWP) refers to a bandwidth part in a dormant mode or a dormant bandwidth part (dormant BWP in activated SCell) in an activated cell. When the dormant bandwidth part is activated, the UE cannot exchange data with the base station, does not perform PDCCH monitoring to identify an indication of the base station, or does not transmit a pilot signal, but the UE performs channel measurement and reports a measurement result for a measured frequency/cell/channel periodically or when an event occurs, according to a configuration by the base station. Therefore, since the UE neither monitors PDCCH nor transmits a pilot signal in the dormant bandwidth part (dormant BWP) of the activated cell, the UE can save a battery power compared to a normal bandwidth part (or bandwidth part other than the dormant bandwidth part) of the activated cell or compared to when the normal bandwidth part (or bandwidth part other than the dormant bandwidth part) of the activated cell is activated, and since the UE performs channel measurement reporting unlike when the cell is deactivated, the base station may quickly activate the normal bandwidth part of the activated cell based on a measurement report or based on a measurement report of the dormant bandwidth part of the activated cell, and may allow carrier aggregation to be used quickly, so as to reduce transmission latency.

In the above, for a first active bandwidth part (or first active non-dormant bandwidth part) that is activated from dormancy, when the UE is operating, as a dormant bandwidth part, a bandwidth part of one activated cell, when an activated bandwidth part is the dormant bandwidth part in the activated cell, or when a bandwidth part other than the dormant bandwidth part is switched to the dormant bandwidth part in the cell, in the case that the base station indicates, via DCI of PDCCH, a MAC CE, or an RRC message, the UE to switch the bandwidth part of the activated cell from the dormant bandwidth part to a normal bandwidth part (or bandwidth part other than the dormant bandwidth part), indicates UE to switch or change the active bandwidth part in the dormant bandwidth part to the normal bandwidth part, or indicates the UE to switch or change or activate the active bandwidth part in the dormant bandwidth part to the normal bandwidth part (e.g., first active bandwidth part activated from dormancy), a bandwidth part, to which the UE should switch or activate the bandwidth part of the activated cell according to the indication, may be the first active bandwidth part activated from dormancy configured via the RRC message.

In the disclosure, switching a first bandwidth part to a second bandwidth part may be interpreted as activating the second bandwidth part, or may be interpreted as deactivating the activated first bandwidth part and activating the second bandwidth part.

In addition, in the RRCSetup message, RRCResume message f-25, or RRCReconfiguration message f-45 of the RRC connection configuration, a state shift timer may be configured so that the UE may perform state transition by itself even if the UE does not receive, from the base station, an indication via an RRC message, MAC control information, or DCI of PDCCH. For example, a cell inactivity timer (ScellDeactivationTimer) may be configured for each cell, and if the cell inactivity timer expires, the cell may be shifted to a deactivated state.

In addition, in the RRCSetup message, RRCResume message f-25, or RRCReconfiguration message f-45 of the RRC connection configuration, frequency measurement configuration information (measurement configuration), frequency measurement gap information (measurement gap information), and the like may be configured, and frequency measurement object (measurement object) information may be included. In the RRCSetup message, RRCResume message f-25, or RRCReconfiguration message f-45, f-70, or f-85 of the RRC connection configuration, a function (power saving mode) for reducing power consumption of the UE may be configured, and configuration information, such as a discontinuous reception (DRX) cycle, an offset, an on-duration time (time during which the UE needs to monitor PDCCH), or time information, or the like, information on a time at which PDCCH from the base station is monitored or detected before the on-duration time in the DRX cycle, short time cycle information, or the like may be configured in addition to the function for reducing power consumption. If the function for reducing power consumption of the UE is configured, the UE may configure a DRX cycle, and may detect a wake-up signal (WUS) in a period configured for monitoring of PDCCH of the base station before the on-duration time, and the base station may indicate, via DCI of PDCCH of the WUS, to the UE whether to skip (or not perform) or perform PDCCH monitoring in an immediately following on-duration time. The UE always needs to monitor PDCCH in the on-duration time, where the base station indicates, via the WUS, to the UE not to perform PDCCH monitoring in the on-duration time, so as to enable reduction of battery consumption.

When the RRC connection configuration is completed f-50, f-75, or f-90 as described above, the UE may configure a plurality of bandwidth parts f-55, f-80, or f-95 according to an indication configured via an RRC message. In order to save battery, one or a small number of bandwidths among the plurality of configured bandwidth parts may be activated. For example, the base station may indicate, to the UE, one bandwidth part to be activated. Further, the base station may indicate activation of the bandwidth part via an RRC message, MAC control information (MAC CE), or L1 signaling (PHY layer control signal, such as DCI of PDCCH), so as to indicate switching from an initial access bandwidth part to a new bandwidth part. As another method, new bitmap information may be defined in DCI of PDCCH, and whether to activate a normal bandwidth part (or bandwidth part other than a dormant bandwidth part), whether to activate a dormant bandwidth part, or whether to deactivate a bandwidth part may be indicated. As another method, the bitmap may indicate whether to activate a normal bandwidth part (e.g., first active bandwidth part to be activated from dormancy), whether to active a dormant bandwidth part, whether to switch to a dormant bandwidth part, or whether to perform bandwidth part switching. Since there may be many other new users accessing the initial access bandwidth part, it may be more advantageous, in terms of scheduling, to assign a new bandwidth part and separately manage connected users. This is because the initial access bandwidth part is not configured for each UE, but may be shared and used in common for all UEs. Further, in order to reduce signaling overhead, a default bandwidth part may be dynamically indicated by MAC control information, L1 signaling, or system information.

In the RRC message (RRCSetup message, RRCResume message f-25, or RRCReconfiguration message f-70), configuration information for a cell group may also be included. The configuration information for a cell group may include some or multiple pieces of information from the following information, or may indicate a state, procedure, application or releasing of configuration information, or the like for each cell group.
Cell group identifier indicating a cell group (e.g., cell group identifier or index)
Indicator indicating a state of a cell group (e.g., active state, suspended state, or deactivated state)
Indicator indicating a state of a cell group (e.g., indicator for suspending (or deactivating) a cell group (e.g., cellgroup (SCG) suspension indicator) or indicator for resuming (or activating) a cell group (e.g., cellgroup (SCG) resumption indicator))
Indicator for triggering a procedure of a corresponding protocol layer (e.g., SDAP layer, PDCP layer, RLC layer, or MAC layer) according to the indicator indicating a state of a cell group (e.g., PDCP re-establishment indicator, PDCP data recovery indicator, indicator triggering a new procedure, RLC re-establishment indicator, MAC layer initialization indicator, or MAC layer partial initialization indicator).
In the case that an indicator for suspending (or deactivating) a state of a cell group is included, second DRX configuration information (e.g., monitoring time, active time (on duration) length, cycle, offset, or the like) which enables PDCCH monitoring to be performed with a very long cycle in a PSCell of the cell group may be configured. For example, when the UE receives an indicator for suspending the cell group, the UE may perform PDCCH monitoring based on a very long cycle by applying the second DRX configuration information, so as to save power of the UE. As another method, when the UE receives the indicator for suspending the cell group, the UE may, by applying bandwidth part configuration information for the PSCell of the cell group, activate or switch a downlink bandwidth part of the PSCell of the cell group to a dormant bandwidth part, and may perform UE operations, in a cell for which a dormant bandwidth part is activated, which are proposed in the disclosure. In addition, when the UE receives the indicator for suspending the cell group, the UE may deactivate all SCells configured in the cell group. As another method, when the UE receives the indicator for suspending the cell group, the UE may activate or switch a downlink bandwidth part to a dormant bandwidth part with respect to an SCell, for which a dormant bandwidth part is configured, among the SCells configured in the cell group, and may perform UE operations, in a cell for which a dormant bandwidth part is activated, which are proposed in the disclosure, or may perform deactivation for an SCell for which a dormant bandwidth part is not configured. As another method, when the UE receives, via the RRC message, the indicator for suspending the cell group, the UE may, according to the indicator or configuration information on each SCell of the cell group, which is included in the RRC message, activate or deactivate each SCell, make each SCell dormant, or activate a dormant bandwidth part, or the UE may activate or deactivate each SCell of the cell group, make each SCell dormant, or activate a dormant bandwidth part, via the indicator (e.g., bitmap) of PDCCH, the MAC control information, or the RRC message before or after reception of the indicator for suspending the cell group.
Configuration information relating to a transmission resource via which channel measurement is performed in a dormant bandwidth part or in a bandwidth part other than the dormant bandwidth part, and a measurement result is reported (e.g., PUCCH transmission resource information of a PCell, a PUCCH SCell, or a PSCell)
In the case that an indicator for resuming (or activating) a state of a cell group is included, first DRX configuration information (e.g., monitoring time, active time (on duration) length, cycle, offset, or the like) which enables PDCCH monitoring to be performed again in a PSCell of the cell group may be configured. Alternatively, the first DRX configuration information stored for the cell group may be restored and applied. For example, when the UE receives an indicator for resuming the cell group, the UE may perform PDCCH monitoring by applying the stored first DRX configuration information or the first DRX configuration information received via the RRC message, thereby resuming data transmission or reception f-60. As another method, when the UE receives an indicator for resuming the cell group, the UE may activate or switch a downlink bandwidth part of the PSCell of the group to a bandwidth part (e.g., bandwidth part configured via an RRC message) other than a dormant bandwidth part, by applying bandwidth part configuration information for the PSCell of the cell group, and the UE may perform UE operations, in a cell for which a normal bandwidth part (bandwidth part other than a dormant bandwidth part) is activated, which are proposed in the disclosure. Alternatively, when the UE receives an indicator for resuming the cell group, the UE may trigger random access f-100 in the PSCell of the cell group by applying stored random access configuration information or random access configuration information received via the RRC message (random access transmission resource information (time or frequency transmission resource) or dedicated preamble information for transmission of a preamble, or the like). As another method, when the UE receives an indicator for resuming the cell group, if the RRC message includes the random access configuration information (random access transmission resource information (time or frequency transmission resource) or dedicated preamble information for transmission of a preamble, or the like), the UE may trigger random access (e.g., contention-free random access) in the PSCell of the cell group by applying the random access configuration information, and if the RRC message for indicating resumption or activation of the cell group does not include the random access configuration information (random access transmission resource information (time or frequency transmission resource) or dedicated preamble information for transmission of a preamble, or the like), the UE may trigger random access (e.g., contention-based random access) in the PSCell of the cell group, or may trigger random access (contention-based random access or 2-step random access) based on system information. If there is random access configuration information (random access transmission resource information (time or frequency transmission resource) or dedicated preamble information for transmission of a preamble, or the like) stored in the UE before reception of the indicator for resuming the cell group, the stored random access configuration information may be released or discarded. As another method, the UE may perform PDCCH monitoring in the indicated or configured cell group or cell, and may trigger and perform random access as indicated in PDCCH.
If the indicator for resuming (or activating) a state of the cell group is included, or when the UE receives an indicator for resuming the cell group, all SCells configured in the cell group may be activated. As another method, when the UE receives an indicator for resuming the cell group, the UE may activate or switch a downlink bandwidth part to a bandwidth part (e.g., first active bandwidth part or bandwidth part configured via an RRC message) other than a dormant bandwidth part with respect to an SCell, for which a dormant bandwidth part is configured, among SCells configured in the cell group, and may perform UE operations, in a cell for which a bandwidth part other than a dormant bandwidth part is activated, which are proposed in the disclosure, or may perform activation for an SCell for which a dormant bandwidth part is not configured. As another method, when the UE receives, via the RRC message, an indicator for resuming the cell group, the UE may, according to the indicator or configuration information on each SCell of the cell group, which is included in the RRC message, activate or deactivate each SCell, make each SCell dormant, or activate a dormant bandwidth part, or the UE may activate or deactivate each SCell of the cell group, make the each SCell dormant, or activate a dormant bandwidth part, via the indicator (e.g., bitmap) of PDCCH, the MAC control information, or the RRC message before or after reception of the indicator for resuming the cell group.
Indicator for adding cell group configuration
Indicator for releasing cell group configuration
Security configuration information (security key information, security key information for a cell group, or additional information (e.g., sk-counter)
Indicator indicating handover, cell group addition, or cell group change (e.g., ReconfigurationWithSync indicator or mobilitycontrollnfo indicator)
First channel measurement configuration information for a cell or bandwidth part
Second channel measurement configuration information for a cell or bandwidth part
Indicator (ReconfigurationWithSync) indicating cell group configuration addition or cell group change or indicator (ReconfigurationWithSync or a newly defined indicator) indicating random access
Indicator indicating whether to activate a cell group by performing random access when activating a cell group or whether to activate a cell group without random access (ReconfigurationWithSync or a newly defined indicator)
Radio resource management (RRM) configuration information or frequency measurement configuration information, or separate radio resource management (RRM) configuration information or frequency measurement configuration information to be applied or to be performed when a cell group is deactivated (e.g., simplified frequency measurement configuration information for battery saving (reduced or relaxed RRM configuration information))
Configuration information for radio link monitoring (RLM) or configuration information for RLM to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource). In addition, the configuration information may include bandwidth part configuration information indicating in which bandwidth part the RLM procedure is to be performed (e.g., it may be indicated as a bandwidth part identifier). As another method, when the cell group state is deactivated, the UE performs the RLM procedure in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the RLM procedure in the last (or previously) activated bandwidth part before the cell group state becomes deactivated so that the connection state with the cell group may be maintained continuously (e.g., a case where bandwidth part configuration information indicating in which bandwidth part the RLM procedure is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the RLM procedure is to be performed is not configured, the UE may perform the RLM procedure in the last (or previously) activated bandwidth part. In addition, the configuration information may include beam-related configuration information indicating in which beam the RLM procedure is to be performed (e.g., it can be indicated as a bandwidth part identifier, TCI state or QCL configuration information). As another method, when the cell group state is deactivated, the UE performs the RLM procedure in the beam (e.g., TCI state or QCL configuration information) configured in the RRC message or activates the beam and performs the RLM procedure, monitors a beam that should be activated when activating the cell group early, so that cell group activation delay can be minimized. As another method, in the case that the cell group state is configured to a deactivated state (or activated state), the UE performs the RLM procedure in the last (or previously) activated beam before the cell group state becomes deactivated, so that the connection state with the cell group can be continuously maintained (e.g., a case where beam-related configuration information indicating in which beam the RLM procedure is performed is not configured), or when activating the cell group, the UE may perform an activation procedure in the beam configured in the RRC message. When activating the cell group, in the case that the beam-related configuration information indicating in which beam the RLM procedure is performed is not configured, the UE may perform the RLM procedure in the last (or previously) activated beam.
Configuration information for a beam failure detection or beam failure detection (BFD) or configuration information for BFD to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource. In addition, the configuration information may include bandwidth part configuration information indicating in which bandwidth part the beam failure detection is to be performed (e.g., it may be indicated as a bandwidth part identifier). As another method, when the cell group state is deactivated, the UE performs the beam failure detection in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the beam failure detection in the last (or previously) activated bandwidth part before the cell group state becomes deactivated so that the connection state with the cell group may be maintained continuously (e.g., a case where bandwidth part configuration information indicating in which bandwidth part the beam failure detection is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the beam failure detection is to be performed is not configured, the UE may perform the beam failure detection in the last (or previously) activated bandwidth part. In addition, the configuration information may include beam-related configuration information indicating in which beam the beam failure detection is to be performed (e.g., it can be indicated as a bandwidth part identifier, TCI state or QCL configuration information). As another method, when the cell group state is deactivated, the UE performs the beam failure detection in the beam (e.g., TCI state or QCL configuration information) configured in the RRC message or activates the beam and performs the beam failure detection, monitors a beam that should be activated when activating the cell group early, so that cell group activation delay can be minimized. As another method, in the case that the cell group state is configured to a deactivated state (or activated state), the UE performs the beam failure detection in the last (or previously) activated beam before the cell group state becomes deactivated, so that the connection state with the cell group can be continuously maintained (e.g., a case where beam-related configuration information indicating in which beam the beam failure detection is performed is not configured). Alternatively, when activating the cell group, the UE may perform an activation procedure in the beam configured in the RRC message. When activating the cell group, in the case that the beam-related configuration information indicating in which beam the beam failure detection is performed is not configured, the UE may perform the beam failure detection in the last (or previously) activated beam.
The message may introduce and configure a first timer (e.g., T304), a second timer (e.g., T310), a third timer (e.g., T312) or a fourth timer (e.g., a timer for fallback) in order to efficiently perform a dual connectivity configuration procedure (or SCG configuration procedure) or a handover procedure. It is proposed that the timers are operated and applied in a dual connectivity configuration procedure or a handover procedure. In the above, the first timer (e.g., T304) is a timer for determining whether the dual connectivity configuration procedure or handover procedure has been successfully performed, the second timer (e.g., T310) is a timer for determining whether a radio link is valid, and the third timer (e.g., T312) is an auxiliary timer for determining whether a radio link is valid and a timer for triggering a frequency measurement procedure and reporting a frequency measurement result. Further, the fourth timer (e.g., a timer for fallback) is a timer introduced to attempt to activate a cell group by performing a fallback procedure with random access (general random access (4-step random access or 2-step random access) in the case that the activation of the cell group (or SCG or PSCell) is failed (e.g., a case where the timer expires) without the random access proposed in the disclosure. The fourth timer may be the first timer, or the first timer may be used as a timer for fallback.

It is proposed to include no indicator (e.g., ReconfigurationWithSync indicator or mobilitycontrollnfo indicator) indicating handover, cell group addition, or cell group change in the case that the RRC message (e.g., RRCReconfiguration message) includes an indicator for suspending (or deactivating) a cell group, and it is proposed to include an indicator (e.g., ReconfigurationWithSync indicator or mobilitycontrollnfo indicator) indicating handover, cell group addition, or cell group change in the case that the RRC message includes an indicator for resuming a cell group or configuration information for configuring a cell group. This is because, in the case that a cell group is resumed, a connection with the cell group should be performed again, and therefore synchronization should be performed, system information should be received, or random access should be performed if necessary. For example, in the case that the base station configures the cell group of the UE to a deactivated state via an RRC message, the cell group addition indicator, cell group change indicator, indicator indicating a random accessor procedure, or ReconfigurationWithSync indicator cannot be configured together, so that it is possible to prevent the UE from performing an unnecessary synchronization procedure, connection procedure, or random access.

In the following of the disclosure, a dormant bandwidth part is newly proposed in the next-generation mobile communication system, and UE operations in each bandwidth part when each bandwidth part is shifted or switched is specifically proposed.

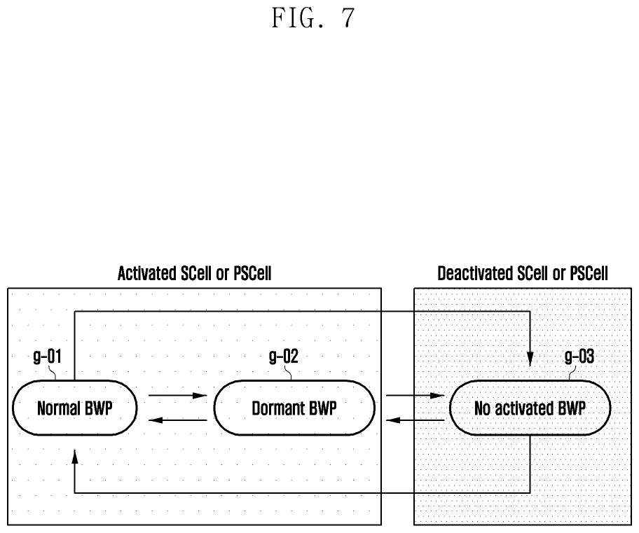

FIG. 7 is a diagram illustrating a bandwidth part-specific state transition procedure or a bandwidth part switching procedure according to an embodiment of the disclosure.

Referring to FIG. 7, a bandwidth part of each cell (e.g., SCell or PSCell) of each cell group of a UE may be activated to a normal bandwidth part g-01, may be activated to a dormant bandwidth part g-02, or may be deactivated g-03. In addition, a normal bandwidth part or a dormant bandwidth part may be activated or deactivated via indication by DCI of PDCCH, MAC control information, or configuration information of an RRC message.

State transition operation (activation, deactivation, or dormant) for each bandwidth part of a cell, activating a normal bandwidth part, activating a dormant bandwidth part, activating a first active bandwidth part activated from dormancy, or deactivating a normal bandwidth part or a dormant bandwidth part, which are proposed in the disclosure, may be performed based on one indication or configuration in the following cases.
In the case that a bandwidth part state of a cell is configured via an RRC message, if a bandwidth part of each cell is configured via an RRC message and a dormant bandwidth part is configured for the cell, or if a first active bandwidth part is configured as a dormant bandwidth part, the cell starts by switching or activating to the dormant bandwidth part, and an operation in the dormant bandwidth part is performed.
In the case that a cell activation, deactivation, or dormancy MAC CE is received,
if a MAC CE indicating activation or deactivation of a first active bandwidth part or a dormant bandwidth part from a normal bandwidth part or dormancy is received,
if DCI of PDCCH indicating activation, deactivation, or switching of a first active bandwidth part or a dormant bandwidth part from a normal bandwidth part or dormancy is received,
in the case that a cell hibernation timer is not configured for an active state cell, and a configured cell inactivity timer expires, and
in the case that a bandwidth part hibernation timer is not configured for an active state bandwidth part, and a configured bandwidth part state inactivity timer (e.g., bwpInactivityTimer) expires, then

the state transition operation or dormant bandwidth part operation method proposed in the disclosure may has the following characteristics.
For an SPCell (PCell or PSCell) (or downlink bandwidth part or uplink bandwidth part of the cell), a dormant bandwidth part cannot be configured, and only normal bandwidth part is configured and is always activated. Since synchronization is performed and a main control signal is transmitted or received in an SPCell, if a bandwidth part of the SPCell is dormant or deactivated, or is operated as a dormant bandwidth part, a connection with a base station may be disconnected, so that the bandwidth part of the SPCell should always be kept active.
If PUCCH is configured despite an SCell or a bandwidth part of an SCell, a dormant state or a dormant bandwidth part cannot be configured. Since there may be another cell that needs to transmit feedback, such as HARQ ACK/NACK via PUCCH, an active state or a normal bandwidth part should be activated and used.
Due to the above characteristics, neither the cell inactivity timer (ScellDeactivationTimer) nor the bandwidth part hibernation timer is applied to an SCell or a bandwidth part of an SCell, for which PUCCH is configured, and an SPCell or a bandwidth part of an SPCell, and the timers may be operated only for other SCells.
The cell or bandwidth part hibernation timer (ScellHibernationTimer) has priority over the cell or bandwidth part inactivity timer (ScellDeactivationTimer). For example, for a timer value, if one timer value is configured via an RRC message, the same value may be applied to all cells. As another method, a base station may configure a different timer value for each SCell or for each BWP based on characteristics of each SCell or each BWP.
Unless a cell or a bandwidth part is indicated to be active or dormant via an RRC message, the cell or bandwidth part operates initially in a deactivated state by default.

In the disclosure, an uplink may indicate an uplink bandwidth part, and a downlink may indicate a downlink bandwidth part. This is because only one active or dormant bandwidth part is operable for each uplink or downlink.

In the disclosure, an active state, a deactivated state, or a dormant state is operated, and when a cell or a bandwidth part is shifted or switched, shifting or switching is performed in bandwidth part level, where, when state shifting or switching occurs according to a bandwidth part level, a bandwidth part (downlink bandwidth part or uplink bandwidth part), for which state shifting or switching is indicated, performs state shifting or switching according to the indication. For example, if a bandwidth part (downlink bandwidth part or uplink bandwidth part) is shifted from an active state to a dormant state or is switched (activated) to a dormant bandwidth part, the bandwidth part may be shifted to a dormant state or may be switched (or activated) to a dormant bandwidth part.

In the disclosure, bandwidth part switching (BWP switching) refers to cases where: when bandwidth part switching is indicated via DCI of PDCCH, if the switching is indicated by a bandwidth part identifier during downlink assignment allocation, a downlink bandwidth part is switched to a bandwidth part indicated by the bandwidth part identifier, and when bandwidth part switching is indicated via DCI of PDCCH, if the switching is indicated by a bandwidth part identifier during UL grant allocation, an uplink bandwidth part is switched to a bandwidth part indicated by the bandwidth part identifier. Further, since a DCI format of PDCCH itself is different from a format (format1) for downlink assignment and a format (format0) for UL grant, even if an uplink and a downlink are not separately described, the UE may operate according to the DCI format.

The method of operating state transition according to a bandwidth part level, and the bandwidth part operations according to respective states, proposed in the disclosure, may be extended and applied to various embodiments. In the following of the disclosure, specific embodiments, in which the contents proposed in the disclosure are extended and applied, will be described.

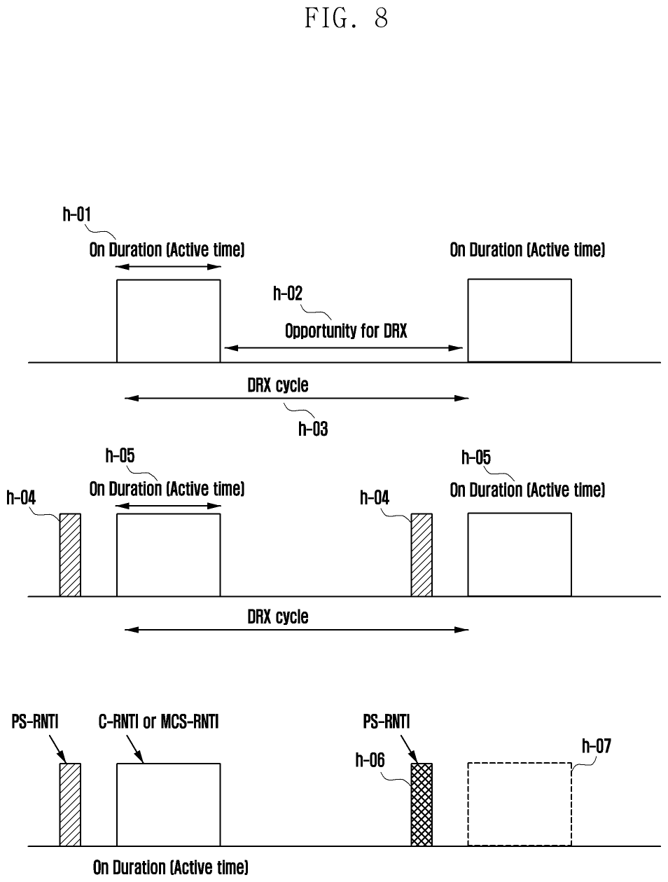

FIG. 8 is a diagram illustrating a discontinuous reception (DRX) configuration or a DRX operation method capable of saving a battery power of a UE according to an embodiment of the disclosure.

Referring to FIG. 8, a base station may configure a UE with a DRX function, such as a DRX cycle, start point, offset, or on-duration (active time), for a PCell, an SCell, or PSCell via an RRC message, as illustrated in FIG. 6. In the disclosure, it is considered to configure the DRX function for a PCell, an SPCell, or a PSCell.

If the DRX function is configure for a PCell (or SPCell or PSCell), the UE may apply the DRX function based on a DRX cycle h-03, a DRX start time, or an offset. When the DRX function is applied, the UE may monitor PDCCH or DCI of PDCCH, which may be received from the base station, in the PCell only in an activation time interval of DRX (on-duration or active time) h-01. In addition, the UE may reduce battery consumption by preventing the UE from monitoring PDCCH or DCI of PDCCH outside the activation time interval of the DRX function (outside active time) h-02.

Referring to FIG. 6, the base station may configure a power saving function (power saving mode) for the UE via an RRC message in order to further improve battery consumption of the UE. If the power saving function is configured together with the DRX function, the UE monitors PDCCH outside the activation time interval for a short time interval h-04 configured via RRC before the active time h-01, at which the UE needs to monitor PDCCH, in the DRX function, and the UE monitors and receives a wake up signal (WUS) outside the activation time interval. The base station may indicate, using a bit of DCI of PDCCH for the WUS signal, whether the UE should perform PDCCH monitoring or not at subsequent active times h-05 and h-07.

For example, the UE, for which the power saving function or the DRX function has been configured, may monitor a WUS signal for the short time interval h-04 configured via an RRC message before every active time h-05, and if a bit value of DCI of PDCCH relating to the subsequent active times h-05 and h-07 has 0 (or 1) in the received WUS signal, the UE may be indicated not to monitor PDCCH for the subsequent active time h-07, or the UE may be indicated not to monitor PDCCH, by preventing a timer corresponding to the subsequent active time from operating in a MAC layer. If the bit value of DCI of PDCCH relating to the subsequent active times h-05 and h-07 has 1 (or 0) in the received WUS signal, the UE may be indicated to monitor PDCCH for the subsequent active time h-05, or may be indicated to monitor PDCCH, by causing the timer corresponding to the subsequent active time to operate in the MAC layer.

In addition, in the above, the UE may not monitor a WUS signal or PDCCH for detecting a WUS signal in an activation time interval.

In addition, when monitoring a WUS signal for the short time interval h-04 configured via an RRC message before every active time h-05, the UE, for which the power saving function or the DRX function has been configured, may detect the signal by identifying PDCCH by using a first RNTI identifier (e.g., PS-RNTI) h-06. The first RNTI identifier (e.g., PS-RNTI) h-06 may be configured for a plurality of UEs, and the base station may concurrently indicate, using the first RNTI identifier (e.g., PS-RNTI) h-06, to the plurality of UEs whether or not to perform PDCCH monitoring at a subsequent activation time interval.

In addition, when monitoring and detecting PDCCH in the active time h-05, the UE, for which the power saving function or the DRX function has been configured, may detect a signal based on a second RNTI (e.g., C-RNTI), a third RNTI (e.g., MCS-C-RNTI), or a fourth RNTI (e.g., SPS-C-RNTI or CS-RNTI) uniquely configured for the UE via an RRC message. The second RNTI (e.g., C-RNTI) may be used for indicating general UE scheduling, the third RNTI (e.g., MCS-C-RNTI) may be used for indicating a modulation and coding scheme of the UE, and the fourth RNTI (SPS-C-RNTI or CS-RNTI) may be used for indicating a periodic transmission resource of the UE.

Based on the method proposed in FIG. 8, the base station may indicate to activate, deactivate, or make the state of a cell or cell group of the UE dormant via the DCI of the PDCCH in the active time h-05 or short time interval h-04 configured in the RRC message. In addition, the UE may perform a PDCCH monitoring procedure in order to receive an indication of the state of the cell or cell group in the active time h-05 or short interval h-04 configured in the RRC message. In the above, in the case that dual connectivity is configured for the UE, the UE may monitor the PDCCH in the active time h-05 or short time interval h-04 configured in the RRC message in the PCell of the MCG, and the DCI of the PDCCH may receive an indication of an activation, deactivation, or dormant state for a cell (SCell) of the MCG or a PSCell (or SCell) of the SCG, and the UE may perform an activation procedure, deactivation procedure, dormancy procedure or partial bandwidth switching procedure for the resulting cell (or bandwidth part). For example, the base station may indicate the activation, deactivation or dormant state for the cell (SCell) of the MCG or the PSCell (or SCell) of the SCG to the UE in the active time h-05 or short time interval h-04 configured in the RRC message in the PCell of the MCG.

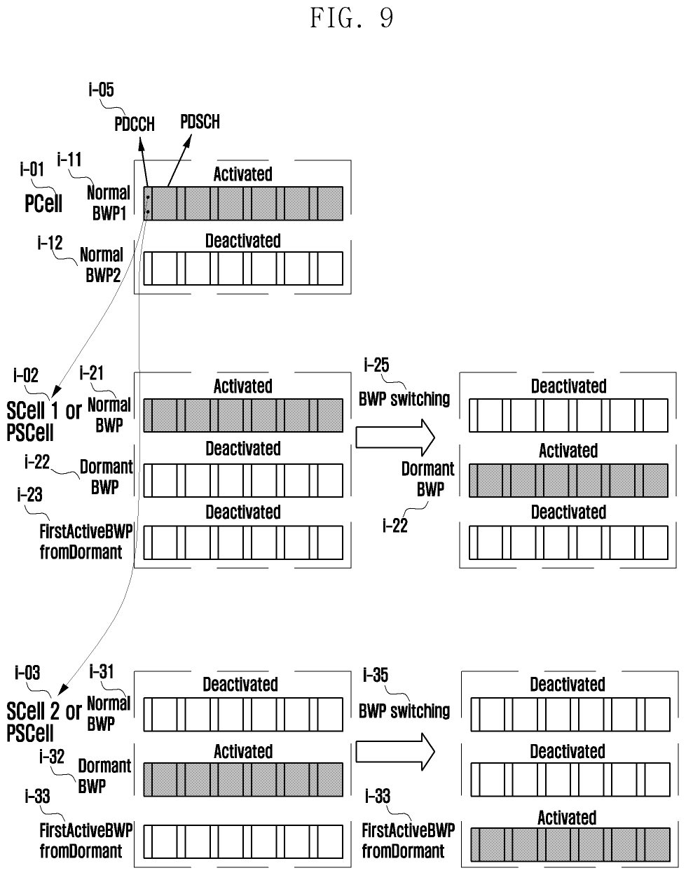

FIG. 9 is a diagram illustrating a concept of a method of operating a dormant bandwidth part in an activated SCell or PSCell proposed according to an embodiment of the disclosure.

Referring to FIG. 6, a base station, for a UE via an RRC message, may, for carrier aggregation, configure a plurality of SCells, allocate respective SCell identifiers, and configure a dormant bandwidth part for each SCell, or may, for dual connectivity, configure a plurality of cell groups, allocate cell group identifiers, and configure or indicate a cell group suspension indicator or configure a dormant bandwidth part for each cell group or a PSCell of each cell group. In addition, the plurality of SCells may be included in each SCell group so as to be configured, and each SCell group may include the plurality of SCells. An SCell group identifier may be allocated to each SCell group, and the plurality of SCell identifiers may be configured to be included in or mapped to each SCell group identifier. An SCell identifier value or an SCell group identifier value may be allocated with a predetermined bit value or may have an integer value (or natural number value). Alternatively, the PSCell of each cell group may be indicated by a cell group identifier.

Referring to FIG. 9, the base station may define a new bitmap for DCI of PDCCH i-05 transmitted in a PCell, may perform mapping to cause each bit value of the bitmap to indicate each SCell identifier value, each SCell group identifier value, a cell group (or secondary cell group) identifier, or a PSCell (or SCell) of a cell group (or secondary cell group), and may indicate, by defining each bit value, whether to perform switching to a dormant bandwidth part, whether to activate a dormant bandwidth part, or whether to suspend or resume a cell group, for an SCell corresponding to a bit, SCells belonging to an SCell group, a cell group (or secondary cell group), or a PSCell (or SCell) of a cell group (or secondary cell group). In addition, whether to switch from a dormant bandwidth part to a normal bandwidth part (e.g., first active bandwidth part activated from dormancy) or whether to activate a normal bandwidth part (e.g., first active bandwidth part activated from dormancy) may be indicated for the SCell corresponding to the bit, the SCells belonging to the SCell group, the cell group (or secondary cell group) identifier, or the PSCell (or SCell) of the cell group (or secondary cell group).

Referring to FIG. 9, after receiving DCI of PDCCH in a PCell i-01, the UE may determine, while reading DCI, the presence or absence of a bitmap including an indication (e.g., switching or activation to a dormant bandwidth part, or switching or activation to a normal bandwidth part—normal BWP1 i-11 or normal BWP2 i-12) for bandwidth parts of SCells or SCell groups, or an indication of suspending or resuming a cell group (or secondary cell group) or a PSCell (or SCell) of a cell group (or secondary cell group). If there is the bitmap, for an SCell, SCells i-02 and i-03 belonging to an SCell group, a cell group (or secondary cell group), or a PSCell (or SCell) of a cell group (or secondary cell group), indicated by each bit of the bitmap, a bandwidth part may be switched or activated, or the cell group may be suspended or resumed according to the bit value. For example, if the bit of the bitmap indicates a first SCell (or first SCell identifier) i-02, a cell group (or secondary cell group), or a PSCell (or SCell) of a cell group (or secondary cell group), or indicates a SCell group including the first SCell (or identifier of a SCell group), and the bit value is 0 (or 1), the UE may, for the first SCell i-02, the cell group (or secondary cell group), or the PSCell (or SCell) of the cell group (or secondary cell group), activate a bandwidth part i-21 to a dormant bandwidth part i-22, or switch a current bandwidth part to the dormant bandwidth part i-22, or in the case that the current bandwidth part is not a dormant bandwidth part, the UE may switch or activate i-25 the currently activated bandwidth part i-21 to the dormant bandwidth part i-22, or may suspend or deactivate a cell group. As another method, power consumption of the UE may be reduced by maintaining a cell group (or secondary cell group) or a PSCell (or SCell) of a cell group (or secondary cell group) as it is, applying the second DRX configuration information or second SRS configuration information proposed in the disclosure, and performing PDCCH monitoring or SRS transmission in a long cycle.

Referring to FIG. 9, after receiving DCI of PDCCH in the PCell i-01, the UE may determine, while reading DCI, the presence or absence of a bitmap including an indication (e.g., switching or activation to a dormant bandwidth part, or switching or activation to a normal bandwidth part) for bandwidth parts of SCells or SCell groups, an indication for a bandwidth part of a cell group (or secondary cell group) or a bandwidth part of a PSCell (or SCell) of a cell group (or secondary cell group), or an indication of suspending or resuming the cell group. If there is the bitmap, for an SCell, SCells i-02 and i-03 belonging to an SCell group, a cell group (or secondary cell group), or a PSCell (or SCell) of a cell group (or secondary cell group), indicated by each bit of the bitmap, a bandwidth part may be switched or activated, or the cell group may be suspended or resumed according to the bit value. For example, when the bit of the bitmap indicates a second SCell (or second SCell identifier) i-03 or indicates an SCell group (or SCell group identifier) including the second SCell, a cell group (or secondary cell group), or a PSCell (or SCell) of a cell group (or secondary cell group), and the bit value is 1 (or 0), if a currently activated bandwidth part of the second SCell i-03 is a dormant bandwidth part i-32, if the currently activated bandwidth part is not a normal bandwidth part, or if the current bandwidth part (or cell) is activated and the current bandwidth part is activated to the dormant bandwidth part i-32 (or activated to a bandwidth part other than a normal bandwidth part), the UE may switch or activate i-35 the bandwidth part of the second SCell i-03 to a bandwidth part (e.g., first active bandwidth part activated from dormancy, i-33) configured via an RRC message or may resume or activate the cell group. In the case that, due to the bit value of 1 (or 0), the SCell, the SCells belonging to an SCell group, the cell group (or secondary cell group), or the PSCell (or SCell) of the cell group (or secondary cell group), indicated by the bit, should be switched or activated to a bandwidth part other than a dormant bandwidth part, or the cell group should be resumed, if the SCell is deactivated or if the SCell is activated and an activated bandwidth part is not a dormant bandwidth part (or is a normal bandwidth part), then the bit value may not be applied or may be disregarded or may not be read for the SCell or each of the SCells belonging to the SCell group, or if the cell group (or secondary cell group) or the PSCell (or SCell) of the cell group (or secondary cell group) has already been active or resumed, then the bit value may not be applied or may be disregarded or may not be read. In addition, in the case that, due to the bit value of 0 (or 1), the SCell, the SCells belonging to an SCell group, the cell group (or secondary cell group), or the PSCell (or SCell) of the cell group (or secondary cell group), indicated by the bit, should be switched or activated to a dormant bandwidth part, or the cell group should be resumed, if the SCell is active and an activated bandwidth part is a dormant bandwidth part, then the bit value may not be applied or may be disregarded or may not be read for the SCell or each of the SCells belonging to the SCell group, or if the cell group (or secondary cell group) or the PSCell (or SCell) of the cell group (or secondary cell group) has already been suspended or deactivated, then the bit value may not be applied or may be disregarded or may not be read.

In the following of the disclosure, methods for quickly activating a cell (e.g., SCell, PSCell or SCell) are proposed.

Specifically, the base station may configure the first channel measurement configuration information capable of quickly measuring a channel and reporting a measurement when the UE activates a cell in an RRC message (e.g., RRCReconfiguration or RRCResume). For quick activation of the cell or cell group, in the configuration information of the cell (e.g., PCell or PSCell or SCell) of the cell group so that the base station is able to transmit many channel measurement signals temporarily or transmit a channel measurement signal frequently to enable quick channel measurement in the cell, the first cell channel measurement configuration information may include a cycle for a frequent channel measurement signal (e.g., radios resource or temporary reference signal (TRS), synchronization signal block (SSB) or channel state information reference signal (CSI-RS) or reference signal (RS)), transmission resource information for transmission (frequency or time transmission resource via which the frequent channel measurement signal is transmitted), an interval or frequency (the number of times the frequent channel measurement signal is transmitted), a timer value (time at which the frequent channel measurement signal is transmitted), a time interval (interval in which the frequent channel measurement signal is transmitted (e.g., an offset of time unit (slot, subframe, symbol, or the like)), or a transmission resource, period, interval, timing, offset, or the like via which the UE should report a measurement result. In the above, the first channel measurement configuration information may configure a short reporting cycle (or transmission resource) for the UE to report the channel measurement result, or transmission resource for channel measurement so that the base station is able to transmit many channel measurement signals (or transmission resources or (e.g., radios resource or temporary reference signal (TRS))) or transmit a channel measurement signal frequently to support the quick channel measurement or many signal measurement of the UE. In the above, the first channel measurement configuration information may include configuration information for a channel measurement signal for a specific UE (or UEs) in the cell or BWP by a base station. In addition, the first channel measurement configuration information may be configured differently for each cell or for each BWP for a plurality of cells or BWPs configured in the RRC message, and the beam-related configuration information, such as a beam direction or a beam number or a beam location (e.g., transmission configuration indication (TCI) state or quasi co-location (QCL)) can be configured together so that the UE can easily measure transmission resources for channel measurement. In addition, the first channel measurement configuration information may be configured with a timing advance (TA) value (or offset value) for synchronizing the downlink signal of the base station or the uplink signal of the base station, or a timer (time alignment timer (TAT)) or timer value (TAT value) that indicates the validity of the TA value, so that channel measurement or channel measurement reporting can be correctly performed. For example, the first channel measurement configuration information may include a cycle of the channel measurement signal, the number of times the signal is transmitted, an interval in which the signal is transmitted, an offset for the time during which the signal is transmitted, a time interval between signals to be transmitted, a list of plurality of channel measurement signals that can be transmitted, a time transmission resource (or frequency transmission resource) indicating the location of the signal to be transmitted, a transmission resource (time transmission resource or frequency transmission resource) for reporting measurement results, a cycle for reporting measurement results, the beam-related configuration information (e.g., transmission configuration indication (TCI) state or quasi co-location (QCL)) for measuring the channel measurement signals, or the like. In addition, the first channel measurement configuration information configured as an RRC message may include a plurality of channel measurement signal information, and any one channel measurement signal information of the plurality of channel measurement signal information configured above as an RRC message or MAC CE or DCI, or beam configuration information may be indicated so that the UE may perform channel measurement or channel measurement reporting by applying or using the indicated channel measurement signal information or beam configuration information. In the above, the method for indication may define a mapping between a bitmap, index, or identifier and each channel measurement signal information configured above, and may make an indication based on this. As another method, by configuring or indicating the channel measurement signal information via the RRC message or MAC CE, the UE performs channel measurement by applying or using the configured (or indicated) channel measurement signal information or channel measurement reporting.

As another method, when the UE is configured with the RRC message including the first channel measurement configuration information, in the case of configuring the cell state to an activated state in the RRC message and instructing the cell to be activated via the RRC message, the UE can quickly measure a channel and report measurement by applying or using the first channel measurement configuration information, thereby quickly activating the cell. For example, the first channel measurement configuration information, channel measurement signal information or beam-related configuration information, which can be applied to a case where a cell state is configured to an activated state in an RRC message and cell activation is indicated by the RRC message, can be configured by separate configuration information in the RRC message (e.g., only if default configuration, channel measurement signal information (or beam-related configuration information) corresponding to identifier of 0, or one channel measurement signal information (or beam-related configuration information) is configured, this channel measurement signal information (or beam-related configuration information) is applied).

The first channel measurement configuration information proposed in the disclosure may be configured only for downlink bandwidth part configuration information of each cell. For example, the first channel measurement configuration information proposed in the disclosure may not be configured for uplink bandwidth part configuration information of each cell. This is because the UE must first measure the channel for the downlink so that it can correctly receive the PDCCH and follow the indications for the base station after reporting the measurement result for the channel or cell.

The first channel measurement configuration information proposed in the disclosure may be initially deactivated when configured as an RRC message or after handover, and may be activated later by the MAC control information, DCI information of PDCCH or RRC message proposed in the disclosure. In the case that the first channel measurement configuration information is configured as the RRC message as described above, the base station can easily manage the cell state or channel measurement procedure of the UE only when the initial state is a deactivated state, and the timing of when and how the UE performs channel measurement can also be accurately performed without a processing delay problem of the RRC message.

In addition, the RRC message (RRCReconfiguration or RRCResume) may include or configure second channel measurement configuration information. The second channel measurement configuration information may include general channel measurement configuration information, such as a transmission resource, cycle, time interval, or frequency of channel measurement signal, or a transmission resource, cycle, or time interval for channel measurement reporting.

In the following of the disclosure, it proposes a structure or indication method of MAC control information (MAC control element) that can indicate the UE to quickly measure a channel or report a measurement result based on the first channel measurement configuration information while activating a cell and to activate the cell quickly when the first channel measurement configuration information or the second channel measurement information is configured in the UE via the RRC message as proposed above. For example, the MAC control information (or RRC message) proposed in the disclosure may indicate to the UE which cell to activate or deactivate among a plurality of cells configured with the RRC (e.g., SCell). Alternatively, if the MAC control information indicates the UE to activate a certain cell, the MAC control information (or RRC message) may indicate the UE which signal information for measurement to apply among the first channel measurement configuration information configured as the RRC message above, how to measure a signal (e.g., indicating how many times to measure a signal transmission resource, how many signals are transmitted, at what time interval to measure, based on which offset to determine a measurement time interval, at what cycle to measure a signal, which transmission resource to measure a signal, or the like), how to report (e.g., indicating how many times to report measurement results, at what time interval measurement results are to be reported, based on which offset to determine a transmission resource for measurement result reporting, at what cycle to report measurement results, which transmission resource to report measurement results, or the like), so that the UE can quickly activate the cell based on the first channel measurement configuration information configured via the RRC message.

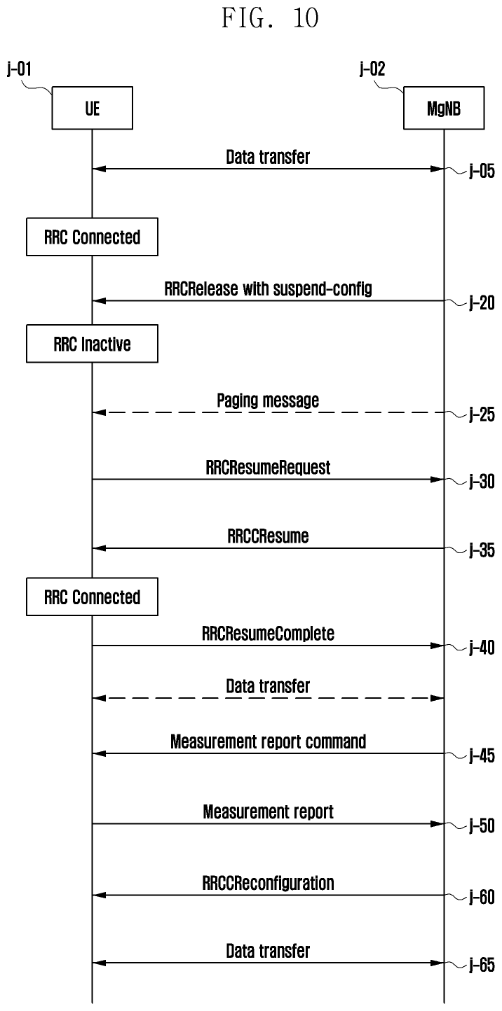

FIG. 10 is a diagram illustrating an embodiment in which the embodiments proposed in the disclosure are extended and applied to a UE in an RRC inactive mode according to an embodiment of the disclosure.

In the disclosure, a cell group or cell may indicate a PCell of a master cell group (MCG), a SCell of an MCG, a PSCell of a secondary cell group (SCG), or a SCell of an SCG.

The embodiment proposes that a UE continuously stores SCell configuration information (e.g., configuration information described or proposed in FIG. 6) or configuration information of a PSCell (or SCell) of a cell group (or secondary group), which is configured or stored, with reference to FIG. 6, in an RRC connected mode for the embodiment, without clearing or discarding the same even if the UE shifts to an RRC inactive mode. In addition, the embodiment also proposes that, when the UE in the RRC inactive mode performs RRC connection resumption, the UE determines whether to discard or clear, maintain and apply, or reconfigure the stored SCell configuration information (e.g., configuration information described or proposed in FIG. 6) or configuration information of the PSCell (or SCell) of the cell group (e.g., secondary cell group), via a reconfiguration procedure or an indicator of an RRCResume message or an RRCReconfiguration message, which is transmitted by a base station. In addition, when the base station transmits, to the UE, an RRCRelease message including an indicator or configuration for shifting the UE to the RRC inactive mode, the base station may transmit, to the UE, the message including configuration information or an indicator indicating whether to discard or clear, maintain and apply, or reconfigure the SCell configuration information (e.g., configuration information described or proposed in FIG. 6) or the configuration information of the PSCell (or SCell) of the cell group (e.g., secondary cell group), which is stored in the RRCRelease message. In addition, when the UE moves and performs RAN notification area (RNA) update in the RRC inactive mode, the UE may receive and apply the configuration information or the indicator indicating whether to discard or clear, maintain and apply, or reconfigure the SCell configuration information (e.g., configuration information described or proposed in FIG. 6) or the configuration information of the PSCell (or SCell) of the cell group (e.g., secondary cell group), which is stored in the RRCRelease message transmitted to the UE by the base station.

In the embodiment proposed in the disclosure, the base station may allow a first active bandwidth part of downlink or uplink bandwidth part configuration information of each cell to be configured as a dormant bandwidth part, in the SCell configuration information (e.g., configuration information described or proposed in FIG. 6) or configuration information of the PSCell (or SCell) of the cell group (e.g., secondary cell group) of the RRC message, and when the UE activates each SCell, each cell group, or a PSCell of each cell group, the base station may directly enable operation, as a dormant bandwidth part, of a downlink bandwidth part or uplink bandwidth part of each SCell, each cell group, or the PSCell of each cell group, or may enable suspension or resumption of the cell group, thereby reducing battery consumption of the UE.

As another method, in an embodiment proposed in the disclosure, the base station may not configure, as a dormant bandwidth part, a first active bandwidth part of downlink or uplink bandwidth part configuration information of each cell, in the SCell configuration information (e.g., configuration information described or proposed in FIG. 6) or configuration information of the PSCell (or SCell) of the cell group (e.g., secondary cell group) of the RRC message, and when the UE activates or resumes each SCell, each cell group, or a PSCell of each cell group, the base station may always cause activation of a downlink bandwidth part or uplink bandwidth part of each SCell, each cell group, or the PSCell of each cell group to a first active bandwidth part, and may enable switching or activation to a dormant bandwidth part according to the embodiments proposed in the disclosure, or may enable suspension or resumption of the cell group, thereby reducing battery consumption of the UE.

In addition, the embodiment proposed above may be extended to each SCell configuration information or PSCell configuration information of a master cell group (MCG) or secondary cell group (SCG) of the UE, for which dual connectivity has been configured, so as to be applied. For example, the SCell configuration information or PSCell configuration information of the SCG may also be stored when the UE is shifted to the RRC inactive mode, and when RRC connection resumption is performed as in the above, or when the UE is shifted to the RRC inactive mode, the base station may transmit, to the UE, configuration information or an indicator indicating whether to discard or clear, maintain and apply, or reconfigure the SCell configuration information (e.g., configuration information described or proposed in FIG. 6) or PSCell configuration information of the MCG or SCG, stored in the RRC message (e.g., RRCResume or RRCReconfiguration or RRCRelease message).

Referring to FIG. 10, a UE j-01 may perform network connection to a base station j-02 and transmit or receive data j-05. If, for some reason, the base station needs to shift the UE to an RRC inactive mode, the base station may transmit an RRCRelease message j-20 to shift the UE to the RRC inactive mode. The base station may transmit, to the UE, the message including configuration information or an indicator indicating whether to discard or clear, maintain and apply, or reconfigure SCell configuration information (e.g., configuration information described or proposed in FIG. 6) of an MCG or SCG, or PSCell (or SCell) configuration information of a cell group (e.g., secondary cell group), stored in the RRC message (e.g., RRCRelease). In a case of a UE to which dual connectivity is applied, the base station may determine whether to suspend or resume master cell group bearer configuration or RRC configuration information or SCell configuration information of the MCG or SCG, and may inquire a secondary cell base station about whether or not to perform suspension or resumption and receive a respond in order to determine whether to suspend or resume secondary cell group bearer configuration and RRC configuration information, j-15. In addition, the base station may configure a list of frequencies to be measured by the UE in an RRC idle mode or an RRC inactive mode, frequency measurement configuration information, a frequency measurement period, or the like via the RRCRelease message.

The UE in the RRC inactive mode may, while moving, receive a paging message j-25 and perform RRC connection resumption procedure when uplink data needs to be transmitted or a RAN notification area needs to be updated.

When the UE needs to establish a connection, the UE performs random access, and when transmitting an RRCResumeRequest message j-30 to the base station, UE operations related to transmission of the message are as follows.

1. When the UE identifies system information, and the system information indicates transmission of a complete UE connection resumption identifier (e.g., I-RNTI or full resume ID), the UE prepares to transmit the message including the stored complete UE connection resumption identifier (e.g., I-RNTI). If the system information indicates to transmit a truncated UE connection resumption identifier (e.g., truncated I-RNTI or truncated resume ID), the UE configures the stored complete UE connection resumption identifier (e.g., I-RNTI) to a truncated UE connection resumption identifier (e.g., truncated resume ID) according to a predetermined scheme, and prepares to transmit the message including the configured truncated UE connection resumption identifier.

2. The UE restores RRC connection configuration information and security context information from stored UE context.

3. The UE updates a new KgNB security key corresponding to a master cell group key based on a current KgNB security key, a NextHop (NH) value, and a next chain counter (NCC) value received via the RRCRelease message so as to be stored.

4. If the UE receives an SCG-counter value (or sk-counter) via the RRCRelease message, the UE updates a new SKgNB security key corresponding to the secondary cell group based on the KgNB security key and the SCG-counter value (or sk-counter).

5. The UE derives new security keys (e.g., K_RRCenc, K_RRC_int, K_UPint, and K_UPenc) to be used in integrity protection and verification and in encryption and decryption, by using the newly updated KgNB security key.

6. If the UE receives the SCG-counter value (or sk-counter) via the RRCRelease message, the UE derives new security keys (e.g., SK_RRCenc, SK_RRC_int, SK_UPint, and SK_UPenc) to be used in integrity protection and verification and in encryption and decryption, by using the newly updated SKgNB security key.

7. The UE calculates MAC-I and prepares to transmit the message including the calculated MAC-I.

8. The UE may resume SRB1 (SRB1 should be resumed in advance because the RRCResume message is to be received via SRB1 in response to the RRCResumeRequest message to be transmitted).

9. The UE configures the RRCResumeRequest message and transmits the message to a lower layer.

10. The UE may resume the integrity protection and verification by applying the updated security keys and a preconfigured algorithm with respect to all bearers (MCG terminated RBs) except for SRBO corresponding to the master cell group, and may apply the integrity verification and protection to data to be transmitted and received at a later time (the resumption and application of the integrity verification and protection is to increase reliability and security on the data to be transmitted to or received from SRB1 or DRBs at a later time).

11. The UE may resume the encryption and decryption procedure by applying the updated security keys and a preconfigured algorithm with respect to all bearers (MCG terminated RBs) except for SRBO corresponding to the master cell group, and may apply the encryption and decryption to data to be transmitted and received at a later time. (The resumption and application of the encryption and decryption is to increase reliability and security on the data to be transmitted to or received from SRB1 or DRBs at a later time.)

12. If the UE receives the SCG-counter value (or sk-counter) via the RRCRelease message, the UE may resume the integrity protection and verification procedure by applying the updated security keys and a preconfigured algorithm with respect to all bearers (SCG terminated RBs) corresponding to the secondary cell group, and may apply the integrity verification and protection to data to be transmitted and received at a later time. (The resumption and application of the integrity verification and protection is to increase reliability and security on the data to be transmitted to or received from DRBs at a later time.)

13. If the UE receives the SCG-counter value (or sk-counter) via the RRCRelease message, the UE resumes the encryption and decryption procedure by applying the updated security keys and a preconfigured algorithm with respect to all bearers (SCG terminated RBs) corresponding to the secondary cell group, and may apply the encryption and decryption to data to be transmitted and received at a later time. (The resumption and application of the encryption and decryption is to increase reliability and security on the data to be transmitted to or received from DRBs at a later time.)

When the UE needs to establish a connection so as to perform random access, the UE transmits an RRCResumeRequest message to the base station, and then receives an RRCResume message j-35 in response thereto, proposed UE operations are as follows. If the RRCResume message includes an indicator indicating to report, if the UE has a valid frequency measurement result measured in the RRC inactive mode, the frequency measurement result, the UE may report the frequency measurement result configured in an RRCResumeComplete message. In addition, the base station may transmit, to the UE, the RRC message (e.g., RRCResume message) including configuration information or an indicator indicating whether to discard or clear, maintain and apply, or reconfigure the SCell configuration information (e.g., configuration information described or proposed in FIG. 6) of the MCG or SCG, stored in the UE.

1. When the message is received, the UE restores a PDCP state corresponding to the master cell group, resets a COUNT value, and re-establishes PDCP layers device of all DRBs (MCG terminated RBs) and SRB2 corresponding to the master cell group.

2. If the UE receives an SCG-counter value (or sk-counter) via the message, the UE updates a new SKgNB security key corresponding to the secondary cell group based on a KgNB security key and the SCG-counter value (or sk-counter). The UE derives new security keys (SK_RRCenc, SK_RRC_int, SK_UPint, and SK_UPenc) to be used in integrity protection and verification procedure and in encryption and decryption procedure, by using the newly updated SKgNB security key corresponding to the secondary cell group.

3. If the message includes master cell group (masterCellgroup) configuration information,
A. the UE performs and applies the master cell group configuration information included in the message. The master cell group information may include configuration information on RLC layers belonging to the master cell group, a logical channel identifier, a bearer identifier, and the like.

4. If the message includes bearer configuration information (radioBearerConfig),
A. the UE may perform and apply the bearer configuration information (radioBearerConfig) included in the message. The bearer configuration information (radioBearerConfig) may include configuration information on PDCP layers for respective bearers, configuration information on service data adaptation protocol (SDAP) layers, a logical channel identifier, a bearer identifier, and the like.

5. If the message includes secondary cell group (secondaryCellgroup) configuration information,
A. the UE may perform and apply the secondary cell group configuration information included in the message. The secondary cell group information may include configuration information on RLC layers belonging to the secondary cell group, a logical channel identifier, a bearer identifier, and the like.

6. If the message includes secondary bearer configuration information (radioBearerConfig),
A. the UE may perform and apply the secondary bearer configuration information (radioBearerConfig) included in the message. The secondary bearer configuration information (radioBearerConfig) may include configuration information on PDCP layers for respective secondary bearers, configuration information on SDAP layers, a logical channel identifier, a bearer identifier, and the like.

7. The UE may resume all DRBs (MCG terminated RBs) and SRB2 corresponding to the master cell group.

8. If the message includes frequency measurement configuration information (measConfig),
A. the UE may perform and apply the frequency measurement configuration information included the message. For example, the UE may perform frequency measurement according to the configuration.

9. The UE may be shifted to the RRC connected mode.

10. The UE may indicate to an upper layer that the suspended RRC connection has been resumed.

11. The UE may configure and transfer the RRCResumeComplete message j-40 for transmission to a lower layer.

In the above, if the UE has UE context information and bearer configuration information for the suspended secondary cell group, the UE may perform frequency measurement based on frequency configuration information configured via system information, the RRCRelease message, or the RRCResume message, and in the case that there is a valid result, the UE may transmit the RRCResumeComplete message including an indicator so as to indicate the presence of the result. When the base station receives the indicator, in the case that resumption of frequency carrier aggregation or dual connectivity is necessary, the base station may indicate j-45 the UE to report a frequency measurement result. The base station may receive a frequency measurement result report from the UE, or the base station may receive the frequency measurement result via the RRCResumeComplete message, j-50. When the frequency measurement result is received, the base station may inquire the secondary cell base station about whether to resume bearer information for the suspended secondary cell group, and may receive a respond so as to make a determination. The base station may provide an indication of resumption or release of bearers for the secondary cell group, by transmitting the RRCReconfiguration message j-60 to the UE. In addition, the base station may transmit j-65, to the UE, the RRC message (e.g., RRCReconfiguration message) including configuration information or an indicator indicating whether to discard or clear, maintain and apply, or reconfigure the SCell configuration information (e.g., configuration information described or proposed in FIG. 6) of the MCG or SCG, stored in the UE.

In the embodiment proposed in FIG. 10 of the disclosure, the base station may allow a first active bandwidth part of downlink or uplink bandwidth part configuration information of each cell to be configured as a dormant bandwidth part, in the SCell configuration information (e.g., configuration information described or proposed in FIG. 6) or PSCell (or SCell) configuration information of the cell group (e.g., secondary cell group) of the RRC message (e.g., RRCRelease, RRCResume, or RRCReconfiguration message), and therefore when the UE activates each SCell or a PSCell of the cell group (e.g., secondary cell group), the base station may directly enable operation, as a dormant bandwidth part, of a downlink bandwidth part or uplink bandwidth part of each SCell or PSCell, or may enable suspension or resumption of the cell group, thereby reducing battery consumption of the UE. For example, for each SCell or PSCell, in the case that an SCell state is configured to be active or a cell group state is configured to be active, suspended, or deactivated in SCell configuration information or cell group configuration information of the RRC message (e.g., RRCRelease, RRCResume, or RRCReconfiguration message), in the case that an indicator for suspending or resuming the cell group is configured, or in the case that an indication of activating the SCell is received via MAC control information proposed in the disclosure, the UE may activate, resume, or suspend the SCell or PSCell. When activating the SCell or PSCell, the UE may operate a method for reducing battery consumption of the UE by directly activating downlink bandwidth part or uplink bandwidth part of the SCell or PSCell to a dormant bandwidth part.

As described above, in the case that the UE in the RRC inactive mode is shifted to the RRC connected mode, and the SCell configuration information or PSCell (or SCell) configuration information of the cell group (e.g., secondary cell group) proposed in the disclosure is restored, applied, or reconfigured, switching or activation between bandwidth parts or activation or application of a dormant bandwidth part may be performed for each activated SCell or activated PSCell (or SCell) of the cell group according to the embodiments proposed in the disclosure. In addition, the embodiments of the disclosure may also be extended and applied when handover is performed.

If the UE receives an indicator for suspension, resumption, activation, or deactivation for a cell, a cell group or a PSCell of a cell group by the embodiments proposed in the disclosure, a PHY layer or MAC layer having received the indication may indicate the indication to an upper layer (e.g., MAC layer, RLC layer, PDCP layer, or RRC layer). When the upper layer receives the indication (e.g., cell group suspension, resumption, activation, or deactivation) from the lower layer, a protocol layer procedure for cell group suspension, resumption, activation, or deactivation corresponding to the indication may be performed. Alternatively, if the UE receives an indicator for suspension, resumption, activation, or deactivation for a cell group or a PSCell of a cell group via the RRC message as in the embodiments of the disclosure, an RRC layer having received the indication may indicate the indication to a lower layer (e.g., PHY layer, MAC layer, RLC layer, of PDCP layer). When the lower layer receives the indication (e.g., cell group suspension, resumption, activation, or deactivation) from the upper layer, a protocol layer procedure for cell group suspension, resumption, activation, or deactivation corresponding to the indication may be performed.

Various embodiments may be configured and operated by uniting or extending the embodiments proposed in the disclosure.

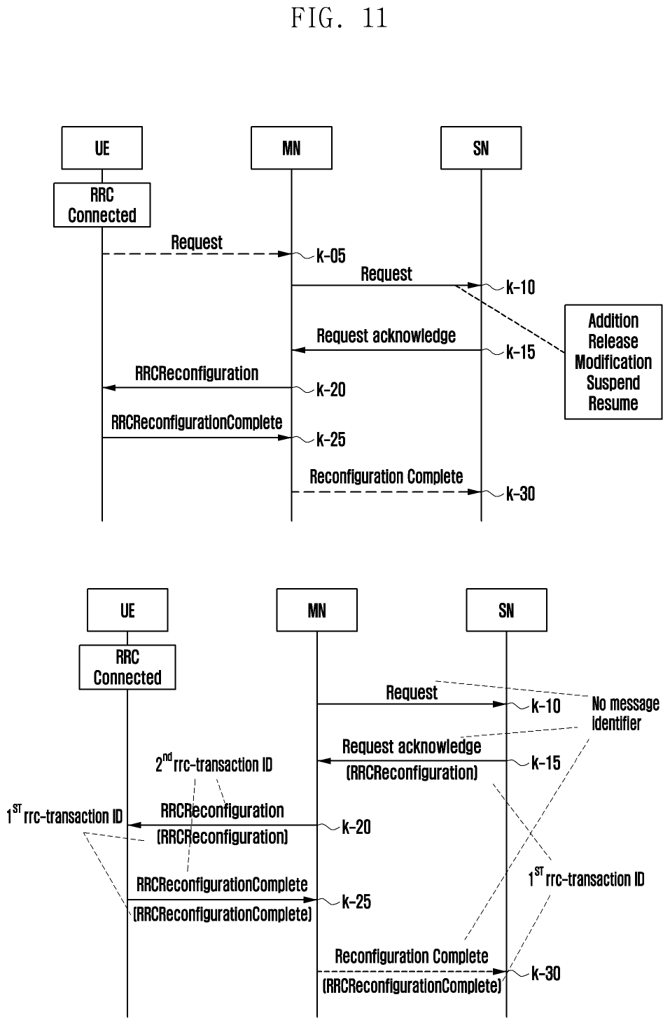

FIG. 11 is a diagram illustrating an example of a signaling procedure of configuring or releasing dual connectivity, or activating, resuming, suspending, or deactivating a secondary cell group for which dual connectivity is configured in a next-generation mobile communication system according to an embodiment of the disclosure.

With reference to FIG. 11, a first signaling procedure of configuring or clearing dual connectivity, or configuring, clearing, activating, resuming, suspending, or deactivating a secondary cell group for which dual connectivity is configured is as follows.

Referring to FIG. 11, a UE may establish an RRC connection with a network or a base station as in FIG. 6 of the disclosure, and may transmit data to or receive data from the base station (e.g., master cell group (MCG), master node (MN), or cells (PCell or SCell) of the master cell group).

The base station may configure dual connectivity for the UE according to a predetermined reason (e.g., a case where a high data transmission rate is required, in response to a request from the UE k-05, a case where high QoS requirements should be satisfied, or the like). For example, the UE may transmit, to the base station, a request for configuring or clearing, activating or deactivating, or resuming or suspending dual connectivity, a cell group (e.g., secondary cell group), or a cell, and the request message may include a frequency (or channel) measurement result report, a cell group identifier, cell identifiers, or measurement results, k-05. As another method, the base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell.

A master base station (master node (MN) or master cell group (MCG)) may receive a frequency or channel measurement report for each frequency or channel received from the UE, and may determine a secondary base station (secondary node (SN) or secondary cell group (SCG)), for which dual connectivity is to be configured, based on the measurement report. Alternatively, the master base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell.

In order to configure, release, add, deactivate, activate, resume, change, reconfigure, or suspend dual connectivity, a cell group (secondary cell group), or a cell for a determined secondary base station, the master base station may transmit a message for requesting whether it is possible to configure or add as a secondary cell group of the UE, to the secondary base station via an Xn interface (e.g., interface between base stations) or an Sn interface (e.g., interface between base stations or a base station and AMF or UMF), k-10. For the request message, each separate new request message may be defined and used to configure, release, add, deactivate, activate, resume, change, reconfigure, or suspend dual connectivity, a cell group (secondary cell group), or a cell for the secondary base station. As another method, a new indicator may be defined from an existing message (e.g., SN addition request message, SN modification request message, SN release request message, or the like) so as to indicate (or request) to configure, clear, add, deactivate, activate, resume, change, reconfigure, or suspend a cell group (secondary cell group), or a cell. The request message may include information, such as cell group configuration information (e.g., master cell group configuration information) currently configured for the UE, bearer configuration information, capability information of the UE, frequency (or channel) measurement result information of the UE, or the like, and when a secondary cell group is configured for the UE based on the information, the secondary base station may configure secondary cell group configuration information or the bearer configuration information so as not to exceed a UE capability or according to the UE capability or the bearer configuration information of the master cell group.

When the request message is rejected, the secondary base station having received the request message k-10 may configure a rejection message and transmit message to the master base station via the Xn interface (e.g., interface between base stations) or the Sn interface (e.g., interface between base stations or a base station and AMF or UMF), k-15. If the request message is accepted, the secondary base station may transmit a request acknowledge message including an indicator or configuration information for configuring, releasing, adding, deactivating, activating, resuming, changing, reconfiguring, or suspending dual connectivity, a cell group (secondary cell group), or a cell to the master base station via the Xn interface (e.g., interface between base stations) or the Sn interface (e.g., interface between base stations or a base station and AMF or UMF). The request acknowledge message may include at least one piece of the following information:
Identifier identical to a message identifier included in the request message, or indicator indicating acceptance of the request made from the request message
Indicator or configuration information (e.g., indicator or configuration information for the master cell group) for configuring, clearing, adding, deactivating, activating, resuming, changing, reconfiguring, or suspending dual connectivity, a cell group (secondary cell group), or a cell
First RRC message (e.g., RRCReconfiguration message) including an indicator or configuration information for configuring, clearing, adding, deactivating, activating, resuming, changing, reconfiguring, or suspending dual connectivity, a cell group (secondary cell group), or a cell
The first RRC message may include at least one piece of the following information.
   ▪ First RRC message identifier for distinguishing the first RRC message (e.g., rrc-Transaction identifier) The UE and the base station (e.g., secondary base station) transmit or receive a plurality of RRC messages to or from each other, and identifiers for distinguishing the respective RRC messages may be thus included in the RRC messages. For example, an RRC message (e.g., RRCReconfiguration message) transmitted by a transmission end, an RRC message (e.g., RRCReconfigurationComplete message) corresponding to the RRC message (e.g., RRCReconfiguration message) transmitted by a reception end, or an RRC message corresponding to the RRC message transmitted by the transmission end may include the same first RRC message identifier.
   ▪ Indicator or configuration information (e.g., indicator or configuration information for the UE) for configuring, clearing, adding, deactivating, activating, resuming, changing, reconfiguring, or suspending dual connectivity, a cell group (secondary cell group), or a cell
   ▪ Indicator indicating a cell group state (e.g., activated, deactivated, suspended, or resumed)
   ▪ Cell group identifier for distinguishing cell groups. The cell group identifier may be assigned by the master base station, or one identifier among previously agreed identifiers may be assigned by the secondary base station.
   ▪ Cell group or cell configuration information
   ▪ Bearer configuration information. For example, indicator information indicating an operation of a protocol layer (e.g., SDAP layer, PDCP layer, RLC layer, or MAC layer) of each bearer (e.g., PDCP suspension indicator, PDCP re-establishment indicator, PDCP data recovery indicator, RLC re-establishment indicator, MAC partial reset indicator, MAC reset indicator, or indicator triggering a new operation)
   ▪ In the above, in the case that an indicator or configuration information for configuring, adding, activating, resuming, changing, or reconfiguring dual connectivity, a cell group (secondary cell group), or a cell is included, a first indicator (e.g., mobilityControlInfor or ReconfigurationWithSync) may be included together. However, in the case that an indicator or configuration information for clearing, deactivating, reconfiguring, or suspending dual connectivity, a cell group (secondary cell group), or a cell is included, the first indicator (e.g., mobilityControlInfor or ReconfigurationWithSync) may not be included. The first indicator may be an indicator triggering random access to the cell group or cell, an indicator for synchronizing a signal with a new cell, an indicator indicating frequency shifting of the UE, or an indicator indicating changing of a cell group (or cell).
   ▪ In the above, in the case that the indicator or configuration information for configuring, adding, activating, resuming, changing, or reconfiguring dual connectivity, a cell group (secondary cell group), or a cell is included, random access configuration information may be included together. However, in the case that the indicator or configuration information for clearing, deactivating, reconfiguring, or suspending dual connectivity, a cell group (secondary cell group), or a cell is included, the random access configuration information may not be included. The random access configuration information may include random access transmission resource information (time or frequency transmission resource), designated preamble information, or the like for preamble transmission for the cell group or cell.
   ▪ Time information indicating when to activate, resume, deactivate, or suspend dual connectivity, a cell group (e.g., secondary cell group), or a cell (PSCell or SCG SCell) (e.g., information indicating timing (e.g., X) time unit, subframe unit, time slot unit, or symbol unit), for example, time information indicating, if the message is received in an nth time unit, whether to activate, resume, deactivate, or suspend the cell in an (n+X)^{th} time unit)
   ▪ First channel measurement configuration information for each cell or each bandwidth part
   ▪ Second channel measurement configuration information for each cell or each bandwidth part
   ▪ Indicator indicating adding of cell group configuration or changing of a cell group (ReconfigurationWithSync) or indicator indicating random access (ReconfigurationWithSync or a newly defined indicator)
   ▪ Indicator indicating, when activating a cell group, whether to activate a cell group by performing random access or activate a cell group without random access (ReconfigurationWithSync or a newly defined indicator)
   ▪ Radio resource management (RRM) configuration information, frequency measurement configuration information or separate radio resource management (RRM) configuration information or frequency measurement configuration information to be applied or performed when deactivating a cell group (e.g., simplified frequency measurement configuration information for reducing battery consumption (Reduced or Relaxed RRM configuration information))
   ▪ Configuration information for radio link monitoring (RLM) or configuration information for RLM to be applied or performed when deactivating a cell group. For example, it is the configuration information of beams in units of cells to be measured by the UE or configuration information of beams for each bandwidth part when a cell group is deactivated, and may include beam-related configuration information (transmission configuration indication (TCI) state or quasi co-location QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource). In addition, the configuration information may include bandwidth part configuration information indicating in which bandwidth part the RLM procedure is to be performed (e.g., it may be indicated as a bandwidth part identifier). As another method, when the cell group state is deactivated, the UE performs the RLM procedure in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the RLM procedure in the last (or previously) activated bandwidth part before the cell group state becomes deactivated so that the connection state with the cell group may be maintained continuously (e.g., a case where bandwidth part configuration information indicating in which bandwidth part the RLM procedure is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the RLM procedure is to be performed is not configured, the UE may perform the RLM procedure in the last (or previously) activated bandwidth part. In addition, the configuration information may include beam-related configuration information indicating in which beam the RLM procedure is to be performed (e.g., it can be indicated as a bandwidth part identifier, TCI state or QCL configuration information). As another method, when the cell group state is deactivated, the UE performs the RLM procedure in the beam (e.g., TCI state or QCL configuration information) configured in the RRC message or activates the beam and performs the RLM procedure, monitors a beam that should be activated when activating the cell group early, so that cell group activation delay can be minimized. As another method, in the case that the cell group state is configured to a deactivated state (or activated state), the UE performs the RLM procedure in the last (or previously) activated beam before the cell group state becomes deactivated, so that the connection state with the cell group can be continuously maintained (e.g., a case where beam-related configuration information indicating in which beam the RLM procedure is performed is not configured). When activating the cell group, in the case that the beam-related configuration information indicating in which beam the RLM procedure is performed is not configured, the UE may perform the RLM procedure in the last (or previously) activated beam.
   ▪ Configuration information for a beam failure detection or beam failure detection (BFD) or configuration information for BFD to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource. In addition, the configuration information may include bandwidth part configuration information indicating in which bandwidth part the beam failure detection is to be performed (e.g., it may be indicated as a bandwidth part identifier). As another method, when the cell group state is deactivated, the UE performs the beam failure detection in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the beam failure detection in the last (or previously) activated bandwidth part before the cell group state becomes deactivated so that the connection state with the cell group may be maintained continuously (e.g., a case where bandwidth part configuration information indicating in which bandwidth part the beam failure detection is to be performed is not configured). Alternatively, when activating the cell group, the UE may perform an activation procedure in the first active bandwidth part (or the first active downlink bandwidth part, firstActiveDownlinkBWP-ID) configured in the RRC message. If the cell group is activated, in the case that the bandwidth part related configuration information indicating in which bandwidth part the beam failure detection is to be performed is not configured, the UE may perform the beam failure detection in the last (or previously) activated bandwidth part. In addition, the configuration information may include beam-related configuration information indicating in which beam the beam failure detection is to be performed (e.g., it can be indicated as a bandwidth part identifier, TCI state or QCL configuration information). As another method, when the cell group state is deactivated, the UE performs the beam failure detection in the beam (e.g., TCI state or QCL configuration information) configured in the RRC message, monitors a beam that should be activated when activating the cell group early, so that cell group activation delay can be minimized. As another method, in the case that the cell group state is configured to a deactivated state (or activated state), the UE performs the beam failure detection in the last (or previously) activated beam before the cell group state becomes deactivated, so that the connection state with the cell group can be continuously maintained (e.g., a case where beam-related configuration information indicating in which beam the beam failure detection is performed is not configured), or when activating the cell group, the UE may perform an activation procedure in the beam configured in the RRC message. When activating the cell group, in the case that the beam-related configuration information indicating in which beam the beam failure detection is performed is not configured, the UE may perform the beam failure detection in the last (or previously) activated beam.

In the above, in the case that the request acknowledge message k-15 is received, the master base station (MCG) may identify the request acknowledge message, and transmit the second RRC message (e.g., RRCReconfiguration) including the information included in the request acknowledge message (e.g., the first RRC message included in the request acknowledge message k-15), k-20. The second RRC message may include at least one piece of the following information:
Second RRC message identifier for distinguishing the second RRC message (e.g., rrc-Transaction identifier). The UE and the base station (e.g., master base station) transmit or receive a plurality of RRC messages to or from each other, and identifiers for distinguishing the respective RRC messages may be thus included in the RRC messages. For example, an RRC message (e.g., RRCReconfiguration message) transmitted by a transmission end, an RRC message (e.g., RRCReconfigurationComplete message) corresponding to the RRC message (e.g., RRCReconfiguration message) transmitted by a reception end, or an RRC message corresponding to the RRC message transmitted by the transmission end may include the same second RRC message identifier.
First RRC message included in the request acknowledge message k-15
Indicator or configuration information (e.g., indicator or configuration information for the UE) for configuring, clearing, adding, deactivating, activating, resuming, changing, reconfiguring, or suspending dual connectivity, a cell group (e.g., secondary cell group), or a cell
Indicator indicating a cell group state (e.g., activated, deactivated, suspended, or resumed)
Cell group identifier for distinguishing cell groups. The cell group identifier may be assigned by the master base station, or one identifier among previously agreed identifiers may be assigned by the secondary base station.
Cell group or cell configuration information
Bearer configuration information. For example, indicator information indicating an operation of a protocol layer (e.g., SDAP layer, PDCP layer, RLC layer, or MAC layer) of each bearer (e.g., PDCP suspension indicator, PDCP re-establishment indicator, PDCP data recovery indicator, RLC re-establishment indicator, MAC partial reset indicator, MAC reset indicator, or indicator triggering a new operation)
In the above, in the case that an indicator or configuration information for configuring, adding, activating, resuming, changing, or reconfiguring dual connectivity, a cell group (secondary cell group), or a cell is included, a first indicator (e.g., mobilityControlInfor or ReconfigurationWithSync) may be included together. However, in the case that an indicator or configuration information for clearing, deactivating, reconfiguring, or suspending dual connectivity, a cell group (e.g., secondary cell group), or a cell is included, the first indicator (e.g., mobilityControlInfor or ReconfigurationWithSync) may not be included. The first indicator may be an indicator triggering random access to the cell group or cell, an indicator for synchronizing a signal with a new cell, an indicator indicating frequency shifting of the UE, or an indicator indicating changing of a cell group (or cell). As another method, the UE may perform PDCCH monitoring in the cell group or cell indicated or configured above, and trigger and perform random access as indicated by the PDCCH. For example, an upper layer (e.g., RRC layer) may send an indicator for triggering random access to a lower layer (e.g., MAC layer).
In the above, in the case that the indicator or configuration information for configuring, adding, activating, resuming, changing, or reconfiguring dual connectivity, a cell group (e.g., secondary cell group), or a cell is included, random access configuration information may be included together. However, in the case that the indicator or configuration information for clearing, deactivating, reconfiguring, or suspending dual connectivity, a cell group (e.g., secondary cell group), or a cell is included, the random access configuration information may not be included. The random access configuration information may include random access transmission resource information (time or frequency transmission resource), designated preamble information, or the like for preamble transmission for the cell group or cell.
Time information indicating when to activate, resume, deactivate, or suspend dual connectivity, a cell group (e.g., secondary cell group), or a cell (PSCell or SCG SCell) (e.g., information indicating timing (e.g., X) time unit, subframe unit, time slot unit, or symbol unit), for example, time information indicating, if the message is received in an nth time unit, whether to activate, resume, deactivate, or suspend the cell in an (n+X)th time unit)
First channel measurement configuration information for each cell or each bandwidth part
Second channel measurement configuration information for each cell or each bandwidth part
Indicator indicating adding of cell group configuration or changing of a cell group (ReconfigurationWithSync) or indicator indicating random access (ReconfigurationWithSync or a newly defined indicator)
Indicator indicating, when activating a cell group, whether to activate a cell group by performing random access or activate a cell group without random access (ReconfigurationWithSync or a newly defined indicator)
Radio resource management (RRM) configuration information, frequency measurement configuration information or separate radio resource management (RRM) configuration information or frequency measurement configuration information to be applied or performed when deactivating a cell group (e.g., simplified frequency measurement configuration information for reducing battery consumption (Reduced or Relaxed RRM configuration information))
Configuration information for radio link monitoring (RLM) or configuration information for RLM to be applied or performed when deactivating a cell group. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource). In addition, the configuration information may include bandwidth part configuration information indicating in which bandwidth part the RLM procedure is to be performed (e.g., it may be indicated as a bandwidth part identifier). As another method, when the cell group state is deactivated, the UE performs the RLM procedure in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the RLM procedure in the last (or previously) activated bandwidth part before the cell group state becomes deactivated so that the connection state with the cell group may be maintained continuously (e.g., a case where bandwidth part configuration information indicating in which bandwidth part the RLM procedure is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the RLM procedure is to be performed is not configured, the UE may perform the RLM procedure in the last (or previously) activated bandwidth part. In addition, the configuration information may include beam-related configuration information indicating in which beam the RLM procedure is to be performed (e.g., it can be indicated as a bandwidth part identifier, TCI state or QCL configuration information). As another method, when the cell group state is deactivated, the UE performs the RLM procedure in the beam (e.g., TCI state or QCL configuration information) configured in the RRC message or activates the beam and performs the RLM procedure, monitors a beam that should be activated when activating the cell group early, so that cell group activation delay can be minimized. As another method, in the case that the cell group state is configured to a deactivated state (or activated state), the UE performs the RLM procedure in the last (or previously) activated beam before the cell group state becomes deactivated, so that the connection state with the cell group can be continuously maintained (e.g., a case where beam-related configuration information indicating in which beam the RLM procedure is performed is not configured). When activating the cell group, in the case that the beam-related configuration information indicating in which beam the RLM procedure is performed is not configured, the UE may perform the RLM procedure in the last (or previously) activated beam.
Configuration information for a beam failure detection or beam failure detection (BFD) or configuration information for BFD to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource. In addition, the configuration information may include bandwidth part configuration information indicating in which bandwidth part the beam failure detection is to be performed (e.g., it may be indicated as a bandwidth part identifier). As another method, when the cell group state is deactivated, the UE performs the beam failure detection in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the beam failure detection in the last (or previously) activated bandwidth part before the cell group state becomes deactivated so that the connection state with the cell group may be maintained continuously (e.g., a case where bandwidth part configuration information indicating in which bandwidth part the beam failure detection is to be performed is not configured). Alternatively, when activating the cell group, the UE may perform an activation procedure in the first active bandwidth part (or the first active downlink bandwidth part, firstActiveDownlinkBWP-ID) configured in the RRC message. If the cell group is activated, in the case that the bandwidth part related configuration information indicating in which bandwidth part the beam failure detection is to be performed is not configured, the UE may perform the beam failure detection in the last (or previously) activated bandwidth part. In addition, the configuration information may include beam-related configuration information indicating in which beam the beam failure detection is to be performed (e.g., it can be indicated as a bandwidth part identifier, TCI state or QCL configuration information). As another method, when the cell group state is deactivated, the UE performs the beam failure detection in the beam (e.g., TCI state or QCL configuration information) configured in the RRC message, monitors a beam that should be activated when activating the cell group early, so that cell group activation delay can be minimized. As another method, in the case that the cell group state is configured to a deactivated state (or activated state), the UE performs the beam failure detection in the last (or previously) activated beam before the cell group state becomes deactivated, so that the connection state with the cell group can be continuously maintained (e.g., a case where beam-related configuration information indicating in which beam the beam failure detection is performed is not configured), or when activating the cell group, the UE may perform an activation procedure in the beam configured in the RRC message. When activating the cell group, in the case that the beam-related configuration information indicating in which beam the beam failure detection is performed is not configured, the UE may perform the beam failure detection in the last (or previously) activated beam.

In the above, in the case that the UE receives the second RRC message k-20, the UE reads and identifies the second RRC message, or read the information included in the second RRC message (e.g., the first RRC message included in the second RRC message), and the UE may configure, add, change, resume, suspend, or deactivate dual connectivity or a cell group (e.g., secondary cell group). In addition, if the first indicator for triggering random access is included in the second RRC message or the first RRC message, the random access may be triggered for the cell group or cell configured or indicated above. When performing the random access in the above, if there is random access information in the RRC message or if there is stored random access information, the UE may perform the random access (e.g., contention-free random access (e.g., 4-step random access or 2-step random access)) based on the random access information stored or received as the RRC message or based on system information. If there is no random access information in the RRC message, the UE may perform the random access (e.g., contention-based random access (e.g., 4-step random access or 2-step random access). As another method, the UE may also perform PDCCH monitoring in the cell group or cell indicated or configured above, and trigger the random access according to an indication indicated by the PDCCH. For example, a higher layer (e.g., an RRC layer) may transmit an indicator for triggering the random access to a lower layer (e.g., a MAC layer).

In the case that the state of the secondary cell group configured for the UE is configured to an inactivated state and performing the RLM procedure or BFD procedure is configured through the RRC message, the UE may perform the following procedures to perform the RLM procedure or BFD procedure in a bandwidth part as suggested above.
If the state of the secondary cell group configured for the UE is configured to the deactivated state via the RRC message, if the PSCell is deactivated, or if the bandwidth part of the cell group (SCG) or cell (PSCell) is deactivated, the UE can perform the following procedure:
   ▪ For the purpose of reporting to the upper layer whether the signal is an out-of-sync state or an in-sync state, the UE may perform monitoring (performing a RLM procedure or a BFD procedure) on a downlink radio link signal of a primary cell. In addition, in the cell group or cell, the UE is not required to monitor downlink radio link signal in a downlink bandwidth part excluding the activated downlink bandwidth part or a downlink bandwidth part excluding deactivated bandwidth part (or downlink bandwidth part) of the deactivated cell group (or PSCell) (For example, the downlink radio link quality of the primary cell I monitored by a UE for the purpose of indicating out-of-sync/in-sync state to higher layers. The UE is not required to monitor the downlink radio link quality in DL BWPs other than the active DL BWP and inactive (or deactivated) BWP associated with PSCell (or deactivated PSCell or deactivated SCG) on the primary cell). As another method, in the cell group or cell, the UE may perform monitoring (RLM procedure or BFD procedure) the downlink radio link signal only in the activated downlink bandwidth part or the deactivated bandwidth part (or downlink bandwidth part) of the deactivated cell group (or PSCell).
If the state of the secondary cell group configured for the UE is configured to an inactivated state as the RRC message, if the PSCell is deactivated, or if a bandwidth part of the cell group (SCG) or cell (PSCell) is activated (or if the activated state is maintained), the UE may perform the following procedure:
   ▪ For the purpose of reporting to the upper layer whether the signal is an out-of-sync state or an in-sync state, the UE may perform monitoring (performing a RLM procedure or a BFD procedure) on a downlink radio link signal of a primary cell. In addition, the UE is not required to monitor downlink radio link signal in the downlink bandwidth part excluding the activated downlink bandwidth part in the cell group or cell (For example, the downlink radio link quality of the primary cell I monitored by a UE for the purpose of indicating out-of-sync/in-sync state to higher layers. The UE is not required to monitor the downlink radio link quality in DL BWPs other than the active DL BWP on the primary cell). As another method, in the cell group or cell, the UE may perform monitoring (performing the RLM procedure or BFD procedure) the downlink radio link signal only in the activated downlink bandwidth part.

In the following of the disclosure, a first embodiment of a UE operation based on dual connectivity configuration information when receiving the RRC message (e.g., RRCReconfiguration message) is proposed. In the above embodiment, it is proposed a procedure for enabling the UE to activate the cell group without random access (RACH less activation) when activating, adding or changing the cell group.
If the UE receives the RRCReconfiguration message, the UE may perform the following procedure.
1> If, for the UE, MCG (or master node (MN)) is configured to LTE (E-UTRA) and SCG (or secondary node (SN)) is configured to NR (i.e., E-UTRA nr-SecondaryCellGroupConfig is configured) or if the UE is configured to (NG)EN-DC(Next Generation E-UTRA NR—Dual connectivity connected to 5GC),
   ▪2> if the RRCReconfiguration message is received via an E-UTRA RRC message in a MobilityFromNRCommand message (a message indicating handover from NR to (NG)EN-DC),
      ♦3> in the above message, if the reconfigurationWithSync configuration information is included in the spCellConfig of the SCG or if the state of the cell group of the SCG is not configured to the deactivated state,
         •4> the UE may perform (or trigger or start) the random access for SpCell (or SCG or PSCell).
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the (timealignmenttimer (TAT) timer associated with the cell group (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise, if (else if) the state of the cell group of the SCG is not configured to a deactivated state, or if a new indicator (e.g., RACH-less indication) is included in the message and indicated not to perform the random access, or if the reconfigurationWithSync configuration information is not included in spCellConfig of SCG in the message,
         •4> the UE may not perform (or trigger or start) the random access for SpCell (or SCG or PSCell).
         •4> the UE may activate the SpCell without the random access, or may start monitoring the PDCCH for the SpCell, or may start receiving the PDSCH. Alternatively, in the case that a scheduling request (SR) transmission resource is configured for the cell (or in the case that it is configured for PUCCH), SR may be transmitted for the configured transmission resource.
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise (else)
         •4> The procedure performed by the UE ends.
1> If, for the UE, MCG (or master node (MN)) is configured to NR and SCG (or secondary node (SN)) is configured to NR (e.g., E-UTRA nr-SecondaryCellGroupConfig is configured), or if the UE is configured to NR-DC (NR—Dual connectivity connected to 5GC), or if the RRCReconfiguration message is received from the nr-SCG of mrdc-SecondaryCellGroup configuration information through SRB1, or if the mrdc-SecondaryCellGroup configuration information is received in the RRCReconfiguration or RRCResume message through SRB1,
   ▪2> In the message, if reconfigurationWithSync configuration information is included in spCellConfig of nr-SCG or if the state of the cell group of the SCG is not configured to a deactivated state,
      ♦3> the UE may perform (or trigger or start) the random access for SpCell (or SCG or PSCell).
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise, if (else if) the state of the cell group of the SCG is not configured to a deactivated state, or if a new indicator (e.g., RACH-less indication) is included in the message and indicated not to perform the random access, or if the reconfigurationWithSync configuration information is not included in spCellConfig of SCG in the message,
      ♦3> the UE may not perform (or trigger or start) the random access for SpCell (or SCG or PSCell),
      ♦3> the UE may activate the SpCell without the random access, or may start monitoring the PDCCH for the SpCell, or may start receiving the PDSCH. Alternatively, in the case that a scheduling request (SR) transmission resource is configured for the cell (or in the case that it is configured for PUCCH), SR may be transmitted for the configured transmission resource.
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise (else)
      ♦3> The procedure performed by the UE ends.
1> In the above message, if reconfigurationWithSync configuration information is included in spCellConfig of MCG or SCG and if the MAC layer of the NR cell group successfully completes the random access triggered above,
   ▪2> the first timer T304 for the cell group may be suspended (or if the timer is running),
   ▪2> the second timer T310 for the cell group or source SpCell may be suspended (or if the timer is running)
When reconfigurationWithSync is included in the message and the UE performs a reconfiguration procedure (reconfiguration with Sync) to match synchronization, the following procedure may be performed:
1> If a dual active protocol stack (DAPS) bearer is not configured, or if the state of the cell group (or SCG) is not configured to a deactivated state, or if RLM-related configuration or beam failure detection-related configuration information for the deactivated cell group is not configured (in the case that the state of the cell group is configured to the deactivated state, the second timer is continuously running and the RLM procedure is performed so that quick activation of the cell group can be supported) or unless this procedure is performed for the deactivated cell group (or SCG),
   ▪2> The second timer T310 for the cell group or SpCell may be suspended (or if the timer is running),
1> the third timer T312 for the cell group or SpCell may be suspended (or if the timer is running)
1> If the state of the cell group (or SCG) is not configured to the deactivated state or if this procedure is not performed for the deactivated cell group (or SCG),
   ▪2> the first timer T304 may be started for the SpCell (PCell of MCG or PSCell of SCG) by configuring the first timer T304 with the value of the first timer T304 included in the reconfigurationWithSync configuration information of the message.
As proposed by the disclosure, if RLM-related configuration information or beam state detection-related configuration information is configured for the cell group (or SCG) deactivated in the RRC message (e.g., RRCReconfiguration message), the UE may perform the radio link failure detection procedure.
   ▪1> If the state of the cell group is configured to the deactivated state (or if the beam failure detection or RLM procedure is configured for the deactivated cell group) or if an out-of-sync indication for SpCell is received a predetermined number of times (e.g., N310 value) from a lower layer,
      ♦the second timer T310 for the SpCell may be started. (when the state of the cell group is activated (or configured to the activated state or not configured to the deactivated state), or when the random access is started or performed for the SpCell, the second timer may be suspended if the second timer is running. In addition, if the second timer expires, it may be declared that radio link failure has occurred for the cell group).
   ▪1> If a certain DAPS bearer is configured or if an out-of-sync indication for SpCell is received a predetermined number of times (e.g., N310 value) from a lower layer, or if the first timer is running,
      ♦the second timer T310 can be started for the source SpCell.
   ▪1> If an out-of-sync indication for SpCell is received a predetermined number of times (e.g., N310 value) from a lower layer, or if the first timer T304 or fourth timer is not running,
      ♦the second timer T310 can be started for the source SpCell.

In the following of the disclosure, a second embodiment of a UE operation based on dual connectivity configuration information when receiving the RRC message (e.g., RRCReconfiguration message) is proposed. In the above embodiment, it is proposed a procedure for enabling the UE to activate the cell group without random access (RACH less activation) when activating, adding or changing the cell group.
If the UE receives the RRCReconfiguration message, the UE may perform the following procedure.
1> If, for the UE, MCG (or master node (MN)) is configured to LTE (E-UTRA) and SCG (or secondary node (SN)) is configured to NR (i.e., E-UTRA nr-SecondaryCellGroupConfig is configured) or if the UE is configured to (NG)EN-DC(Next Generation E-UTRA NR—Dual connectivity connected to 5GC),
   ▪2> if the RRCReconfiguration message is received via an E-UTRA RRC message in a MobilityFromNRCommand message (a message indicating handover from NR to (NG)EN-DC),
      ♦3> in the above message, if the reconfigurationWithSync configuration information is included in the spCellConfig of the SCG, or if the state of the cell group of the SCG is not configured to the deactivated state, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure occurs), or if the beam failure detection or RLM procedure is not configured for the deactivated cell group, or if a new beam (TCI state) is not configured in the RRC message, or if radio link failure is detected in the RLM procedure (or if the second timer T310 expires or if the radio link with the SCG is not valid),
         •4> the UE may perform (or trigger or start) the random access for SpCell (or SCG or PSCell).
         •4> In the above, if the cell group (e.g., secondary cell group) is configured (or indicated) to be activated (or if the state of the cell group is not configured to an inactivated state in the above), or if the previous state of the cell group was the inactivated state, or if the UE was in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is running (or is not expired, or does not receive an indication indicating the expiration from a lower layer), or if an indication that beam failure is detected is not received from a lower layer (or if beam failure is not occurred), or if the beam failure detection or RLM procedure is configured for the deactivated cell group, or if the radio link failure is not detected in the RLM procedure (or if the second timer T310 is not expired or if the radio link of the SCG is valid), or if the reconfigurationWithSync configuration information is not included in the spCellConfig of SCG in the message,
         •4> the UE may not perform (or trigger or start) the random access for SpCell (or SCG or PSCell).
         •4> the UE may activate the SpCell without the random access, or may start monitoring the PDCCH for the SpCell, or may start receiving the PDSCH. Alternatively, when the scheduling request (SR) transmission resource is configured for the cell (or in the case that the SR is configured for the PUCCH), the SR may be transmitted for the configured transmission resource.
         •4> In the above, if the cell group (e.g., secondary cell group) is configured (or indicated) to be activated (or if the state of the cell group is not configured to an inactivated state in the above), or if the previous state of the cell group was the inactivated state, or if the UE was in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure is occurred), or if the beam failure detection or RLM procedure is not configured for the deactivated cell group, or if a new beam (TCI state) is not configured in the RRC message, or if the radio link failure is detected in the RLM procedure (or if the second timer T310 expires or if the radio link of the SCG is not valid), or if the reconfigurationWithSync configuration information is not included in the spCellConfig of SCG in the message,
         •4> the UE may perform (or trigger or start) the random access for SpCell (or SCG or PSCell).
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise (else)
         •4> The procedure performed by the UE ends.
1> If, for the UE, MCG (or master node (MN)) is configured to NR and SCG (or secondary node (SN)) is configured to NR (i.e., E-UTRA nr-SecondaryCellGroupConfig is configured) or if the UE is configured to NR-DC (NR-Dual connectivity connected to 5GC), or if the RRCReconfiguration message is received from the nr-SCG of the mrdc-SecondaryCellGroup configuration information through SRB1, or if the mrdc-SecondaryCellGroup configuration information is received from the RRCReconfiguration or RRCResume message through SRB1,
   ▪2> in the above message, if the reconfigurationWithSync configuration information is included in the spCellConfig of nr-SCG, or if the state of the cell group of the SCG is not configured to the deactivated state, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure occurs), or if the beam failure detection or RLM procedure is not configured for the deactivated cell group, or if a new beam (TCI state) is not configured in the RRC message, or if radio link failure is detected in the RLM procedure (or if the second timer T310 expires or if the radio link with the SCG is not valid),
      ♦3> the UE may perform (or trigger or start) the random access for SpCell (or SCG or PSCell).
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is running (or does not expire, or does not receive an indication indicating the expiration from a lower layer), or if an indication that beam failure is detected is not received from a lower layer (or if beam failure is not occurred), or if the beam failure detection or RLM procedure is configured for the deactivated cell group, or if the reconfigurationWithSync configuration information is not included in the spCellConfig of SCG in the message, or if the radio link failure is not detected in the RLM procedure (or if the second timer T310 does not expire or the radio link with the SCG is valid),
      ♦3> the UE may not perform (or trigger or start) the random access for SpCell (or SCG or PSCell).
      ♦3> the UE may activate the SpCell without the random access, or may start monitoring the PDCCH for the SpCell, or may start receiving the PDSCH. Alternatively, when the scheduling request (SR) transmission resource is configured for the cell (or in the case that the SR is configured for the PUCCH), the SR may be transmitted for the configured transmission resource.
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure is occurred), or if the beam failure detection or RLM procedure is not configured for the deactivated cell group, or if a new beam (TCI state) is not configured in the RRC message, or if the radio link failure is detected in the RLM procedure (or if the second timer T310 expires or if the radio link of the SCG is not valid), or if the reconfigurationWithSync configuration information is not included in the spCellConfig of SCG in the message,
      ♦3> the UE may perform (or trigger or start) the random access for SpCell (or SCG or PSCell).
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise (else)
      ♦3> The procedure performed by the UE ends.
1> In the above message, if reconfigurationWithSync configuration information is included in spCellConfig of MCG or SCG and if the MAC layer of the NR cell group successfully completes the random access triggered above,
   ▪2> the first timer T304 for the cell group may be suspended (or if the timer is running),
   ▪2> the second timer T310 for the cell group or source SpCell may be suspended (or if the timer is running)
When reconfigurationWithSync is included in the message and the UE performs a reconfiguration procedure (reconfiguration with Sync) to match synchronization, the following procedure may be performed:
1> If a dual active protocol stack (DAPS) bearer is not configured, or if the state of the cell group (or SCG) is not configured to a deactivated state, or if RLM-related configuration or beam failure detection-related configuration information for the deactivated cell group is not configured (in the case that the state of the cell group is configured to the deactivated state, the second timer is continuously running and the RLM procedure is performed so that quick activation of the cell group can be supported) or unless this procedure is performed for the deactivated cell group (or SCG),
   ▪2> The second timer T310 may be suspended for the cell group or SpCell (or if the timer is running)
1> The third timer T312 may be suspended for the cell group or SpCell (or if the timer is running)
1> If the state of the cell group (or SCG) is not configured to the deactivated state or if this procedure is not performed for the deactivated cell group (or SCG),
   ▪2> The first timer T304 may be started for the SpCell (PCell of MCG or PSCell of SCG) by configuring the first timer T304 with the value of the first timer T304 included in the reconfigurationWithSync configuration information of the message.
As proposed by the disclosure, if RLM-related configuration information or beam state detection-related configuration information is configured for the cell group (or SCG) deactivated in the RRC message (e.g., RRCReconfiguration message), the UE may perform the radio link failure detection procedure.
   ▪1> If the state of the cell group is configured to the deactivated state (or if the beam failure detection or RLM procedure is configured for the deactivated cell group) or if an out-of-sync indication for SpCell is received a predetermined number of times (e.g., N310 value) from a lower layer,
      ♦the second timer T310 for the SpCell may be started. (when the state of the cell group is activated (or configured to the activated state or not configured to the deactivated state), or when the random access is started or performed for the SpCell, or when the random access is successfully completed, the second timer may be suspended if the second timer is running. In addition, if the second timer expires, it may be declared that radio link failure has occurred for the cell group).
   ▪1> If a certain DAPS bearer is configured or if an out-of-sync indication for SpCell is received a predetermined number of times (e.g., N310 value) from a lower layer, or if the first timer is running,
      ♦the second timer T310 can be started for the source SpCell.
   ▪1> If an out-of-sync indication for SpCell is received a predetermined number of times (e.g., N310 value) from a lower layer, or if the first timer T304 or fourth timer is not running,
      ♦the second timer T310 can be started for the source SpCell.

In the following of the disclosure, a third embodiment of a UE operation based on dual connectivity configuration information when receiving the RRC message (e.g., RRCReconfiguration message) is proposed. In the above embodiment, it is proposed a procedure for enabling the UE to activate the cell group without random access (RACH less activation) when activating, adding or changing the cell group.
If the UE receives the RRCReconfiguration message, the UE may perform the following procedure.
1> If, for the UE, MCG (or master node (MN)) is configured to LTE (E-UTRA) and SCG (or secondary node (SN)) is configured to NR (i.e., E-UTRA nr-SecondaryCellGroupConfig is configured) or if the UE is configured to (NG)EN-DC(Next Generation E-UTRA NR—Dual connectivity connected to 5GC),
   ▪2> if the RRCReconfiguration message is received via E-UTRA RRC message in a MobilityFromNRCommand message (message indicating handover from NR to (NG)EN-DC),
      ♦3> in the above message, if the reconfigurationWithSync configuration information is included in the spCellConfig of the SCG, or if the state of the cell group of the SCG is not configured to the deactivated state, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure occurs), or if the beam failure detection or RLM procedure is not configured for the deactivated cell group, or if a new beam (TCI state) is not configured in the RRC message, or if radio link failure is detected in the RLM procedure (or if the second timer T310 expires or if the radio link with the SCG is not valid),
         •4> the UE may perform (or trigger or start) the random access for SpCell (or SCG or PSCell).
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise, if (else if) the state of the cell group of the SCG is not configured to the deactivated state, or if a new indicator (e.g., RACH-less indication or second reconfigurationWithcSync) is included in the message and indicated not to perform the random access, or if the TAT timer (a timer for determining the validity of the timing advance (TA) value for synchronizing the UE and the base station) running in the MAC layer is running (or does not expire, or does not receive an indication indicating the expiration from a lower layer), or if an indication that beam failure is detected is not received from a lower layer (or if beam failure is not occurred), or if the beam failure detection or RLM procedure is configured for the deactivated cell group, or if the radio link failure is not detected in the RLM procedure (or if the second timer T310 does not expire or if the radio link of the SCG is valid), or if the reconfigurationWithSync configuration information is not included in the spCellConfig of SCG in the message,
         •4> the UE may not perform (or trigger or start) the random access for SpCell (or SCG or PSCell).
         •4> the UE may activate the SpCell without the random access, or may start monitoring the PDCCH for the SpCell, or may start receiving the PDSCH. Alternatively, when the scheduling request (SR) transmission resource is configured for the cell (or in the case that the SR is configured for the PUCCH), the SR may be transmitted for the configured transmission resource.
         •4> The UE may introduce a new fourth timer to identify whether or not the SpCell has been successfully activated without the random access. For example, the fourth timer may be started when the above condition is satisfied. The fourth timer may be suspended when PDCCH or PDSCH is successfully received from the SpCell. If the fourth timer expires, the UE may trigger an SCG failure reporting procedure and report the SCG failure through the MCG. As another method, in the case that the fourth timer expires, the UE may perform the random access (contention based random access (CBRA) or contention free random access (CFRA)) or 2-step random access (two-step RACH) based on the configuration information for a separate random access configured in the RRC message or broadcast in system information (e.g., it may be configured to second reconfigurationWithSync, or preamble information, smtc information or a new UE identifier (RNTI value) may be configured, or a Need code may be configured to S and stored and used) (i.e., it can fall back to the random access). As another method, in the case that the procedure for activating the cell group without the random access fails (e.g., a case where PDCCH or PDSCH is not successfully received for a certain period of time), the UE may perform the random access (contention based random access (CBRA) or contention free random access (CFRA)) or 2-step random access (two-step RACH) based on the configuration information for a separate random access configured in the RRC message or broadcast in system information (i.e., it can fall back to the random access). The configuration information for the separate random access may be configured when an indication to deactivate the cell group is transmitted to the UE as the RRC message, or when an indication indicating the UE to activate the cell group (or reconfigurationWithSync) is transmitted to the UE via the RRC message. In the above, whether or not the cell group is successfully activated without the random access may be determined by, for example, whether the UE successfully receives the PDCCH from the base station, receives a transmission resource (uplink grant or downlink assignment), or receives the RRC message from the base station.
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure is occurred), or a new beam (TCI state) is not configured in the RRC message, or if the beam failure detection or RLM procedure is not configured for the deactivated cell group, or if the radio link failure is detected in the RLM procedure (or if the second timer T310 expires or if the radio link of the SCG is not valid), or if the reconfigurationWithSync configuration information is not included in the spCellConfig of SCG in the message,
         •4> the UE may perform (or trigger or start) the random access for SpCell (or SCG or PSCell).
         •4> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
      ♦3> Otherwise (else)
         •4> The procedure performed by the UE ends.
1> If, for the UE, MCG (or master node (MN)) is configured to NR and SCG (or secondary node (SN)) is configured to NR (i.e., E-UTRA nr-SecondaryCellGroupConfig is configured), or if the UE is configured to NR-DC(NR-Dual connectivity connected to 5GC), or if the RRCReconfiguration message is received from the nr-SCG of the mrdc-SecondaryCellGroup configuration information through SRB1, or if the mrdc-SecondaryCellGroup configuration information is received from the RRCReconfiguration or RRCResume message through SRB1,
   ▪2> in the above message, if the reconfigurationWithSync configuration information is included in the spCellConfig of nr-SCG, or if the state of the cell group of the SCG is not configured to the deactivated state, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure occurs), or if the beam failure detection or RLM procedure is not configured for the deactivated cell group, or if a new beam (TCI state) is not configured in the RRC message, or if radio link failure is detected in the RLM procedure (or if the second timer T310 expires or if the radio link with the SCG is not valid),
      ♦3> the UE may perform (or trigger or start) the random access for SpCell (or SCG or PSCell).
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is running (or does not expire, or does not receive an indication indicating the expiration from a lower layer), or if an indication that beam failure is detected is not received from a lower layer (or if beam failure is not occurred), or if the beam failure detection or RLM procedure is configured for the deactivated cell group, or if the radio link failure is not detected in the RLM procedure (or if the second timer T310 does not expire or if the radio link of the SCG is valid), or if the reconfigurationWithSync configuration information is not included in the spCellConfig of SCG in the message,
      ♦3> the UE may not perform (or trigger or start) the random access for SpCell (or SCG or PSCell).
      ♦3> the UE may activate the SpCell without the random access, or may start monitoring the PDCCH for the SpCell, or may start receiving the PDSCH. Alternatively, when the scheduling request (SR) transmission resource is configured for the cell (or in the case that the SR is configured for the PUCCH), the SR may be transmitted for the configured transmission resource.
      ♦3> The UE may introduce a new fourth timer to identify whether or not the SpCell has been successfully activated without the random access. For example, the fourth timer may be started when the above condition is satisfied. The fourth timer may be suspended when PDCCH or PDSCH is successfully received from the SpCell. If the fourth timer expires, the UE may trigger an SCG failure reporting procedure and report the SCG failure through the MCG. As another method, in the case that the fourth timer expires, the UE may perform the random access (contention based random access (CBRA) or contention free random access (CFRA)) or 2-step random access (two-step RACH) based on the configuration information for a separate random access configured in the RRC message or broadcast in system information (e.g., it may be configured to second reconfigurationWithSync, or preamble information, smtc information or a new UE identifier (RNTI value) may be configured, or a Need code may be configured to S and stored and used) (i.e., it can fall back to the random access). As another method, in the case that the procedure for activating the cell group without the random access fails (e.g., a case where PDCCH or PDSCH is not successfully received for a certain period of time), the UE may perform the random access (contention based random access (CBRA) or contention free random access (CFRA)) or 2-step random access (two-step RACH) based on the configuration information for a separate random access configured in the RRC message or broadcast in system information (i.e., it can fall back to the random access). The configuration information for the separate random access may be configured when an indication to deactivate the cell group is transmitted to the UE as the RRC message, or when an indication indicating the UE to activate the cell group (or reconfigurationWithSync) is transmitted to the UE via the RRC message.
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise, if (else if) the state of the cell group of the SCG is not configured to the deactivated state, or if a new indicator (e.g., RACH-less indication) is included in the message and indicated not to perform the random access, or if the TAT timer (a timer for determining the validity of the timing advance (TA) value for synchronizing the UE and the base station) running in the MAC layer is not running (or expires, or receives an indication indicating the expiration from a lower layer), or if an indication that beam failure is detected is received from a lower layer (or if beam failure is occurred), or if the beam failure detection or RLM procedure is not configured for the deactivated cell group, or if a new beam (TCI state) is not configured in the RRC message, or if the radio link failure is detected in the RLM procedure (or if the second timer T310 expires or if the radio link of the SCG is not valid), or if the reconfigurationWithSync configuration information is not included in the spCellConfig of SCG in the message,
      ♦3> the UE may perform (or trigger or start) the random access for SpCell (or SCG or PSCell).
      ♦3> In the above, if the cell group (e.g., secondary cell group) is configured (or indicated) to be activated (or if the state of the cell group is not configured to an inactivated state in the above), or if the previous state of the cell group was the inactivated state, or if the UE is in a connected mode, the UE may reset the MAC layer (MAC reset). In the above, the MAC layer reset (MAC reset) may be performed after the determination of whether or not the UE performs the random access, or after triggering the random access, or when the random access is successfully completed (or after the random access is completed), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. In the following of the disclosure, the MAC layer reset or the partial MAC layer reset will be described below.
   ▪2> Otherwise (else)
      ♦3> The procedure performed by the UE ends.
1> In the above message, if reconfigurationWithSync configuration information is included in spCellConfig of MCG or SCG and if the MAC layer of the NR cell group successfully completes the random access triggered above,
   ▪2> the first timer T304 for the cell group may be suspended (or if the timer is running),
   ▪2> the second timer T310 for the cell group or source SpCell may be suspended (or if the timer is running)
When reconfigurationWithSync is included in the message and the UE performs a reconfiguration procedure (reconfiguration with Sync) to match synchronization, the following procedure may be performed:
1> If a dual active protocol stack (DAPS) bearer is not configured, or if the state of the cell group (or SCG) is not configured to a deactivated state, or if RLM-related configuration or beam failure detection-related configuration information for the deactivated cell group is not configured (in the case that the state of the cell group is configured to the deactivated state, the second timer is continuously running and the RLM procedure is performed so that quick activation of the cell group can be supported) or unless this procedure is performed for the deactivated cell group (or SCG),
   ▪2> The second timer T310 may be suspended for the cell group or SpCell (or if the timer is running)
1> The third timer T312 may be suspended for the cell group or SpCell (or if the timer is running)
1> If the state of the cell group (or SCG) is not configured to the deactivated state or if this procedure is not performed for the deactivated cell group (or SCG),
   ▪2> The first timer T304 may be started for the SpCell (PCell of MCG or PSCell of SCG) by configuring the first timer T304 with the value of the first timer T304 included in the reconfigurationWithSync configuration information of the message.
As proposed by the disclosure, if RLM-related configuration information or beam state detection-related configuration information is configured for the cell group (or SCG) deactivated in the RRC message (e.g., RRCReconfiguration message), the UE may perform the radio link failure detection procedure.
   ▪1> If the state of the cell group is configured to the deactivated state (or if the beam failure detection or RLM procedure is configured for the deactivated cell group) or if an out-of-sync indication for SpCell is received a predetermined number of times (e.g., N310 value) from a lower layer,
      ♦the second timer T310 for the SpCell may be started. (when the state of the cell group is activated (or configured to the activated state or not configured to the deactivated state), or when the random access is started or performed for the SpCell, or when the random access is successfully completed, the second timer may be suspended if the second timer is running. In addition, if the second timer expires, it may be declared that radio link failure has occurred for the cell group).
   ▪1> If a certain DAPS bearer is configured or if an out-of-sync indication for source SpCell is received a predetermined number of times (e.g., N310 value) from a lower layer, or if the first timer is running,
      ♦the second timer T310 can be started for the source SpCell.
   ▪1> If an out-of-sync indication for SpCell is received a predetermined number of times (e.g., N310 value) from a lower layer, or if the first timer T304 or fourth timer is not running,
      ♦The second timer T310 can be started for the source SpCell.

In the above of the disclosure, if the UE receives the RRC message (e.g., RRCReconfiguration message or RRCResume message) including an indicator for activating the cell group (or configured to activate the state of the cell group), in the case that the UE performs the CFRA random access when performing the random access according to the conditions proposed in the disclosure, the UE may start (or restart) the TAT timer configured (or associated) in the cell group or re-apply the TA value (timing advance command (TAC)).

However, if the UE receives the RRC message (e.g., RRCReconfiguration message or RRCResume message) including an indicator for activating the cell group (or configured to activate the state of the cell group), in the case that the UE performs the CBRA random access when performing the random access according to the conditions proposed in the disclosure, the UE does not start (or restart) the TAT timer configured (or associated) in the cell group (or PSCell) or cannot re-apply the TA value (timing advance command (TAC)) because the base station cannot identify the cell identifier of the UE (because the CBRA procedure does not include the cell identifier of the UE). Therefore, in order to solve the above problem, when the base station transmits the RRC message (e.g., RRCReconfiguration message or RRCResume message) including the indicator for activating the cell group (or configured to activate the state of the cell group) to the UE, or when the base station includes the indicator for performing the random access in the RRC message, the CFRA transmission resource (e.g., a dedicated preamble transmission resource) for the random access is always configured in the RRC message, so that the UE can perform the CFRA random access when performing the random access according to the conditions proposed in the disclosure. As another method, in order to solve the above problem, if the UE receives the RRC message (e.g., RRCReconfiguration message or RRCResume message) including the indicator for activating the cell group (or configured to activate the state of the cell group), when the UE performs the random access (or CBRA random access) according to the conditions proposed in the disclosure, the UE may suspend the TAT timer or consider that the TAT timer expires in the case that the TAT timer configured (or associated) in the cell group (or PSCell) is running. If the TAT timer is suspended as described above, even if the UE performs the CBRA random access, the TAT timer is started (or restarted) or the TA value (timing advance Command (TAC)) can be newly applied. Therefore, the above problem can be solved.

In the above, the UE may receive the second RRC message k-20 or apply the received configuration information, generate the third RRC message k-25 or the fourth RRC message, and transmit it to the base station, k-25. The third RRC message may include some of the following information:
Second RRC message identifier having the same value as the second RRC message identifier included in the second RRC message
Indicator or identifier that the second RRC message has been successfully received
Fourth RRC message including a response indicating that the first RRC message generated and transmitted by the secondary base station has been successfully received. The fourth RRC message may include some of the following information:
   ▪ First RRC message identifier having the same value as the first RRC message identifier included in the first RRC message
   ▪ Indicator or identifier that the first RRC message has been successfully received
   ▪ Response indicator indicating successful application of the first RRC message.

In the above, when the base station (e.g., the master base station) receives the third RRC message, it can determine whether it is a response message to the second RRC message through the second identifier. In addition, the base station may identify the fourth RRC message included in the third RRC message, include the fourth RRC message in a configuration completion message for indicating the secondary cell group base station that the configuration is complete, and transmit the configuration completion message to the secondary base station through a Xn interface (e.g., an interface between base stations) or an Sn interface (an interface between a base station and AMF or UMF or base stations), k-30. The configuration completion message may include some of the following information:
Fourth RRC message included in the third RRC message
Indicator or identifier indicating that the configuration (addition, change or clear of a cell group) or indication (activation, deactivation, suspension or resumption of a cell group) indicated in the request acknowledge message or the first RRC message is completed.

When the configuration completion message is received, the base station (e.g., secondary base station) may read, obtain or identify the fourth RRC message included in the configuration completion message, and may determine, via the first identifier, whether the fourth RRC message is a response message to the first RRC message. Further, the base station may determine whether the indicated configuration or indication has been successfully completed. When the configuration completion message or the fourth RRC message is received, the secondary base station may transmit, to the master base station in response to the reception, a response message indicating that the configuration completion message or the fourth RRC message has been successfully received.

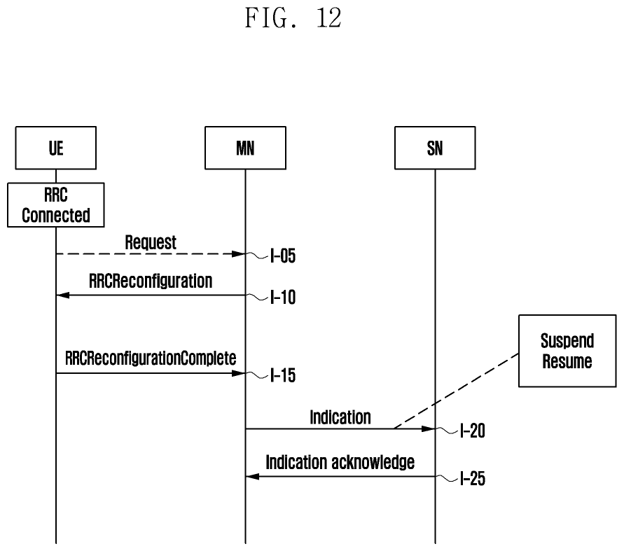

FIG. 12 is a diagram illustrating a second signaling procedure of configuring or clearing dual connectivity, or configuring, clearing, activating, resuming, suspending, or deactivating a secondary cell group for which dual connectivity is configured according to an embodiment of the disclosure.

Referring to FIG. 12, a UE may establish an RRC connection with a network or a base station as in FIG. 6 of the disclosure, and may transmit data to or receive data from the base station (e.g., master cell group (MCG), master node (MN), or cells (PCell or SCell) of the master cell group).

The base station may configure dual connectivity for the UE according to a predetermined reason (e.g., a case where a high data transmission rate is required, or in response to a request 1-05 from the UE, or a case where high QoS requirements should be satisfied). For example, the UE may transmit, to the base station, a request for configuring or clearing, activating or deactivating, or resuming or suspending dual connectivity, a cell group (e.g., secondary cell group), or a cell, and the request message may include a frequency (or channel) measurement result report, a cell group identifier, cell identifiers, or measurement results, 1-05. As another method, the base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell.

A master base station (master node (MN) or master cell group (MCG)) may receive a frequency or channel measurement report for each frequency or channel received from the UE, and may determine a secondary base station (secondary node (SN) or secondary cell group (SCG)), for which dual connectivity is to be configured, based on the measurement report. Alternatively, the master base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell. The master base station may transmit a first RRC message to the UE in order to configure, clear, add, deactivate, activate, resume, change, reconfigure, or suspend dual connectivity, a cell group (secondary cell group), or a cell for the determined secondary base station, 1-10. For the first RRC message, each separate new request message may be defined and used to perform indication to configure, clear, add, deactivate, activate, resume, change, reconfigure, or suspend dual connectivity, a cell group (secondary cell group), or a cell for the UE, and alternatively, a new indicator may be defined from an existing message (e.g., RRCReconfiguration message or RRCResume message) so as to indicate (or request) to configure, clear, add, deactivate, activate, resume, change, reconfigure, or suspend a cell group (e.g., secondary cell group), or a cell. The first RRC message may include some of the following information.
First RRC message identifier for distinguishing the first RRC message (e.g., rrc-Transaction identifier) The UE and the base station (e.g., master base station) transmit or receive a plurality of RRC messages to and from each other, and identifiers for distinguishing the respective RRC messages may be thus included in the RRC messages. For example, an RRC message (e.g., RRCReconfiguration message) transmitted by a transmission end, an RRC message (e.g., RRCReconfigurationComplete message) corresponding to the RRC message (e.g., RRCReconfiguration message) transmitted by a reception end, or an RRC message corresponding to the RRC message transmitted by the transmission end may include the same first RRC message identifier.
Indicator or configuration information (e.g., indicator or configuration information for the UE) for configuring, clearing, adding, deactivating, activating, resuming, changing, reconfiguring, or suspending dual connectivity, a cell group (secondary cell group), or a cell
Indicator indicating a cell group state (e.g., activation, deactivation, suspension, or resumption)
Cell group identifier for distinguishing cell groups. The cell group identifier may be assigned by the master base station, or one identifier among previously agreed identifiers may be assigned by the secondary base station.
Cell group or cell configuration information
Bearer configuration information. For example, indicator information indicating an operation of a protocol layer (e.g., SDAP layer, PDCP layer, RLC layer, or MAC layer) of each bearer (e.g., PDCP suspension indicator, PDCP re-establishment indicator, PDCP data recovery indicator, RLC re-establishment indicator, MAC partial reset indicator, MAC reset indicator, or indicator triggering a new operation)
In the case that an indicator or configuration information for configuring, adding, activating, resuming, changing, or reconfiguring dual connectivity, a cell group (secondary cell group), or a cell is included, a first indicator (e.g., mobilityControlInfor or ReconfigurationWithSync) may be included together. However, in the case that an indicator or configuration information for clearing, deactivating, reconfiguring, or suspending dual connectivity, a cell group (secondary cell group), or a cell is included, the first indicator (e.g., mobilityControlInfor or ReconfigurationWithSync) may not be included. The first indicator may be an indicator triggering random access to the cell group or cell, an indicator for synchronizing a signal with a new cell, an indicator indicating frequency shifting of the UE, or an indicator indicating changing of a cell group (or cell). As another method, the UE may perform PDCCH monitoring in the indicated or configured cell group or cell, and may trigger and perform random access as indicated in PDCCH. For example, an upper layer (e.g., RRC layer) may transmit, to a lower layer (e.g., MAC layer), an indicator triggering random access.
If the indicator or configuration information for configuring, adding, activating, resuming, changing, or reconfiguring dual connectivity, a cell group (secondary cell group), or a cell is included, random access configuration information may be included together. However, in the case that the indicator or configuration information for clearing, deactivating, reconfiguring, or suspending dual connectivity, a cell group (secondary cell group), or a cell is included, the random access configuration information may not be included. The random access configuration information may include random access transmission resource information (time or frequency transmission resource), designated preamble information, or the like for preamble transmission for the cell group or cell.
Time information indicating when to activate, resume, deactivate, or suspend dual connectivity, a cell group (e.g., secondary cell group), or a cell (PSCell or SCG SCell) (e.g., information indicating timing (e.g., X time unit, subframe unit, time slot unit, or symbol unit), for example, time information indicating, if the message is received in an nth time unit, whether to activate, resume, deactivate, or suspend the cell in an (n+X)th time unit))
First channel measurement configuration information for each cell or each bandwidth part
Second channel measurement configuration information for each cell or each bandwidth part
Indicator indicating adding of cell group configuration or changing of a cell group (ReconfigurationWithSync) or indicator indicating random access (ReconfigurationWithSync or a newly defined indicator)
Indicator indicating, when activating a cell group, whether to activate a cell group by performing random access or activate a cell group without random access (ReconfigurationWithSync or a newly defined indicator)
Radio resource management (RRM) configuration information, frequency measurement configuration information or separate radio resource management (RRM) configuration information or frequency measurement configuration information to be applied or performed when deactivating a cell group (e.g., simplified frequency measurement configuration information for reducing battery consumption (Reduced or Relaxed RRM configuration information))
Configuration information for radio link monitoring (RLM) or configuration information for RLM to be applied or performed when deactivating a cell group. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource). In addition, the configuration information may include bandwidth part configuration information indicating in which bandwidth part the RLM procedure is to be performed (e.g., it may be indicated as a bandwidth part identifier). As another method, when the cell group state is deactivated, the UE performs the RLM procedure in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the RLM procedure in the last (or previously) activated bandwidth part before the cell group state becomes deactivated so that the connection state with the cell group may be maintained continuously (e.g., a case where bandwidth part configuration information indicating in which bandwidth part the RLM procedure is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the RLM procedure is to be performed is not configured, the UE may perform the RLM procedure in the last (or previously) activated bandwidth part. In addition, the configuration information may include beam-related configuration information indicating in which beam the RLM procedure is to be performed (e.g., it can be indicated as a bandwidth part identifier, TCI state or QCL configuration information). As another method, when the cell group state is deactivated, the UE performs the RLM procedure in the beam (e.g., TCI state or QCL configuration information) configured in the RRC message or activates the beam and performs the RLM procedure, monitors a beam that should be activated when activating the cell group early, so that cell group activation delay can be minimized. As another method, in the case that the cell group state is configured to a deactivated state (or activated state), the UE performs the RLM procedure in the last (or previously) activated beam before the cell group state becomes deactivated, so that the connection state with the cell group can be continuously maintained (e.g., a case where beam-related configuration information indicating in which beam the RLM procedure is performed is not configured). Alternatively, when activating the cell group, the UE may perform an activation procedure in the beam configured in the RRC message. When activating the cell group, in the case that the beam-related configuration information indicating in which beam the RLM procedure is performed is not configured, the UE may perform the RLM procedure in the last (or previously) activated beam.
Configuration information for a beam failure detection or beam failure detection (BFD) or configuration information for BFD to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource. In addition, the configuration information may include bandwidth part configuration information indicating in which bandwidth part the beam failure detection is to be performed (e.g., it may be indicated as a bandwidth part identifier). As another method, when the cell group state is deactivated, the UE performs the beam failure detection in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the beam failure detection in the last (or previously) activated bandwidth part before the cell group state becomes deactivated so that the connection state with the cell group may be maintained continuously (e.g., a case where bandwidth part configuration information indicating in which bandwidth part the beam failure detection is to be performed is not configured). Alternatively, when activating the cell group, the UE may perform an activation procedure in the first active bandwidth part (or the first active downlink bandwidth part, firstActiveDownlinkBWP-ID) configured in the RRC message. If the cell group is activated, in the case that the bandwidth part related configuration information indicating in which bandwidth part the beam failure detection is to be performed is not configured, the UE may perform the beam failure detection in the last (or previously) activated bandwidth part. In addition, the configuration information may include beam-related configuration information indicating in which beam the beam failure detection is to be performed (e.g., it can be indicated as a bandwidth part identifier, TCI state or QCL configuration information). As another method, when the cell group state is deactivated, the UE performs the beam failure detection in the beam (e.g., TCI state or QCL configuration information) configured in the RRC message, monitors a beam that should be activated when activating the cell group early, so that cell group activation delay can be minimized. As another method, in the case that the cell group state is configured to a deactivated state (or activated state), the UE performs the beam failure detection in the last (or previously) activated beam before the cell group state becomes deactivated, so that the connection state with the cell group can be continuously maintained (e.g., a case where beam-related configuration information indicating in which beam the beam failure detection is performed is not configured), or when activating the cell group, the UE may perform an activation procedure in the beam configured in the RRC message. When activating the cell group, in the case that the beam-related configuration information indicating in which beam the beam failure detection is performed is not configured, the UE may perform the beam failure detection in the last (or previously) activated beam.

In the case that the first RRC message 1-15 is received, the UE may read and identify the first RRC message, and the UE may configure, add, change, resume, suspend, or deactivate dual connectivity or a cell group (e.g., secondary cell group). In addition, if the first indicator triggering random access is included in the first RRC message, random access may be triggered for the configured or indicated cell group or cell. When random access is performed, if there is random access information in the RRC message, or if there is random access information that has been stored, random access (e.g., contention-free random access (e.g., 4-step random access or 2-step random access)) may be performed based on system information or the random access information that has been stored or received via the RRC message. If there is no random access information in the RRC message, random access (e.g., contention-based random access (e.g., 4-step random access or 2-step random access)) may be performed. As another method, the UE may perform PDCCH monitoring in the indicated or configured cell group or cell, and may trigger and perform random access as indicated in PDCCH. For example, an upper layer (e.g., RRC layer) may transmit, to a lower layer (e.g., MAC layer), an indicator triggering random access.

In the above, the UE may receive the first RRC message 1-10 or apply received configuration information, and may generate a second RRC message and transmit the same to the base station, 1-15. The second RRC message may include some of the following information.
First RRC message identifier having the same value as that of the first RRC message identifier included in the first RRC message
Indicator or identifier indicating that the first RRC message has been successfully received

When the base station (e.g., master base station) receives the second RRC message, the base station may determine, via a first identifier, whether the received message is a response message to the first RRC message. The base station may identify the first RRC message, and may transmit an indication message, which includes an indication that a cell group has been configured, added, cleared, activated, resumed, suspended, or deactivated for a secondary cell group base station, to the secondary base station via an Xn interface (e.g., interface between base stations) or an Sn interface (e.g., interface between base stations or a base station and AMF or UMF). The indication message may include some of the following information.
Identifier capable of distinguishing the indication message
Indicator or configuration information (e.g., indicator or configuration information for the secondary cell group) for configuring, clearing, adding, deactivating, activating, resuming, changing, reconfiguring, or suspending dual connectivity, a cell group (secondary cell group), or a cell

When the indication message is received, the base station (e.g., secondary base station) may read and identify a message or configuration information included in the indication message, and may generate an indication acknowledge message as a response message to the indication message, so as to transmit the indication acknowledge message 1-25 to the master base station. The indication acknowledge message may include at least one piece of the following information.
Identifier having the same value as that of the identifier included in the indication message
Indicator or identifier indicating that the indication message has been successfully received
Response indicator indicating that the indication message has been successfully applied

The signaling proposed in the disclosure may have procedures combined to each other and modified, so as to be extended to new signaling. For example, in the case that the master base station receives the l-05 message from the UE above, after inquiring or requesting the secondary base station as illustrated in l-20 or k-10 in FIG. 11, a response message is received in response to the inquiry or request as in 1-25 or k-15 in FIG. 11, and then, an RRC message corresponding to l-10 is configured according to the response message and transmitted to the UE, and the UE may configure a cell group according to the indication of the RRC message and transmit the l-15 message to the master base station in response thereto.

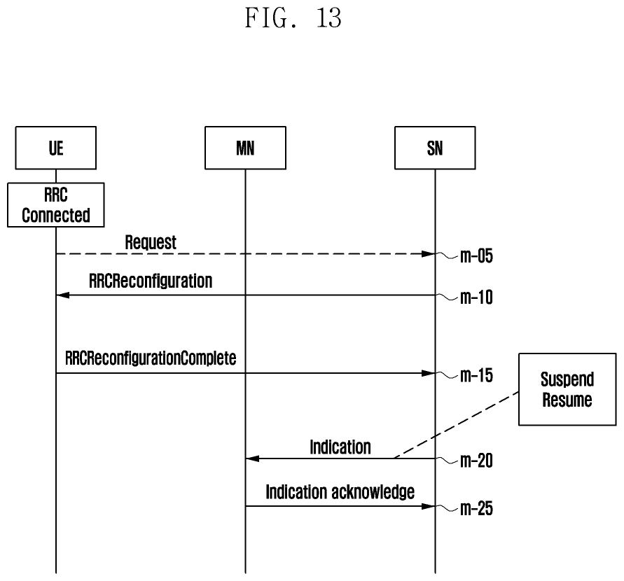

FIG. 13 is a diagram illustrating a third signaling procedure of configuring or releasing dual connectivity, or configuring, releasing, activating, resuming, suspending, or deactivating a secondary cell group for which dual connectivity is configured according to an embodiment of the disclosure.

Referring to FIG. 13, a UE may establish an RRC connection with a network or a base station as in FIG. 6 of the disclosure, and may transmit data to or receive data from the base station (e.g., master cell group (MCG), master node (MN), or cells (PCell or SCell) of the master cell group).

Referring to FIG. 13, according to configuration procedures in FIG. 6, the base station may configure, for the UE, an SRB (e.g., SRB3) enabling direct transmission or reception of a control message or an RRC message between the UE and a secondary base station.

The base station (e.g., secondary base station or master base station) may configure dual connectivity for the UE according to a predetermined reason (e.g., a case where a high data transmission rate is required, in response to a request m-05 from the UE or a case where high QoS requirements should be satisfied). For example, the UE may transmit, to the base station, a request for configuring or clearing, activating or deactivating, or resuming or suspending dual connectivity, a cell group (e.g., secondary cell), or a cell, or may transmit a request to the secondary base station via SRB3. The message for requesting may include a frequency (or channel) measurement result report, a cell group identifier, cell identifiers, or measurement results, m-05. As another method, the secondary base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell.

The secondary base station (master node (MN) or master cell group (MCG)) may receive a frequency or channel measurement report for each frequency or channel received from the UE, and may determine whether to configure, clear, add, deactivate, activate, resume, change, reconfigure, or suspend dual connectivity, a cell group (secondary cell group), or a cell based on the measurement report. Alternatively, the secondary base station may determine, by considering a downlink (or uplink) data amount or a buffer amount, whether the base station is to configure, clear, add, deactivate, activate, resume, change, reconfigure, or suspend dual connectivity, a cell group (e.g., secondary cell group), or a cell.

The secondary base station may transmit a first RRC message to the UE via SRB3 in order to configure, clear, add, deactivate, activate, resume, change, reconfigure, or suspend dual connectivity, a cell group (secondary cell group), or a cell, m-10. For the first RRC message, each separate new request message may be defined and used to perform indication to configure, clear, add, deactivate, activate, resume, change, reconfigure, or suspend dual connectivity, a cell group (secondary cell group), or a cell for the UE, and alternatively, a new indicator may be defined from an existing message (e.g., RRCReconfiguration message or RRCResume message) so as to indicate (or request) to configure, clear, add, deactivate, activate, resume, change, reconfigure, or suspend a cell group (e.g., secondary cell group), or a cell. The first RRC message may include some of the following information.
First RRC message identifier for distinguishing the first RRC message (e.g., rrc-Transaction identifier) The UE and the base station (e.g., secondary base station) transmit or receive a plurality of RRC messages to or from each other, and identifiers for distinguishing the respective RRC messages may be thus included in the RRC messages. For example, an RRC message (e.g., RRCReconfiguration message) transmitted by a transmission end, an RRC message (e.g., RRCReconfigurationComplete message m-15) corresponding to the RRC message (e.g., RRCReconfiguration message) transmitted by a reception end, or an RRC message corresponding to the RRC message transmitted by the transmission end may include the same first RRC message identifier.
Indicator or configuration information (e.g., indicator or configuration information for the UE) for configuring, clearing, adding, deactivating, activating, resuming, changing, reconfiguring, or suspending dual connectivity, a cell group (secondary cell group), or a cell
Indicator indicating a cell group state (e.g., activation, deactivation, suspension, or resumption)
Cell group identifier for distinguishing cell groups. The cell group identifier may be assigned by a master base station, or one identifier among previously agreed identifiers may be assigned by the secondary base station.
Cell group or cell configuration information
Bearer configuration information For example, indicator information indicating an operation of a protocol layer (e.g., SDAP layer, PDCP layer, RLC layer, or MAC layer) of each bearer (e.g., PDCP suspension indicator, PDCP re-establishment indicator, PDCP data recovery indicator, RLC re-establishment indicator, MAC partial reset indicator, MAC reset indicator, or indicator triggering a new operation)
In the case that an indicator or configuration information for configuring, adding, activating, resuming, changing, or reconfiguring dual connectivity, a cell group (secondary cell group), or a cell is included, a first indicator (e.g., mobilityControlInfor or ReconfigurationWithSync) may be included together. However, in that case that an indicator or configuration information for clearing, deactivating, reconfiguring, or suspending dual connectivity, a cell group (secondary cell group), or a cell is included, the first indicator (e.g., mobilityControlInfor or ReconfigurationWithSync) may not be included. The first indicator may be an indicator triggering random access to the cell group or cell, an indicator for synchronizing a signal with a new cell, an indicator indicating frequency shifting of the UE, or an indicator indicating changing of a cell group (or cell). As another method, the UE may perform PDCCH monitoring in the indicated or configured cell group or cell, and may trigger and perform random access as indicated in PDCCH. For example, an upper layer (e.g., RRC layer) may transmit, to a lower layer (e.g., MAC layer), an indicator triggering random access.
In the case that the indicator or configuration information for configuring, adding, activating, resuming, changing, or reconfiguring dual connectivity, a cell group (secondary cell group), or a cell is included, random access configuration information may be included together. However, if the indicator or configuration information for clearing, deactivating, reconfiguring, or suspending dual connectivity, a cell group (secondary cell group), or a cell is included, the random access configuration information may not be included. The random access configuration information may include random access transmission resource information (time or frequency transmission resource), designated preamble information, or the like for preamble transmission for the cell group or cell.
Time information indicating when to activate, resume, deactivate, or suspend dual connectivity, a cell group (e.g., secondary cell group), or a cell (PSCell or SCG SCell) (e.g., information indicating timing (e.g., X time unit, subframe unit, time slot unit, or symbol unit), e.g., time information indicating, if the message is received in an nth time unit, whether to activate, resume, deactivate, or suspend the cell in an (n+X)th time unit)
First channel measurement configuration information for each cell or each bandwidth part
Second channel measurement configuration information for each cell or each bandwidth part
Indicator indicating adding of cell group configuration or changing of a cell group (ReconfigurationWithSync) or indicator indicating random access (ReconfigurationWithSync or a newly defined indicator)
Indicator indicating, when activating a cell group, whether to activate a cell group by performing random access or activate a cell group without random access (ReconfigurationWithSync or a newly defined indicator)
Radio resource management (RRM) configuration information, frequency measurement configuration information or separate radio resource management (RRM) configuration information or frequency measurement configuration information to be applied or performed when deactivating a cell group (e.g., simplified frequency measurement configuration information for reducing battery consumption (Reduced or Relaxed RRM configuration information))
Configuration information for radio link monitoring (RLM) or configuration information for RLM to be applied or performed when deactivating a cell group. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource). In addition, the configuration information may include bandwidth part configuration information indicating in which bandwidth part the RLM procedure is to be performed (e.g., it may be indicated as a bandwidth part identifier). As another method, when the cell group state is deactivated, the UE performs the RLM procedure in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the RLM procedure in the last (or previously) activated bandwidth part before the cell group state becomes deactivated so that the connection state with the cell group may be maintained continuously (e.g., a case where bandwidth part configuration information indicating in which bandwidth part the RLM procedure is to be performed is not configured). Alternatively, when activating the cell group, the UE may perform an activation procedure in the first active bandwidth part (or the first active downlink bandwidth part, firstActiveDownlinkBWP-ID) configured in the RRC message. When the cell group is activated, in the case that the bandwidth part related configuration information indicating in which bandwidth part the RLM procedure is to be performed is not configured, the UE may perform the RLM procedure in the last (or previously) activated bandwidth part. In addition, the configuration information may include beam-related configuration information indicating in which beam the RLM procedure is to be performed (e.g., it can be indicated as a bandwidth part identifier, TCI state or QCL configuration information). As another method, when the cell group state is deactivated, the UE performs the RLM procedure in the beam (e.g., TCI state or QCL configuration information) configured in the RRC message or activates the beam and performs the RLM procedure, monitors a beam that should be activated when activating the cell group early, so that cell group activation delay can be minimized. As another method, in the case that the cell group state is configured to a deactivated state (or activated state), the UE performs the RLM procedure in the last (or previously) activated beam before the cell group state becomes deactivated, so that the connection state with the cell group can be continuously maintained (e.g., a case where beam-related configuration information indicating in which beam the RLM procedure is performed is not configured). When activating the cell group, in the case that the beam-related configuration information indicating in which beam the RLM procedure is performed is not configured, the UE may perform the RLM procedure in the last (or previously) activated beam.
Configuration information for a beam failure detection or beam failure detection (BFD) or configuration information for BFD to be applied or performed when a cell group is deactivated. For example, it is the configuration information of beams in units of cells to be measured by the UE or configuration information of beams for each bandwidth part when a cell group is deactivated, and may include beam-related configuration information (transmission configuration indication (TCI) state or quasi co-location (QCL)), or may include a timing advance (TA) value (or offset value) for synchronizing the downlink signal of the base station or the uplink signal of the base station, a timer (time alignment timer (TAT)) or timer value (TAT value) that indicates the validity of the TA value, configuration information of a synchronization signal block (SSB), which is a subject to be measured, or may include channel state information reference signal (CSI-RS) configuration information, reference signal (RS) configuration information, transmission resource information capable of reporting results in case of beam failure (e.g., PUCCH configuration information (e.g., scheduling request (SR) information or specific transmission resource), frequency transmission resource or time transmission resource. In addition, the configuration information may include bandwidth part configuration information indicating in which bandwidth part the beam failure detection is to be performed (e.g., it may be indicated as a bandwidth part identifier). As another method, when the cell group state is deactivated, the UE performs the beam failure detection in the first active bandwidth part (or first active downlink bandwidth part, firstActiveDownlinkBWP-ID) configured in the RRC message, so that the UE can monitor the first active bandwidth part that should be activated when activating the cell group early, thereby minimizing cell group activation delay. As another method, in the case that the cell group state is configured to a deactivated state (or activated state), the UE performs the beam failure detection in the last (or previously) activated bandwidth part before the cell group state becomes deactivated so that the connection state with the cell group may be maintained continuously (e.g., a case where bandwidth part configuration information indicating in which bandwidth part the beam failure detection is to be performed is not configured). Alternatively, when activating the cell group, the UE may perform an activation procedure in the first active bandwidth part (or the first active downlink bandwidth part, firstActiveDownlinkBWP-ID) configured in the RRC message. If the cell group is activated, in the case that the bandwidth part related configuration information indicating in which bandwidth part the beam failure detection is to be performed is not configured, the UE may perform the beam failure detection in the last (or previously) activated bandwidth part. In addition, the configuration information may include beam-related configuration information indicating in which beam the beam failure detection is to be performed (e.g., it can be indicated as a bandwidth part identifier, TCI state or QCL configuration information). As another method, when the cell group state is deactivated, the UE performs the beam failure detection in the beam (e.g., TCI state or QCL configuration information) configured in the RRC message, monitors a beam that should be activated when activating the cell group early, so that cell group activation delay can be minimized. As another method, in the case that the cell group state is configured to a deactivated state (or activated state), the UE performs the beam failure detection in the last (or previously) activated beam before the cell group state becomes deactivated, so that the connection state with the cell group can be continuously maintained (e.g., a case where beam-related configuration information indicating in which beam the beam failure detection is performed is not configured), or when activating the cell group, the UE may perform an activation procedure in the beam configured in the RRC message. When activating the cell group, in the case that the beam-related configuration information indicating in which beam the beam failure detection is performed is not configured, the UE may perform the beam failure detection in the last (or previously) activated beam.

In the case that the first RRC message m-10 is received via SRB3, the UE may read and identify the first RRC message, and the UE may configure, add, change, resume, suspend, or deactivate dual connectivity or a cell group (e.g., secondary cell group). In addition, if the first indicator triggering random access is included in the first RRC message, random access may be triggered for the configured or indicated cell group or cell. When random access is performed, if there is random access information in the RRC message, or if there is random access information that has been stored, random access (e.g., contention-free random access (e.g., 4-step random access or 2-step random access)) may be performed based on system information or the random access information that has been stored or received via the RRC message. If there is no random access information in the RRC message, random access (e.g., contention-based random access (e.g., 4-step random access or 2-step random access)) may be performed. As another method, the UE may perform PDCCH monitoring in the indicated or configured cell group or cell, and may trigger and perform random access as indicated in PDCCH. For example, an upper layer (e.g., RRC layer) may transmit, to a lower layer (e.g., MAC layer), an indicator triggering random access.

In the above, the UE may receive the first RRC message m-10 or apply received configuration information, and may generate a second RRC message so as to transmit the second RRC message to the secondary base station via SRB3. The second RRC message may include some of the following information.
First RRC message identifier having the same value as that of the first RRC message identifier included in the first RRC message
Indicator or identifier indicating that the first RRC message has been successfully received

When the base station (e.g., secondary base station) receives the second RRC message, the base station may determine, via a first identifier, whether the received message is a response message to the first RRC message. The base station may identify the first RRC message, and may transmit an indication message which includes an indication that a cell group has been configured, added, cleared, activated, resumed, suspended, or deactivated for the master base station or a master cell group base station, to the master base station via an Xn interface (e.g., interface between base stations) or an Sn interface (e.g., interface between base stations or a base station and AMF or UMF), m-20. The indication message may include some of the following information.
Identifier capable of distinguishing the indication message
Indicator or configuration information (e.g., indicator or configuration information for the secondary cell group) for configuring, clearing, adding, deactivating, activating, resuming, changing, reconfiguring, or suspending dual connectivity, a cell group (secondary cell group), or a cell

When the indication message is received, the base station (e.g., master base station) may read, obtain and identify a message or configuration information included in the indication message, and may generate an indication acknowledge message as a response message to the indication message, so as to transmit the indication acknowledge message to the secondary base station, m-25. The indication acknowledge message may include at least one piece of the following information.
Identifier having the same value as that of the indicator included in the indication message
Indicator or identifier indicating that the indication message has been successfully received
Response indicator indicating that the indication message has been successfully applied

When, as proposed in the disclosure, a message is transmitted to the UE in order to configure or indicate a cell group or cell configuration information to the UE, for example, if the message includes an indicator or configuration information for configuring, adding, activating, resuming, changing, or reconfiguring dual connectivity, a cell group (e.g., secondary cell group), or a cell, SDAP configuration information may be included or reconfigured, or mapping configuration information of a QoS flow and a bearer of an SDAP layer may be included, configured or reconfigured. However, in the case that an indicator or configuration information for clearing, deactivating, reconfiguring, or suspending dual connectivity, a cell group (e.g., secondary cell group), or a cell is included, the SDAP configuration information may be neither included nor reconfigured, the mapping configuration information of the QoS flow and the bearer of the SDAP layer may be neither included, configured, nor reconfigured, or application of the mapping configuration information may be suspended.

The signaling proposed in the disclosure may have procedures combined to each other and modified, so as to be extended to new signaling.

The signaling proposed in the disclosure may be extended to multi-connectivity. For example, configuration information of a plurality of cell groups may be configured for the UE via an RRC message, one or more cell groups (or cells) among the configured plurality of cell groups may be activated or resumed via an indicator of PDCCU, MAC control information, or an RRC message, or one or more cell groups may be suspended or deactivated.

Hereinafter, when, as proposed in the disclosure, dual connectivity, a cell group (e.g., secondary cell group), or a cell (PSCell or SCG SCell) is activated, resumed, added, deactivated, cleared, or suspended, a UE operation for each cell (PSCell or SCG SCell) or a UE operation for each protocol layer (e.g., SDAP layer, PDCP layer, RLC layer, MAC layer, or PHY layer) may be proposed.
1> If the UE receives an identifier (e.g., via DCI of PDCCH, MAC control information, or RRC message) or configuration information for configuring, adding, activating, or resuming, changing, or reconfiguring dual connectivity, a cell group (e.g., secondary cell group), or a cell, or if the previous state of the cell group was the deactivated state, or if the UE is in a connected mode, the UE may perform some of the following procedures.
   ▪2> An upper layer (e.g., RRC layer) may indicate the configuration information or indicator to a lower layer (e.g., PDCP layer, RLC layer, MAC layer, or PHY layer).
   ▪2> UE operation for PSCell: When an indicator or configuration information is received, the UE may maintain a PSCell active, may activate a downlink bandwidth part of the PSCell to a normal bandwidth part (e.g., first active bandwidth part, or bandwidth part other than a dormant bandwidth part) configured via the RRC message, or a last activated bandwidth part, and may perform a UE operation of the activated bandwidth part. As another method, when an indicator or configuration information is received, the UE may maintain a PSCell active, may reconfigure or switch a DRX configuration cycle or a PDCCH monitoring cycle of the PSCell to a short cycle based on first DRX configuration information, and may perform PDCCH monitoring and a UE operation of the active cell. In this way, the UE operation for the PSCell may be performed to enable reception of a scheduling indication from a cell group or a cell, and a quick start of data transmission or reception. In order to receive a scheduling indication from a cell group or cell, and to start data transmission or reception more quickly, the UE may measure many or frequent channel signals based on first channel measurement configuration information configured via the RRC message, and may perform quick channel measurement reporting, for example, report a measurement result to the base station. When a predetermined condition is satisfied, the UE may measure a channel signal again based on second channel measurement configuration information and may report a measurement result to the UE.
   ▪2> UE operation for SCell of secondary cell group: When an indicator or configuration information is received, the UE may activate an SCell of a secondary cell group, may activate a downlink bandwidth part or an uplink bandwidth part to a bandwidth part (e.g., first active bandwidth part) configured via the RRC message, and may perform a UE operation of the activated SCell or bandwidth part. As another method, when an indicator or configuration information is received, in the case that a dormant bandwidth part is configured for an SCell of the secondary cell group, the UE may maintain the SCell active, may activate a downlink bandwidth part of the SCell to a bandwidth part (e.g., first active bandwidth part) configured via the RRC message, and may perform a UE operation of the activated bandwidth part. In the case that a dormant bandwidth part is not configured for the SCell of the secondary cell group, the UE may switch the SCell to an active state, may activate the downlink bandwidth part or uplink bandwidth part to a bandwidth part (e.g., first active bandwidth part) configured via the RRC message, and may perform a UE operation of the activated SCell or bandwidth part. As another method, when an indicator or configuration information is received, the UE may determine, according to an indicator or SCell configuration information configured in the message including the indicator or configuration information, switching, activation, or deactivation of a bandwidth part or a state of the SCell, and may perform a UE operation.
   ▪2> UE operation of MAC layer for secondary cell group: When an indicator or configuration information is received, the UE may perform resetting for a MAC layer (MAC reset) (e.g., the UE may reset or clear configuration information configured for the MAC layer, may suspend or reset configured timers, or may suspend or reset an HARQ procedure). For example, a timing advance timer (TAT) indicating validity of signal synchronization between the UE and the base station may be considered to be suspended or expired. As another method, when an indicator or configuration information is received, the UE may perform MAC partial reset (alternatively, when the message including the indicator or configuration information includes an indicator indicating MAC partial reset, the MAC partial reset may be performed). For example, the timing advance timer (TAT) indicating validity of signal synchronization between the UE and the base station may be continuously maintained, or HARQ retransmission that has been performed may be continued. As another method, the current configuration may be maintained without performing any procedure for the MAC layer. If an indication of triggering random access is indicated from an upper layer (e.g., RRC layer), or if the TAT is suspended or has expired, the UE may trigger random access. Alternatively, if the TAT has not been suspended or has not expired, random access may not be triggered or performed. This is because, if the TAT is running, synchronization between the secondary cell group and a signal is made or maintained, and thus unnecessary random access is performed. As another method, in the case that the base station triggers the random access with the indication of the PDCCH, the UE may trigger the random access, configure or adjust a timing advance (TA) value, or start a TA timer. After the random access is completed, the secondary cell group can be resumed or activated and data transmission or reception can be resumed. In the above, the random access may perform a contention based random access (CBRA). As another method, when the random access is performed, if dedicated random access configuration information (dedicated RACH config or dedicated preamble) is configured (or included) in the message (or previously received message) indicating activation or resumption of the cell group, the UE may perform the contention free random access (CFRA). Alternatively, if the dedicated random access configuration information (dedicated RACH config or dedicated preamble) is not configured (or included) in the message (or previously received message) indicating activation or resumption of the cell group, the UE may perform the contention based random access (CBRA) or may not perform the random access. In the above, in the case that the UE is configured (or indicated) to activate the cell group (e.g., secondary cell group) (or if the state of the cell group is not configured to the deactivated state in the above), the UE may reset the MAC layer (MAC reset). In the above, the MAC layer reset (MAC reset) is performed after the UE determines whether or not to perform the random access, or after triggering the random access, or when the random access is successfully completed (or after completion of random access), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (for example, the cell group can be activated without the random access only when the TAT timer is running) As another method, the partial MAC layer reset may be performed instead of the above MAC layer reset. As proposed above, if the MAC layer is reset or is not partially reset, the data stored in the downlink buffer of the UE is not flushed, so that an error may occur in soft combining when receiving data later (e.g., in the case of activating the cell group, the error may occur afterwards), or the data in the uplink buffer (e.g., message 3 buffer or message A buffer) may not be flushed and thus old data may be transmitted when transmitting the data later (e.g., when the cell group is activated or thereafter), so that an error may occur.
   ▪2> Operation for data radio bearer (DRB) configured for secondary cell group: When an indicator or configuration information is received, the UE may resume DRBs (or SN (SCG) terminated DRB, DRB in which a PDCP layer is configured for the SCG, a bearer using RLC UM mode, or a bearer using RLC AM mode) included in the secondary cell group. For example, for a split bearer (a bearer in which one RLC layer is configured for the master cell group, and another RLC layer is configured for the secondary cell group) in which the PDCP layer is configured for the master cell group, the RRC message including the configuration information or indicator may include an indicator (reestablishRLC) triggering re-establishment of the RLC layer configured for the secondary cell group, or the UE may perform re-establishment for the RLC layer configured for the secondary cell group. For example, for a split bearer (a bearer in which one RLC layer is configured for the master cell group, and another RLC layer is configured for the secondary cell group) in which the PDCP layer is configured for the secondary cell group, the RRC message including the configuration information or indicator may include an indicator (reestablishRLC) triggering re-establishment of the RLC layer configured for the master cell group, an indicator triggering PDCP re-establishment (reestablishPDCP) or PDCP resumption (PDCP resume) in the PDCP layer configured for the secondary cell group may be included together, or the UE may perform re-establishment for the RLC layer configured for the master cell group, or may perform PDCP re-establishment or PDCP resumption (PDCP resume) in the PDCP layer configured for the secondary cell group. For example, with respect to bearers configured for the secondary cell group, the bearers may be resumed, the RRC layer may indicate, to the PDCP layer, triggering of PDCP re-establishment or PDCP resumption, or PDCP re-establishment or PDCP resumption (PDCP resume) may be performed in the PDCP layer. The UE may trigger first PDCP resumption for the bearers configured for the secondary cell group (or bearers using RLC UM mode or bearers using RLC AM mode), or may perform the first PDCP resumption in the PDCP layer. As another method, in order to solve a security issue caused by transmission of different data with the same security key when the secondary cell group is activated or resumed, the UE may trigger second PDCP resumption for the bearers configured for the secondary cell group (or bearers using RLC UM mode or bearers using RLC AM mode), or may perform the second PDCP resumption in the PDCP layer. As another method, in the case that PDCP layer resumption is triggered in an upper layer, the first PDCP resumption may be triggered and performed, and in the case that the upper layer triggers the PDCP layer resumption or indicates an indicator for activation or resumption of a cell group (or cell), second PDCP resumption may be triggered and performed. As another method, in order to solve a security issue caused by transmission of different data with the same security key, in the case that an indicator for activation or resumption of a cell group (or cell) is indicated, the base station may configure a network security key by adding security key configuration information (e.g., sk-counter) to the RRC message including the indicator for activation or resumption of the cell group (or cell) and may enable a change or update of the security key, the RRC message includes a PDCP re-establishment indicator to enable a change or update of the security key of the bearers configured for the secondary cell group (or bearers using RLC UM mode or bearers using RLC AM mode), or the UE may perform PDCP re-establishment for the bearers. As another method, in the case that the security configuration information is included in the message including an indication to resume or activate the cell group in the above, or in the case that the security configuration information change (or update) is indicated, or an indicator indicating first PDCP layer resumption is included, the UE may trigger the first PDCP resumption or perform the first PDCP resumption in the PDCP layer for the bearers configured for the secondary cell group (or bearers using RLC UM mode or bearers using RLC AM mode). However, in the case that the security configuration information is not included in the message including an indication to resume or activate the cell group in the above, or in the case that the security configuration information change (or update) is not indicated, or an indicator indicating second PDCP layer resumption is included, in order to solve a security issue caused by transmission of different data with the same security key when the secondary cell group is activated or resumed, the UE may trigger the second PDCP resumption or perform the second PDCP resumption in the PDCP layer for the bearers configured for the secondary cell group (or bearers using RLC UM mode or bearers using RLC AM mode). The above proposed methods may be performed when the UE receives the message including the indication indicating the suspension or deactivation of the cell group. Alternatively, the above proposed methods may be applied to the SCG bearers (bearers in which the PDCP layer is configured for the SCG or SCG terminated bearer).
   ▪2> Operation for signaling radio bearer (SRB) configured for secondary cell group: When an indicator or configuration information is received, and a PSCell is activated, or if an activated downlink bandwidth part of the PSCell is a normal bandwidth part other than a dormant bandwidth part, or the activated PSCell performs PDCCH monitoring in a long cycle based on first DRX configuration information, the UE may continuously maintain SRBs (or SN (SCG) terminated SRB, or SRB or SRB3 in which a PDCP layer is configured in SCG) included in the secondary cell group (e.g., the UE may continuously transmit or receive a control message to or from the secondary base station). Alternatively, data discard (e.g., RLC re-establishment or discard indication to the PDCP layer) may be performed to discard old data (e.g., PDCP SDU or PDCP PDU) stored in SRBs configured for the secondary cell group. As another method, when an indicator or configuration information is received, the UE may resume SRBs (or SN (SCG) terminated SRB, or SRB or SRB3 in which a PDCP layer is configured in SCG) included in the secondary cell group. Alternatively, data discard (e.g., RLC re-establishment or discard indication to the PDCP layer) may be performed to discard old data (e.g., PDCP SDU or PDCP PDU) stored in SRBs configured for the secondary cell group. For example, for a split bearer (a bearer in which one RLC layer is configured for the master cell group, and another RLC layer is configured for the secondary cell group) in which the PDCP layer is configured for the master cell group, the RRC message including the configuration information or indicator may include an indicator (reestablishRLC) triggering re-establishment of the RLC layer configured for the secondary cell group, or the UE may perform re-establishment for the RLC layer configured for the secondary cell group. For example, for a split bearer (a bearer in which one RLC layer is configured for the master cell group, and another RLC layer is configured for the secondary cell group) in which the PDCP layer is configured for the secondary cell group, the RRC message including the configuration information or indicator may include an indicator (reestablishRLC) triggering re-establishment of the RLC layer configured for the master cell group, an indicator triggering PDCP re-establishment (reestablishPDCP) or PDCP resumption (PDCP resume) in the PDCP layer configured for the secondary cell group may be included together, or the UE may perform re-establishment for the RLC layer configured for the master cell group, or may perform PDCP re-establishment or PDCP resumption (PDCP resume) in the PDCP layer configured for the secondary cell group. For example, with respect to bearers configured for the secondary cell group, the bearers may be resumed, the RRC layer may indicate, to the PDCP layer, triggering of PDCP re-establishment or PDCP resumption, or PDCP re-establishment or PDCP resumption (PDCP resume) may be performed in the PDCP layer. In the above, the UE may trigger first PDCP resumption for the bearers configured for the secondary cell group, or may perform the first PDCP resumption in the PDCP layer. As another method, in order to solve a security issue problem caused by transmission of different data with the same security key when the secondary cell group is activated or resumed, the UE may trigger second PDCP resumption for the bearers configured for the secondary cell group, or may perform the second PDCP resumption in the PDCP layer. As another method, in the case that PDCP layer resumption is triggered in an upper layer, the first PDCP resumption may be triggered and performed, and in the case that the upper layer triggers the PDCP layer resumption or indicates an indicator for activation or resumption of a cell group (or cell), second PDCP resumption may be triggered and performed. As another method, in order to solve a security issue caused by transmission of different data with the same security key, in the case that an indicator for activation or resumption of a cell group (or cell) is indicated, the base station may configure a new security key by adding security key configuration information (e.g., sk-counter) to the RRC message including the indicator for activation or resumption of the cell group (or cell) and may enable a change or update of the security key, the RRC message includes a PDCP re-establishment indicator to enable a change or update of the security key of the bearers configured for the secondary cell group, or the UE may perform PDCP re-establishment for the bearers. As another embodiment, in the case that the security configuration information is included in the message including an indication to resume or activate the cell group in the above, or in the case that the security configuration information change (or update) is indicated, or an indicator indicating first PDCP layer resumption is included, the UE may trigger the first PDCP resumption or perform the first PDCP resumption in the PDCP layer for the bearers configured for the secondary cell group. However, in the case that the security configuration information is not included in the message including an indication to resume or activate the cell group in the above, or in the case that the security configuration information change (or update) is not indicated, or an indicator indicating second PDCP layer resumption is included, in order to solve a security issue caused by transmission of different data with the same security key when the secondary cell group is activated or resumed, the UE may trigger the second PDCP resumption or perform the second PDCP resumption in the PDCP layer for the bearers configured for the secondary cell group in order to solve the security issue problem that occurs. The above proposed methods may be performed when the UE receives the message including the indication indicating the suspension or deactivation of the cell group. Alternatively, the above proposed methods may be applied to the SCG bearers (bearers in which the PDCP layer is configured for the SCG or SCG terminated bearer).
   ▪2> UE operation for PUCCH SCell of secondary cell group: When an indicator or configuration information is received, the UE may activate a PUCCH SCell of a secondary cell group, may activate a downlink bandwidth part or an uplink bandwidth part to a bandwidth part (e.g., first active bandwidth part) configured via the RRC message, and may perform a UE operation of the activated SCell or bandwidth part. As another method, when an indicator or configuration information is received, in the case that a dormant bandwidth part is configured for a PUCCH SCell of the secondary cell group, the UE may maintain the SCell active, may activate a downlink bandwidth part of the SCell to a bandwidth part (e.g., first active bandwidth part) configured via the RRC message, and may perform a UE operation of the activated bandwidth part, or in the case that a dormant bandwidth part is not configured for the SCell of the secondary cell group, the UE may switch the SCell to an active state, may activate the downlink bandwidth part or uplink bandwidth part to a bandwidth part (e.g., first active bandwidth part) configured via the RRC message, and may perform the UE operation of the activated SCell or bandwidth part. As another method, when an indicator or configuration information is received, the UE may determine, according to an indicator or SCell configuration information configured in the message including the indicator or configuration information, switching, activation, or deactivation of a bandwidth part or a state of the SCell, and may perform a UE operation. As another method, when an indicator or configuration information is received, the UE may apply the first DRX configuration information (e.g., suspending second DRX configuration information and performing reconfiguration to the first DRX configuration information) configured via the RRC message for the PUCCH SCell, and if PDCCH monitoring can be performed, a UE operation in the activated SCell may be performed.
   ▪2> In the above, the UE may transmit an indicator indicating that configuration, addition, activation, resumption, change or reconfiguration of the cell group (e.g., secondary cell group) or cell is performed to the master cell group or the secondary cell group, and the UE may transmit the indicator to the secondary cell group (or base station) or the master cell group (or base station) via a physical signal (e.g., HARQ ACK, NACK or a new transmission resource), MAC control information or an RRC message.
   ▪2> If the UE receives an indicator to resume, activate, or add the cell group (e.g., secondary cell group) or cell in the above, or if the previous state of the cell group was the deactivated state or if the UE is in a connected mode, for the configured SCG bearers, bearers connected to the SCG RLC layer, SCG split bearers, MCG bearers or MCG split bearers, the UE may trigger PDCP state reporting in the PDCP layer and report the PDCP state to the base station. This is because, by transmitting the PDCP state report, it is possible to identify lost data or states of window variables between the UE and the base station, so that transmission windows or reception windows can be synchronized.
1> If the UE receives an identifier (e.g., via DCI of PDCCH, MAC control information, or RRC message) or configuration information for clearing, deactivating, reconfiguring, or suspending dual connectivity, a cell group (e.g., secondary cell group), or a cell, or if the previous state of the cell group was the activated state, or if the UE is in a connected mode, the UE may perform some of the following procedures.
   ▪2> An upper layer (e.g., RRC layer) may indicate the configuration information or indicator to a lower layer (e.g., PDCP layer, RLC layer, MAC layer, or PHY layer).
   ▪2> UE operation for PSCell: In the above, when an indicator or configuration information is received, the UE may maintain a PSCell active, may activate a downlink bandwidth part of the PSCell to a dormant bandwidth part configured via the RRC message, and may perform a UE operation in the dormant bandwidth part. As another method, in the above, when an indicator or configuration information is received, the UE may maintain a PSCell active, may reconfigure or switch a DRX configuration cycle or a PDCCH monitoring cycle of the PSCell to a very long cycle based on the second DRX configuration information, and may perform PDCCH monitoring and a UE operation of the active cell. As another method, in the above, when an indicator or configuration information is received, the UE may deactivate a PSCell and may perform a UE operation of the deactivated cell. In this way, by performing a UE operation for the PSCell, power consumption of the UE may be reduced.
   ▪2> UE operation for SCell of secondary cell group: In the above, when an indicator or configuration information is received, the UE may deactivate an SCell of the secondary cell group and may perform a UE operation of the deactivated SCell. As another method, in the above, when an indicator or configuration information is received, in the case that a dormant bandwidth part is configured for the SCell of the secondary cell group, the UE may maintain the SCell active, may activate a downlink bandwidth part of the SCell to a dormant bandwidth part, and may perform a UE operation in the dormant bandwidth part, or in the case that no dormant bandwidth part is configured for the SCell of the secondary cell group, the UE may switch the SCell to a deactivated state, and may perform a UE operation in the deactivated cell or bandwidth part. As another method, in the above, when an indicator or configuration information is received, the UE may determine, according to an indicator or SCell configuration information configured in the message including the indicator or configuration information, switching, activation, or deactivation of a bandwidth part or a state of the SCell, and may perform a UE operation.
   ▪2> UE operation of MAC layer for secondary cell group: When an indicator or configuration information is received, the UE may perform resetting for a MAC layer (MAC reset) (e.g., the UE may reset or clear configuration information configured for the MAC layer, may suspend or reset configured timers, or may suspend or reset an HARQ procedure). For example, a TAT indicating validity of signal synchronization between the UE and the base station may be considered to be suspended or expired. As another method, in order to prevent data loss due to the reset of the MAC layer reset, when an indicator or configuration information is received, the UE may perform MAC partial reset (alternatively, in the case that the message including the indicator or configuration information includes an indicator indicating MAC partial reset, the MAC partial reset may be performed). For example, the TAT indicating validity of signal synchronization between the UE and the base station may be continuously maintained, or HARQ retransmission that has been performed may be continued. As another method, the current configuration may be maintained without performing any procedure for the MAC layer. In the above, in the case that the TAT timer is continuously maintained, if the TAT timer expires, the UE may perform the random access to adjust or configure timing advance (TA) again even in the case that the secondary cell group is suspended or deactivated. In the above, when performing the random access, the UE may indicate to the base station that it is the random access procedure for adjusting the TA with an indicator (e.g., the UE may transmit by including a buffer state report (MAC control information) and indicate that there is no data to be transmitted or may introduce a new indicator), or the base station may transmit a message including the indication indicating suspension or deactivation of the cell group to the UE again after the random access is completed, or the UE may maintain the cell group suspended or deactivated after the random access is completed (as another method, the UE may maintain the cell group suspended or deactivated without an indication from the base station). As another method, in the case that the TAT timer is continuously maintained, if the TAT timer expires, since the base station operates the same TAT timer, it may enable the UE to trigger the random access (for TA adjustment or reconfiguration) for the master cell group or the secondary cell group through the cell (PCell, SCell, or PSCell). Alternatively, the base station may transmit a message including an indicator indicating resumption or activation of the cell group to the UE. In the above, in the case that the cell group (e.g., secondary cell group) is configured (or indicated) to be activated (or if the state of the cell group is not configured to the deactivated state in the above), the UE may reset the MAC layer (MAC reset). In the above, the MAC layer reset (MAC reset) may be performed after the UE determines whether or not to perform the random access, or after triggering the random access, or when the random access is successfully completed (or after completion of random access), or when the cell group is activated without the random access, or when the cell group is successfully activated without the random access (e.g., successful reception of PDCCH or transmission resource reception). This is because when activating the cell group, if the MAC layer is reset first, the TAT timer associated with the cell group or PTAG (or PSCell) is considered to have expired, and thus, the UE may not perform the procedure for activating the cell group without the random access proposed in this disclosure (e.g., the cell group can be activated without the random access only when the TAT timer is running) As another method, the partial MAC layer reset may be performed instead of the above MAC layer reset. As proposed above, if the MAC layer is reset or is not partially reset, the data stored in the downlink buffer of the UE is not flushed, so that an error may occur in soft combining when receiving data later (e.g., in the case of activating the cell group, the error may occur afterwards), or the data in the uplink buffer (e.g., message 3 buffer or message A buffer) may not be flushed, and thus old data may be transmitted when transmitting the data later (e.g., when the cell group is activated or thereafter), so that an error may occur.
   ▪2> Operation for data radio bearer (DRB) configured for secondary cell group (or bearer using RLC UM mode or bearer using RLC AM mode) When an indicator or configuration information is received, the UE may suspend DRBs (or SN (SCG) terminated DRB, DRB in which a PDCP layer is configured for the SCG, or bearer using RLC UM mode, or bearer using RLC AM mode) included in the secondary cell group. For example, for a split bearer (a bearer in which one RLC layer is configured for the master cell group, and another RLC layer is configured for the secondary cell group) in which the PDCP layer is configured for the master cell group, the RRC message including the configuration information or indicator may include an indicator (reestablishRLC) triggering re-establishment of the RLC layer configured for the secondary cell group, an indicator triggering PDCP data recovery in the PDCP layer configured for the master cell group may be included together, or the UE may perform re-establishment for the RLC layer configured for the secondary cell group, or may perform PDCP data recovery in the PDCP layer configured for the master cell group. For example, for a split bearer (a bearer in which one RLC layer is configured for the master cell group, and another RLC layer is configured for the secondary cell group) in which the PDCP layer is configured for the secondary cell group, the RRC message including the configuration information or indicator may include an indicator (reestablishRLC) triggering re-establishment of the RLC layer configured for the master cell group, an indicator triggering PDCP re-establishment (reestablishPDCP) or triggering PDCP suspension (PDCP suspend) in the PDCP layer configured for the secondary cell group may be included together, or the UE may perform re-establishment for the RLC layer configured for the master cell group, or may perform PDCP re-establishment or PDCP suspension (PDCP suspend) in the PDCP layer configured for the secondary cell group. For example, with respect to bearers configured for the secondary cell group (or bearer using RLC UM mode or bearer using RLC AM mode), the bearers may be suspended, the RRC layer may indicate, to the PDCP layer, triggering of PDCP re-establishment or PDCP suspension, or PDCP re-establishment or PDCP suspension (PDCP suspend) may be performed in the PDCP layer. In the above, the UE may trigger first PDCP suspension for the bearers configured for the secondary cell group (or bearer using RLC UM mode or bearer using RLC AM mode), or may perform the first PDCP suspension in the PDCP layer. As another method, in order to solve a security issue caused by transmission of different data with the same security key when the secondary cell group is activated or resumed, the UE may trigger second PDCP suspension for the bearers configured for the secondary cell group (or bearer using RLC UM mode or bearer using RLC AM mode), or may perform second PDCP suspension in the PDCP layer. As another method, in the case that PDCP layer suspension is triggered in an upper layer, the first PDCP suspension may be triggered and performed, and in the case that the upper layer triggers the PDCP layer suspension or indicates an indicator for deactivation or suspension of a cell group (or cell), second PDCP suspension may be triggered and performed. As another method, in the case that the security configuration information is included in the message including an indication to suspend or deactivate the cell group in the above, or in the case that the security configuration information change (or update) is indicated, or an indicator indicating first PDCP layer suspension is included, the UE may trigger the first PDCP suspension or perform the first PDCP suspension in the PDCP layer for the bearers configured for the secondary cell group (or bearers using RLC UM mode or bearers using RLC AM mode). However, in the case that the security configuration information is not included in the message including an indication to suspend or deactivate the cell group in the above, or in the case that the security configuration information change (or update) is not indicated, or an indicator indicating second PDCP layer suspension is included, in order to solve a security issue caused by transmission of different data with the same security key when the secondary cell group is activated or resumed, the UE may trigger the second PDCP suspension or perform the second PDCP suspension in the PDCP layer for the bearers configured for the secondary cell group (or bearer using RLC UM mode or bearer using RLC AM mode). The above proposed methods may be performed when the UE receives the message including the indication indicating the resumption or activation of the cell group. Alternatively, the above proposed methods may be applied to the SCG bearers (bearers in which the PDCP layer is configured for the SCG or SCG terminated bearer).
   ▪2> Operation for signaling radio bearer (SRB) configured for secondary cell group: When an indicator or configuration information is received, and a PSCell is activated, or if an activated downlink bandwidth part of the PSCell is a normal bandwidth part other than a dormant bandwidth part, or the activated PSCell performs PDCCH monitoring in a long cycle based on second DRX configuration information, the UE may continuously maintain SRBs (or SN (SCG) terminated SRB, or SRB or SRB3 in which a PDCP layer is configured in SCG) included in the secondary cell group without suspension (e.g., the UE may continuously transmit or receive a control message to or from the secondary base station). Alternatively, data discard (e.g., RLC re-establishment or discard indication to the PDCP layer) may be performed to discard old data (e.g., PDCP SDU or PDCP PDU) stored in SRBs configured for the secondary cell group. As another method, when an indicator or configuration information is received, the UE may suspend SRBs (or SN (SCG) terminated SRB, or SRB or SRB3 in which a PDCP layer is configured in SCG) included in the secondary cell group. Alternatively, data discard (e.g., RLC re-establishment or discard indication to the PDCP layer) may be performed to discard old data (e.g., PDCP SDU or PDCP PDU) stored in SRBs configured for the secondary cell group. For example, for a split SRB bearer (a bearer in which one RLC layer is configured for the master cell group, and another RLC layer is configured for the secondary cell group) in which the PDCP layer is configured for the master cell group, the RRC message including the configuration information or indicator may include an indicator (reestablishRLC) triggering re-establishment of the RLC layer configured for the secondary cell group, an indicator triggering PDCP data recovery in the PDCP layer configured for the secondary cell group may be included together, or the UE may perform re-establishment for the RLC layer configured for the secondary cell group, or may perform PDCP data recovery in the PDCP layer configured for the master cell group. For example, for a split bearer (a bearer in which one RLC layer is configured for the master cell group, and another RLC layer is configured for the secondary cell group) in which the PDCP layer is configured for the secondary cell group, the RRC message including the configuration information or indicator may include an indicator (reestablishRLC) triggering re-establishment of the RLC layer configured for the master cell group, an indicator triggering PDCP re-establishment (reestablishPDCP) or PDCP suspension (PDCP suspend) in the PDCP layer configured for the secondary cell group may be included together, or the UE may perform re-establishment for the RLC layer configured for the master cell group, or may perform PDCP re-establishment or PDCP suspension (PDCP suspend) in the PDCP layer configured for the secondary cell group. For example, with respect to bearers configured for the secondary cell group, the bearers may be suspended, the RRC layer may indicate, to the PDCP layer, triggering of PDCP re-establishment or PDCP suspension, or PDCP re-establishment or PDCP suspension (PDCP suspend) may be performed in the PDCP layer. The UE may trigger first PDCP suspension for the bearers configured for the secondary cell group or may perform the first PDCP suspension in the PDCP layer. As another method, in order to solve a security issue caused by transmission of different data with the same security key when the secondary cell group is activated or resumed, the UE may trigger second PDCP suspension for the bearers configured for the secondary cell group, or may perform second PDCP suspension in the PDCP layer. As another method, in the case that PDCP layer suspension is triggered in an upper layer, the first PDCP suspension may be triggered and performed, and in the case that the upper layer triggers the PDCP layer suspension or indicates an indicator for deactivation or suspension of a cell group (or cell), second PDCP suspension may be triggered and performed. As another method, in the case that the security configuration information is included in the message including an indication to suspend or deactivate the cell group in the above, or in the case that the security configuration information change (or update) is indicated, or an indicator indicating first PDCP layer suspension is included, the UE may trigger the first PDCP suspension or perform the first PDCP suspension in the PDCP layer for the bearers configured for the secondary cell group. However, in the case that the security configuration information is not included in the message including an indication to suspend or deactivate the cell group in the above, or in the case that the security configuration information change (or update) is not indicated, or an indicator indicating second PDCP layer suspension is included, in order to solve a security issue caused by transmission of different data with the same security key when the secondary cell group is activated or resumed, the UE may trigger the second PDCP suspension or perform the second PDCP suspension in the PDCP layer for the bearers configured for the secondary cell group. The above proposed methods may be performed when the UE receives the message including the indication indicating the resumption or activation of the cell group. Alternatively, the above proposed methods may be applied to the SCG bearers (bearers in which the PDCP layer is configured for the SCG or SCG terminated bearer).
   ▪2> UE operation for PUCCH SCell of secondary cell group: When an indicator or configuration information is received, the UE may deactivate a PUCCH SCell of the secondary cell group and may perform a UE operation of the deactivated SCell. As another method, when an indicator or configuration information is received, in the case that a dormant bandwidth part is configured for the PUCCH SCell of the secondary cell group, the UE may maintain the SCell active, may activate a downlink bandwidth part of the SCell to a dormant bandwidth part, and may perform a UE operation in the dormant bandwidth part, or in the case that no dormant bandwidth part is configured for the PUCCH SCell of the secondary cell group, the UE may switch the SCell to a deactivated state, and may perform a UE operation in the deactivated cell or bandwidth part. As another method, when an indicator or configuration information is received, the UE may determine, according to an indicator or SCell configuration information configured in the message including the indicator or configuration information, switching, activation, or deactivation of a bandwidth part or a state of the SCell, and may perform a UE operation. As another method, when an indicator or configuration information is received, the UE may apply the second DRX configuration information configured via the RRC message for the PUCCH SCell, and if PDCCH monitoring can be performed based on a long cycle, a UE operation in the activated SCell may be performed.
   ▪2> In the above, the UE may transmit an indicator indicating that suspension, deactivation, clearing or change of the cell group (e.g., secondary cell group) or cell is performed to the master cell group or the secondary cell group, and the UE may transmit the indicator to the secondary cell group (or base station) or the master cell group (or base station) via a physical signal (e.g., HARQ ACK, NACK or a new transmission resource), MAC control information or an RRC message.
   ▪2> If the UE receives an indicator to suspend, deactivate, or release the cell group (e.g., secondary cell group) or cell in the above, or if the previous state of the cell group was the deactivated state, for the configured SCG bearers, bearers connected to the SCG RLC layer, SCG split bearers, MCG bearers or MCG split bearers, the UE may trigger PDCP state reporting in the PDCP layer and report the PDCP state to the base station. This is because, by transmitting the PDCP state report, it is possible to identify lost data or states of window variables between the UE and the base station, so that transmission windows or reception windows can be synchronized.

The MAC layer reset (MAC reset) proposed in the disclosure may include the following procedures as UE operations. For example, when an upper layer receives an indication to reset a MAC layer (or if an indication to reset is requested), the MAC layer of the UE may perform the following procedures as UE operations. However, the partial MAC layer reset (partial MAC reset) proposed in the disclosure may include some of the following procedures or one or more of the following procedures that are changed as UE operations. For example, when an upper layer receives an indicator to partially reset the MAC layer (or if an indication to partially reset is requested), the MAC layer of the UE performs UE operations that are some of the following procedures or one or more of the following procedures that are changed. The MAC layer reset or the partial MAC layer reset may be indicated or performed for each cell group (e.g., MCG or SCG). For example, i) when an RRC message including an indicator to deactivate the cell group (or the state of the cell group is configured to the deactivated state) is received, or ii) when the cell group was previously activated, or iii) when the UE is in an RRC connected mode, some of the following procedures may be performed as the partial MAC layer reset. In addition, i) when the RRC message including an indicator to activate the cell group (or the state of the cell group is configured to the activated state) is received, or ii) when the cell group was previously deactivated, or iii) when the UE is in the RRC connected mode, the remaining part of the following procedures may be performed as a partial MAC layer reset.
The Bj value configured for each logical channel can be reset to 0. The Bj value is a value that is maintained while being increased by a value obtained by multiplying the prioritized bit rate (PBR) configured in the RRC message for each logical channel by T (time elapsed since the last Bj increase) before every performance of logical channel prioritization (LCP). The procedure of resetting the Bj value configured for each logical channel to 0 in the above may be performed when it is indicated to perform the partial MAC layer reset in the RRC layer, as one operation of the partial MAC layer reset, i) when the RRC message including an indicator to deactivate the cell group (or the state of the cell group is configured to the deactivated state) is received, or ii) when the cell group was previously activated, or iii) if the UE is in the RRC connected mode (This is to increase the Bj value even when the cell group is deactivated so that the priority of data transmission can be considered). As another method, the procedure of resetting the Bj value configured for each logical channel to 0 in the above may be performed when it is indicated to perform the partial MAC layer reset in the RRC layer, as one operation of the procedure of the partial MAC layer reset, i) when the RRC message including an indicator to activate the cell group (or the state of the cell group is configured to the activated state) is received, or ii) when the cell group was previously deactivated, or iii) if the UE is in the RRC connected mode (This is to increase the Bj value from when the cell group is activated to more fairly consider the priority of data transmission).
If there is a timer running in the MAC layer, all running timers may be suspended. In the above, the timer may include a data inactivity timer (datainactivity timer, which performs an operation of transitioning to an RRC idle mode when the timer expires, and can be restarted whenever data is transmitted or received), a bandwidth part inactivity timer, or a TAT timer related to the cell group (MCG, PCell, SCG or PSCell), or may be suspended. However, in the above, i) when the RRC message including an indicator to deactivate the cell group (or the state of the cell group is configured to the deactivated state) is received, or ii) the cell group was previously activated, or iii) if the UE is in the RRC connected mode, the above procedure is not performed (if there is the timer running in the MAC layer, all running timers are suspended) when it is indicated to perform the partial MAC layer reset in the RRC layer. If there is the timer in the MAC layer, a procedure of suspending all other timers except for the TAT timer related to the cell group (SCG or PSCell) can be performed as one operation of the partial MAC layer reset. In the partial MAC layer reset, the timer may include the data inactivity timer (datainactivity timer, which performs the operation of transitioning to the RRC idle mode when the timer expires, and can be restarted whenever data is transmitted or received.) or the bandwidth part inactivity timer, or may be suspended.
All TAT timers may be considered expired. If the TAT timer expires, the HARQ buffer for all serving cells connected to or configured with the timer is flushed, or it may notify the RRC layer to release a PUCCH resource or SRS resource for the serving cell, or the downlink transmission resource (any configured downlink assignment) or uplink transmission (any configured uplink grants) configured in the MAC layer may be released. However, i) when the RRC message including an indicator to deactivate the cell group (or the state of the cell group is configured to the inactive state) is received, or ii) when the cell group was previously activated, or iii) if the UE is in the RRC connected mode, the procedure for continuously maintaining all TAT timers related to the cell group (SCG or PSCell) without performing the above procedure (considering that all TAT timers have expired) may be performed when it is indicated to perform the partial MAC layer reset in the RRC layer, as one operation of the partial MAC layer reset.
New data indicators for an HARQ process for an uplink may all be configured to 0.
If there is random access in progress, the random access may be suspended.
If there is contention-free random access (CFRA) transmission resources for 4-step random access (4-step random access (RA) type) or 2-step random access (2-step RA type) configured in the RRC message proposed in the disclosure, the CFRA transmission resources may be discarded. However, i) when the RRC message including an indicator to deactivate the cell group (or the state of the cell group is configured to the deactivated state) is received in the above or previously, or ii) when the cell group was previously activated, or iii) if the UE is in the RRC connected mode, or the CFRA transmission resources for the 4-step random access (4-step random access (RA) type) or the 2-step random access (2-step RA type) is configured (or included) in the RRC message, the procedure for continuously maintaining or storing the CFRA transmission resource without performing the above procedure (discarding the CFRA transmission resource) (or the CFRA random access may be performed based on the CFRA transmission resource when the cell group is activated) may be performed when it is indicated to perform the partial MAC layer reset in the RRC layer, as one operation of the partial MAC layer reset. However, i) when the RRC message including an indicator to deactivate the cell group (or the state of the cell group is configured to the deactivated state) is received in the above or previously, or ii) when the cell group was previously activated, or iii) if the UE is in the RRC connected mode, or the CFRA transmission resources for the 4-step random access (4-step random access (RA) type) or the 2-step random access (2-step RA type) is not configured (or included) in the RRC message, the above procedure (discarding the CFRA transmission resource) may be performed when it is indicated to perform the partial MAC layer reset in the RRC layer, as one operation of the partial MAC layer reset. As another method, as one operation of the partial MAC layer reset, if there is the contention-free random access (CFRA) transmission resource for the configured (explicitly signaled) 4-step random access (4-step random access (RA) type) or 2-step random access (2-step RA type), as proposed in the disclosure, the CFRA transmission resources may be discarded.
A message 3 (Msg3) buffer may be flushed.
A message A (MSGA) buffer may be flushed.
If there is a triggered scheduling request (SR), it may be canceled.
If there is a triggered buffer status report (BSR), it may be canceled.
If there is a triggered listen before talk (LBT), it may be canceled.
If there is a triggered beam failure recovery (BFR), it may be canceled.
If there is a triggered configured uplink transmission resource confirmation (configured uplink grant confirmation), it may be canceled.
Soft buffers for all downlink HARQ processes may be flushed.
In each HARQ process, the next transmission (or transmission resource) received for a certain transmission block (TB) is considered as the first transmission (or transmission resource).
If there is a temporary cell identifier (temporary C-RNTI), the temporary cell identifier may be released.
All beam failure counter variables (BFI_COUNTER) may be reset (e.g., the value may be configured to 0). However, i) when the RRC message including an indicator to deactivate the cell group (or the state of the cell group is configured to the deactivated state) is received, or ii) the cell group was previously activated, or iii) if the UE is in the RRC connected mode, or if there is configuration information to perform an RLM procedure or a beam failure detection (BFD) procedure in the RRC message, or if the configuration information related to the RLM procedure or beam failure detection is configured to continuously perform the RLM procedure or beam failure detection in the current (or previous) active beam (TCI state) or current (or previous) active bandwidth part (or if it is not configured (or changed) from a previously used beam or bandwidth part to a new different beam or new different bandwidth part), the procedure of maintaining or continuously using the beam failure counter variables (BFI_COUNTER), without performing the above procedure (resetting all beam failure counter variables (BFI_COUNTER)), may be performed when it is indicated to perform the partial MAC layer reset in the RRC layer, as one operation of the partial MAC layer reset (this is because, in the case that the beam or bandwidth part is continuously used, if the resetting is performed above, the beam failure or RLM detection may be delayed by resetting the counter variable value). However, i) when the RRC message including an indicator to deactivate the cell group (or the state of the cell group is configured to the deactivated state) is received, or ii) the cell group was previously activated, or iii) if the UE is in the RRC connected mode, or if there is no configuration information to perform an RLM procedure or a beam failure detection (BFD) in the RRC message, or if there is the configuration information to perform the RLM procedure or beam failure detection (BFD) in the RRC message and the configuration information related to the RLM procedure or beam failure detection is not configured to continuously perform the RLM procedure or beam failure detection in the current (or previous) active beam (TCI state) or current (or previous) active bandwidth part (or if it is configured (or reconfigured or changed) from a previously used beam or bandwidth part to a new different beam or new different bandwidth part), the above procedure (resetting all beam failure counter variables (BFI_COUNTER)) may be performed when it is indicated to perform the partial MAC layer reset in the RRC layer, as one operation of the partial MAC layer reset (this is because, in the case that the beam or bandwidth part is changed, if the resetting is not performed above, the beam failure or RLM detection may occur prematurely due to the maintenance of the counter variable). As another method, all beam failure counter variables (BFI_COUNTER) may always be reset as one operation of the partial MAC layer reset.
All LBT counter variables (LBT_COUNTER) may be reset.

The partial MAC layer reset (partial MAC reset) proposed in the disclosure may include one or a plurality of UE operations among the following procedures. For example, when an upper layer receives an indication to partially reset the MAC layer (or if an indication for partial reset is requested), the MAC layer of the UE may include one or a plurality of UE operations from among the following procedures. A first embodiment of partial MAC layer reset proposed in the disclosure is as follows.
The procedure of resetting the Bj value configured for each logical channel to 0 may be performed when it is indicated to perform the partial MAC layer reset in the RRC layer, as one operation of the partial MAC layer reset, i) when the RRC message including an indicator to deactivate the cell group (or PSCell or MAC layer) (or the state of the cell group is configured to the deactivated state) is received, or ii) when the cell group was previously activated, or iii) the cell group (or PSCell or MAC layer) is deactivated, or iv) if the UE is in the RRC connected mode (This is to increase the Bj value even when the cell group (or PSCell) is deactivated so that the priority of data transmission can be considered). As another method, the procedure of resetting the Bj value configured for each logical channel to 0 in the above may be performed when it is indicated to perform the partial MAC layer reset in the RRC layer, as one operation of the procedure of the partial MAC layer reset, i) when the RRC message including an indicator to activate the cell group (or PSCell) (or the state of the cell group is configured to the activated state) is received (or when activating the PSCell), or ii) when the cell group was previously deactivated, or iii) if the UE is in the RRC connected mode (This is to increase the Bj value from when the cell group is activated to more fairly consider the priority of data transmission).
In the above, i) when the RRC message including an indicator to deactivate the cell group (or PSCell) (or the state of the cell group is configured to the deactivated state) is received, or ii) the cell group was previously activated, or iii) if the UE is in the RRC connected mode, or when the cell group (or PSCell or MAC layer) is deactivated, the procedure of not suspending all running timers if there are timers running in the MAC layer, and suspending all other timers except for the TAT timer related to the cell group (SCG or PSCell) if there is a timer running in the MAC layer may be performed when it is indicated to perform the partial MAC layer reset in the RRC layer, as one operation of the partial MAC layer reset. In the partial MAC layer reset, the timer may include the data inactivity timer (DataInactivity Timer, which performs an operation of transitioning to an RRC idle mode when the timer expires, and can be restarted whenever data is transmitted or received) and the bandwidth part inactivity timer or may suspend the timer. As another method, in the above, i) when the RRC message including an indicator to deactivate the cell group (or PSCell) (or the state of the cell group is configured to the deactivated state) is received, or ii) when the cell group was previously activated, or iii) the UE is in the RRC-connected mode, or iv) when the cell group (or PSCell) is deactivated, the procedure of suspending all other timers except for the TAT timer related to the cell group (SCG or PSCell) or the timer (BeamFailureDetectionTimer) for beam failure detection related to the cell group (SCG or PSCell) may be performed when it is indicated to perform the partial MAC layer reset in the RRC layer, and if there is a timer running in the MAC layer, an one operation of the partial MAC layer reset. For example, if the TAT timer related to the cell group (SCG or PSCell) or the timer for the beam failure detection (BeamFailureDetectionTimer) related to the cell group (SCG or PSCell) is running, the timer may be continuously run (or used). The timer to be suspended in the partial MAC layer reset may include the data inactivity timer (DataInactivity Timer, when the timer expires, it performs an operation of transitioning to the RRC idle mode, and can be restarted whenever data is transmitted or received) or a bandwidth part inactivity timer. In the above, the timer (BeamFailureDetectionTimer) for beam failure detection related to the cell group (SCG or PSCell) may be suspended in the case that the beam failure detection or RLM procedure is not configured for the deactivated cell group (SCG or PSCell). For example, when the RRC message including an indicator to deactivate the cell group (or PSCell or MAC layer) (or the state of cell group is configured to the deactivated state) is received, or in the case that the RRC message is not configured to perform the beam failure detection or RLM procedure for the deactivated cell group (or PSCell or MAC layer), the UE may suspend the timer (BeamFailureDetectionTimer) for beam failure detection related to the cell group (SCG or PSCell). The suspension of the timer may be different from reset of the timer. This is because the suspension of the timer suspends the running timer, and may be restarted according to a procedure for starting or restarting the timer according to specific conditions in the beam failure detection proposed in the disclosure. However, the reset of the timer is resetting a timer value, and the resetting the timer while the timer is running may mean restarting because it is resetting the time value to 0 and running the timer. The operation proposed in the above disclosure may mean an operation of suspending the timer.
in the above, i) when the RRC message including an indicator to deactivate the cell group (or the state of the cell group is configured to the inactive state) is received, or ii) when the cell group was previously activated, or iii) if the UE is in the RRC connected mode, the procedure for continuously maintaining all TAT timers related to the cell group (SCG or PSCell) without performing the above procedure (considering that all TAT timers have expired) may be performed when it is indicated to perform the partial MAC layer reset in the RRC layer, as one operation of the partial MAC layer reset.
New data indicators for an HARQ process for an uplink may all be configured to 0.
If there is random access in progress, the random access may be suspended.
i) When the RRC message including an indicator to deactivate the cell group (or the state of the cell group is configured to the deactivated state) is received in the above or previously, or ii) when the cell group was previously activated, or iii) if the UE is in the RRC connected mode, or the CFRA transmission resources for the 4-step random access (4-step random access (RA) type) or the 2-step random access (2-step RA type) is configured (or included) in the RRC message, the procedure for continuously maintaining or storing the CFRA transmission resource without discarding the CFRA transmission resource (or the CFRA random access may be performed based on the CFRA transmission resource when the cell group is activated) may be performed when it is indicated to perform the partial MAC layer reset in the RRC layer when deactivating the cell group (or PSCell or MAC layer), as one operation of the partial MAC layer reset. However, i) when the RRC message including an indicator to deactivate the cell group (or the state of the cell group is configured to the deactivated state) is received in the above or previously, or ii) when the cell group was previously activated, or iii) if the UE is in the RRC connected mode, or the CFRA transmission resources for the 4-step random access (4-step random access (RA) type) or the 2-step random access (2-step RA type) is not configured (or included) in the RRC message, the above procedure (discarding the CFRA transmission resource) may be performed when it is indicated to perform the partial MAC layer reset in the RRC layer, as one operation of the partial MAC layer reset. As another method, as one operation of the partial MAC layer reset, if there is the contention-free random access (CFRA) transmission resource for the configured (explicitly signaled) 4-step random access (4-step random access (RA) type) or 2-step random access (2-step RA type), as proposed in the disclosure, the CFRA transmission resources may be discarded.
A message 3 (Msg3) buffer may be flushed.
A message A (MSGA) buffer may be flushed.
If there is a triggered scheduling request (SR), it may be canceled.
If there is a triggered buffer status report (BSR), it may be canceled.
If there is a triggered listen before talk (LBT), it may be canceled.
If there is a triggered beam failure recovery (BFR), it may be canceled.
If there is a triggered configured uplink transmission resource confirmation (configured uplink grant confirmation), it may be canceled.
Soft buffers for all downlink HARQ processes may be flushed.
In each HARQ process, the next transmission (or transmission resource) received for a certain transmission block (TB) is considered as the first transmission (or transmission resource).
If there is a temporary cell identifier (Temporary C-RNTI), the temporary cell identifier may be released.
In the above, i) when the RRC message including an indicator to deactivate the cell group (or the state of the cell group is configured to the deactivated state) is received, or ii) the cell group was previously activated, or iii) if the UE is in the RRC connected mode, or iv) when the cell group (or PSCell or MAC layer) is deactivated, or v) if there is configuration information to perform an RLM procedure or a beam failure detection (BFD) procedure in the RRC message, or vi) if the configuration information related to the RLM procedure or beam failure detection is configured to continuously perform the RLM procedure or beam failure detection in the current (or previous) active beam (TCI state) or current (or previous) active bandwidth part (or if it is not configured (or changed) from a previously used beam or bandwidth part to a new different beam or new different bandwidth part), the procedure of maintaining or continuously using the beam failure counter variables (BFI_COUNTER), without performing the above procedure (resetting all beam failure counter variables (BFI_COUNTER)), may be performed when it is indicated to perform the partial MAC layer reset in the RRC layer, as one operation of the partial MAC layer reset (this is because, in the case that the beam or bandwidth part is continuously used, if the resetting is performed above, the beam failure or RLM detection may be delayed by resetting the counter variable value). However, i) when the RRC message including an indicator to deactivate the cell group (or the state of the cell group is configured to the deactivated state) is received, or ii) the cell group was previously activated, or iii) if the UE is in the RRC connected mode, or iv) if there is no configuration information to perform an RLM procedure or a beam failure detection (BFD) procedure in the RRC message, or v) if there is configuration information to perform the RLM procedure or beam failure detection (BFD) in the RRC message, and if the configuration information related to the RLM procedure or beam failure detection is not configured to continuously perform the RLM procedure or beam failure detection in the current (or previous) active beam (TCI state) or current (or previous) active bandwidth part (or if it is configured (or reconfigured or changed) from a previously used beam or bandwidth part to a new different beam or new different bandwidth part), the above procedure (resetting all beam failure counter variables (BFI_COUNTER)) may be performed when it is indicated to perform the partial MAC layer reset in the RRC layer, as one operation of the partial MAC layer reset (this is because, in the case that the beam or bandwidth part is changed, if the resetting is not performed above, the beam failure or RLM detection may occur prematurely due to the maintenance of the counter variable). As another method, all beam failure counter variables (BFI_COUNTER) may always be reset as one operation of the partial MAC layer reset. As another method, i) when the RRC message including an indicator to deactivate the cell group (or the state of the cell group is configured to the deactivated state) is received, or ii) the cell group was previously activated, or iii) if the UE is in the RRC connected mode, or iv) when the cell group (or PSCell or MAC layer) is deactivated, or v) if there is configuration information to perform the RLM procedure or beam failure detection (BFD) in the RRC message, or vi) if the configuration information related to the RLM procedure or beam failure detection is configured to continuously perform the RLM procedure or beam failure detection in the current (or previous) active beam (TCI state) or current (or previous) active bandwidth part (or if it is not configured (or changed) from a previously used beam or bandwidth part to a new different beam or new different bandwidth part), the procedure for not resetting the beam failure counter variable (BFI_COUNTER) for the cell group (or PSCell or cell (serving cell) for which the beam failure detection is configured) (or the procedure of excluding the beam failure counter variable (BFI_COUNTER) for the cell group (or PSCell)), or the procedure for resetting other beam failure counter variables (BFI_COUNTER) (or beam failure counter variables for cells other than the PSCell (e.g., SCell or serving cell) or a cell (serving cell) for which the beam failure detection is not configured) may be performed when it is indicated to perform the partial MAC layer reset in the RRC layer, as one operation of the partial MAC layer reset (this is because, in the case that the beam or bandwidth part is continuously used, if the resetting is performed above, the beam failure or RLM detection may occur delayed by the reset of the counter variable). However, i) when the RRC message including an indicator to deactivate the cell group (or the state of the cell group is configured to the deactivated state) is received, or ii) the cell group was previously activated, or iii) if the UE is in the RRC connected mode, or iv) if there is no configuration information to perform an RLM procedure or a beam failure detection (BFD) in the RRC message, or v) if there is configuration information to perform the RLM procedure or beam failure detection (BFD) in the RRC message, and if the configuration information related to the RLM procedure or beam failure detection is not configured to continuously perform the RLM procedure or beam failure detection in the current (or previous) active beam (TCI state) or current (or previous) active bandwidth part (or if it is configured (or reconfigured or changed) from a previously used beam or bandwidth part to a new different beam or new different bandwidth part), the above procedure (resetting all beam failure counter variables (BFI_COUNTER)) may be performed when it is indicated to perform the partial MAC layer reset in the RRC layer, as one operation of the partial MAC layer reset (this is because, in the case that the beam or bandwidth part is changed, if the resetting is not performed above, the beam failure or RLM detection may occur prematurely due to the maintenance of the counter variable). In the above, all beam failure count variables may mean beam failure count variables related to PSCell, SCell, or serving cell.
All LBT counter variables (LBT_COUNTER) may be reset.

The partial MAC layer reset (partial MAC reset) proposed in the disclosure may include one or a plurality of UE operations among the following procedures. For example, when an upper layer receives an indication to partially reset the MAC layer (or if an indication for partial reset is requested), the MAC layer of the UE may include one or a plurality of UE operations from among the following procedures. A second embodiment of partial MAC layer reset proposed in the disclosure is as follows.
The procedure of resetting the Bj value configured for each logical channel to 0 may be performed when it is indicated to perform the partial MAC layer reset in the RRC layer, as one operation of the partial MAC layer reset, i) when the RRC message including an indicator to deactivate the cell group (or PSCell or MAC layer) (or the state of the cell group is configured to the deactivated state) is received, or ii) when the cell group was previously activated, or iii) the cell group (or PSCell or MAC layer) is deactivated, or iv) if the UE is in the RRC connected mode (This is to increase the Bj value even when the cell group (or PSCell) is deactivated so that the priority of data transmission can be considered). As another method, the procedure of resetting the Bj value configured for each logical channel to 0 in the above may be performed when it is indicated to perform the partial MAC layer reset in the RRC layer, as one operation of the procedure of the partial MAC layer reset, i) when the RRC message including an indicator to activate the cell group (or PSCell) (or the state of the cell group is configured to the activated state) is received (or when PSCell is activated), or ii) when the cell group was previously deactivated, or iii) if the UE is in the RRC connected mode (This is to increase the Bj value from when the cell group is activated to more fairly consider the priority of data transmission).
In the above, i) when the RRC message including an indicator to deactivate the cell group (or PSCell) (or the state of the cell group is configured to the deactivated state) is received, or ii) the cell group was previously activated, or iii) if the UE is in the RRC connected mode, or iv) when the cell group (or PSCell or MAC layer) is deactivated, the procedure of not suspending all running timers if there are timers running in the MAC layer, and suspending all other timers except for the TAT timer related to the cell group (SCG or PSCell) if there is a timer running in the MAC layer may be performed when it is indicated to perform the partial MAC layer reset in the RRC layer, as one operation of the partial MAC layer reset. In the partial MAC layer reset, the timer may include the data inactivity timer (DataInactivity Timer, which performs an operation of transitioning to an RRC idle mode when the timer expires, and can be restarted whenever data is transmitted or received), or the bandwidth part inactivity timer, or may suspend the timer. As another method, in the above, i) when the RRC message including an indicator to deactivate the cell group (or PSCell) (or the state of the cell group is configured to the deactivated state) is received, or ii) when the cell group was previously activated, or iii) the UE is in the RRC-connected mode, or iv) when the cell group (or PSCell) is deactivated, the procedure of suspending all other timers except for the TAT timer related to the cell group (SCG or PSCell) or the timer (BeamFailureDetectionTimer) for beam failure detection related to the cell group (SCG or PSCell) may be performed when it is indicated to perform the partial MAC layer reset in the RRC layer, and if there is a timer running in the MAC layer, an one operation of the partial MAC layer reset. For example, if the TAT timer related to the cell group (SCG or PSCell) or the timer for the beam failure detection (BeamFailureDetectionTimer) related to the cell group (SCG or PSCell) is running, the timer may be continuously run (or used). The timer to be suspended in the partial MAC layer reset may include the data inactivity timer (DataInactivity Timer, when the timer expires, it performs an operation of transitioning to the RRC idle mode, and can be restarted whenever data is transmitted or received) or a bandwidth part inactivity timer. In the above, the timer (BeamFailureDetectionTimer) for beam failure detection related to the cell group (SCG or PSCell) may be suspended in the case that the beam failure detection or RLM procedure is not configured for the deactivated cell group (SCG or PSCell). For example, when the RRC message including an indicator to deactivate the cell group (or PSCell or MAC layer) (or the state of cell group is configured to the deactivated state) is received, or in the case that the RRC message is not configured to perform the beam failure detection or RLM procedure for the deactivated cell group (or PSCell or MAC layer), the UE may suspend the timer (BeamFailureDetectionTimer) for beam failure detection related to the cell group (SCG or PSCell). The suspension of the timer may be different from reset of the timer. This is because the suspension of the timer suspends the running timer, and may be restarted according to a procedure for starting or restarting the timer according to specific conditions in the beam failure detection proposed in the disclosure. However, the reset of the timer is resetting a timer value, and the resetting the timer while the timer is running may mean restarting because it is resetting the time value to 0 and running the timer. The operation proposed in the above disclosure may mean an operation of suspending the timer. As another method, in the above, i) when the RRC message including an indicator to deactivate the cell group (or PSCell) (or the state of the cell group is configured to the deactivated state) is received, or ii) when the cell group was previously activated, or iii) the UE is in the RRC-connected mode, or iv) when the cell group (or PSCell) is deactivated, the procedure for suspending all other timers except for the TAT timer related to the cell group (SCG or PSCell) and/or the timer (BeamFailureDetectionTimer) for the beam failure detection related to the cell group (SCG or PSCell) and/or the timer (lbt-FailureDetectionTimer) for a listen before talk (LBT) failure detection may be performed when it is indicated to perform the partial MAC layer reset in the RRC layer, and if there is a timer running in the MAC layer, an one operation of the partial MAC layer reset. For example, if the TAT timer related to the cell group (SCG or PSCell), the timer (BeamFailureDetectionTimer) for the beam failure detection related to the cell group (SCG or PSCell) or the timer (lbt-FailureDetectionTimer) for the listen before talk (LBT) failure detection is running, the timer may be continuously running (using). The timer to be suspended in the partial MAC layer reset may include the data inactivity timer (DataInactivity Timer, which performs an operation of transitioning to an RRC idle mode when the timer expires, and can be restarted whenever data is transmitted or received) and/or the bandwidth part inactivity timer. In the above, the timer (BeamFailureDetectionTimer) for the beam failure detection related to the cell group (SCG or PSCell) may be suspended in the case that the beam failure detection or RLM procedure is not configured for the deactivated cell group (SCG or PSCell). For example, when the RRC message including an indicator to deactivate the cell group (or PSCell or MAC layer device) (or the state of the cell group is configured to the deactivated state) is received in above, or in the case that the RRC message is not configured to perform the beam failure detection or RLM procedure for the deactivated cell group (PSCell or MAC layer), the timer (BeamFailureDetectionTimer) for the beam failure detection related to the cell group (SCG or PSCell) may be suspended. In the above, the timer (lbt-FailureDetectionTimer) for the listen before talk (LBT) failure detection related to the cell group (SCG or PSCell) may be suspended in the case that the LBT procedure is not configured for the deactivated cell group (SCG or PSCell). For example, when the RRC message including an indicator to deactivate the cell group (or PSCell or MAC layer device) (or the state of the cell group is configured to the deactivated state) is received in above, or in the case that the RRC message is not configured to perform the LBT procedure for the deactivated cell group (PSCell or MAC layer), the timer (lbt-FailureDetectionTimer) for the listen before talk (LBT) failure detection related to the cell group (SCG or PSCell) may be suspended. In the above, suspending the timer may be different from resetting the timer. This is because suspending the timer stops the running timer and the timer can be restarted by the procedure of starting or restarting the timer according to specific conditions in the beam failure detection proposed in the disclosure. However, resetting the timer is resetting a timer value, and the resetting the timer while the timer is running may mean resetting the time value to 0 and running the timer, which may mean restarting. The operation proposed in the above disclosure may mean an operation of suspending the timer.
in the above, i) when the RRC message including an indicator to deactivate the cell group (or the state of the cell group is configured to the inactive state) is received, or ii) when the cell group was previously activated, or iii) if the UE is in the RRC connected mode, the procedure for continuously maintaining all TAT timers related to the cell group (SCG or PSCell) without performing the above procedure (considering that all TAT timers have expired) may be performed when it is indicated to perform the partial MAC layer reset in the RRC layer, as one operation of the partial MAC layer reset.
New data indicators (NDI) for an HARQ process for an uplink may all be configured to 0.
If there is random access in progress, the random access may be suspended.
In the above, i) when the RRC message including an indicator to deactivate the cell group (or the state of the cell group is configured to the deactivated state) is received, or ii) when the cell group was previously activated, or iii) the UE is in the RRC-connected mode, or iv) when the CFRA transmission resource for 4-step random access (4-step random access (RA) type) or 2-step random access (2-step RA type) is configured (or included) in the RRC message, or v) the cell group (or PSCell or MAC layer) is deactivated, the procedure for continuously maintaining or storing the CFRA transmission resource (or the CFRA random access may be performed based on the CFRA transmission resource when activating the cell group), without discarding the CFRA transmission resource, may be performed when it is indicated to perform the partial MAC layer reset in the RRC layer, as one operation of the partial MAC layer reset. However, i) when the RRC message including an indicator to deactivate the cell group (or the state of the cell group is configured to the deactivated state) is received in the above or previously, or ii) when the cell group was previously activated, or iii) the UE is in the RRC-connected mode, or iv) when the CFRA transmission resource for 4-step random access (4-step random access (RA) type) or 2-step random access (2-step RA type) is not configured (or included) in the RRC message, the above procedure (discarding the CFRA transmission resource) may be performed when it is indicated to perform the partial MAC layer reset in the RRC layer, as one operation of the partial MAC layer reset. As another method, as one operation of the partial MAC layer reset, if there is the contention-free random access (CFRA) transmission resource for the configured (explicitly signaled) 4-step random access (4-step random access (RA) type) or 2-step random access (2-step RA type), as proposed in the disclosure, the CFRA transmission resources may be discarded.
A message 3 (Msg3) buffer may be flushed.
A message A (MSGA) buffer may be flushed.
If there is a triggered scheduling request (SR), it may be canceled.
If there is a triggered buffer status report (BSR), it may be canceled.
If there is a triggered listen before talk (LBT), it may be canceled.
If there is a triggered beam failure recovery (BFR), it may be canceled.
If there is a triggered configured uplink transmission resource confirmation (configured uplink grant confirmation), it may be canceled.
Soft buffers for all downlink HARQ processes may be flushed.
In each HARQ process, the next transmission (or transmission resource) received for a certain transmission block (TB) is considered as the first transmission (or transmission resource).
If there is a temporary cell identifier (Temporary C-RNTI), the temporary cell identifier may be released.
In the above, i) when the RRC message including an indicator to deactivate the cell group (or the state of the cell group is configured to the deactivated state) is received, or ii) the cell group was previously activated, or iii) if the UE is in the RRC connected mode, or iv) when the cell group (or PSCell or MAC layer) is deactivated, or v) if there is configuration information to perform an RLM procedure or a beam failure detection (BFD) procedure in the RRC message, or vi) if the configuration information related to the RLM procedure or beam failure detection is configured to continuously perform the RLM procedure or beam failure detection in the current (or previous) active beam (TCI state) or current (or previous) active bandwidth part (or if it is not configured (or changed) from a previously used beam or bandwidth part to a new different beam or new different bandwidth part), the procedure of maintaining or continuously using the beam failure counter variables (BFI_COUNTER), without performing the above procedure (resetting all beam failure counter variables (BFI_COUNTER)), may be performed when it is indicated to perform the partial MAC layer reset in the RRC layer, as one operation of the partial MAC layer reset (this is because, in the case that the beam or bandwidth part is continuously used, if the resetting is performed above, the beam failure or RLM detection may be delayed by resetting the counter variable value). However, i) when the RRC message including an indicator to deactivate the cell group (or the state of the cell group is configured to the deactivated state) is received, or ii) the cell group was previously activated, or iii) if the UE is in the RRC connected mode, or iv) if there is no configuration information to perform an RLM procedure or a beam failure detection (BFD) procedure in the RRC message, or v) if there is configuration information to perform the RLM procedure or beam failure detection (BFD) in the RRC message, and if the configuration information related to the RLM procedure or beam failure detection is not configured to continuously perform the RLM procedure or beam failure detection in the current (or previous) active beam (TCI state) or current (or previous) active bandwidth part (or if it is configured (or reconfigured or changed) from a previously used beam or bandwidth part to a new different beam or new different bandwidth part), the above procedure (resetting all beam failure counter variables (BFI_COUNTER)) may be performed when it is indicated to perform the partial MAC layer reset in the RRC layer, as one operation of the partial MAC layer reset (this is because, in the case that the beam or bandwidth part is changed, if the resetting is not performed above, the beam failure or RLM detection may occur prematurely due to the maintenance of the counter variable). As another method, all beam failure counter variables (BFI_COUNTER) may always be reset as one operation of the partial MAC layer reset. As another method, i) when the RRC message including an indicator to deactivate the cell group (or the state of the cell group is configured to the deactivated state) is received, or ii) the cell group was previously activated, or iii) if the UE is in the RRC connected mode, or iv) when the cell group (or PSCell or MAC layer) is deactivated, or v) if there is configuration information to perform the RLM procedure or beam failure detection (BFD) in the RRC message, or vi) if the configuration information related to the RLM procedure or beam failure detection is configured to continuously perform the RLM procedure or beam failure detection in the current (or previous) active beam (TCI state) or current (or previous) active bandwidth part (or if it is not configured (or reconfigured or changed) from a previously used beam or bandwidth part to a new different beam or new different bandwidth part), the procedure for not resetting the beam failure counter variable (BFI_COUNTER) for the cell group (or PSCell or cell (serving cell) for which the beam failure detection is configured) (or the procedure of excluding the beam failure counter variable (BFI_COUNTER) for the cell group (or PSCell)), or the procedure for resetting other beam failure counter variables (BFI_COUNTER) (or beam failure counter variables for cells other than the PSCell (e.g., SCell or serving cell) or a cell (serving cell) for which the beam failure detection is not configured) may be performed when it is indicated to perform the partial MAC layer reset in the RRC layer, as one operation of the partial MAC layer reset (this is because, in the case that the beam or bandwidth part is continuously used, if the resetting is performed above, the beam failure or RLM detection may be delayed by the reset of the counter variable). However, i) when the RRC message including an indicator to deactivate the cell group (or the state of the cell group is configured to the deactivated state) is received, or ii) the cell group was previously activated, or iii) if the UE is in the RRC connected mode, or iv) if there is no configuration information to perform an RLM procedure or a beam failure detection (BFD) in the RRC message, or v) if there is configuration information to perform the RLM procedure or beam failure detection (BFD) in the RRC message, and if the configuration information related to the RLM procedure or beam failure detection is not configured to continuously perform the RLM procedure or beam failure detection in the current (or previous) active beam (TCI state) or current (or previous) active bandwidth part (or if it is configured (or reconfigured or changed) from a previously used beam or bandwidth part to a new different beam or new different bandwidth part), the above procedure (resetting all beam failure counter variables (BFI_COUNTER)) may be performed when it is indicated to perform the partial MAC layer reset in the RRC layer, as one operation of the partial MAC layer reset (this is because, in the case that the beam or bandwidth part is changed, if the resetting is not performed above, the beam failure or RLM detection may occur prematurely due to the maintenance of the counter variable).
In the above, i) when the RRC message including an indicator to deactivate the cell group (or the state of the cell group is configured to the deactivated state) is received, or ii) when the cell group was previously activated, or iii) the UE is in the RRC-connected mode, or iv) when the cell group (or PSCell or MAC layer) is deactivated, or v) if there is configuration information to perform the LBT procedure in the RRC message or it is configured to continuously perform the LBT procedure in the RRC message, the above procedure (resetting all LBT counter variables (LBT_COUNTER)) is not performed and the procedure for maintaining or continuously using the LBT counter variables (LBT_COUNTER)) may be performed when it is indicated to perform the partial MAC layer reset in the RRC layer, as one operation of the partial MAC layer reset (this is because, in the LBT procedure is continuously used, if the above resetting is performed, the LBT failure detection may be delayed). However, i) when the RRC message including an indicator to deactivate the cell group (or the state of the cell group is configured to the deactivated state) is received, or ii) when the cell group was previously activated, or iii) the UE is in the RRC-connected mode, or iv) if there is no configuration information to perform the LBT procedure in the RRC message or it is not configured to continuously perform the LBT procedure in the RRC message, the above procedure (resetting all LBT counter variables (LBT_COUNTER)) may be performed when it is indicated to perform the partial MAC layer reset in the RRC layer, as one operation of the partial MAC layer reset (this is because, in the LBT procedure is not configured, if the resetting is not performed in the above, LBT failure may occur too early due to the maintenance of the counter variables when the LBT procedure is configured later). As another method, all LBT counter variables (LBT_COUNTER) may always be reset as one operation of the partial MAC layer reset. As another method, i) when the RRC message including an indicator to deactivate the cell group (or the state of the cell group is configured to the deactivated state) is received, or ii) when the cell group was previously activated, or iii) the UE is in the RRC-connected mode, or iv) the cell group (or PSCell or MAC layer) is deactivated, or v) if there is configuration information to perform the LBT procedure in the RRC message or it is configured to continuously perform the LBT procedure in the RRC message, the procedure for not resetting the LBT counter variables (LBT_COUNTER) for the cell group (or PSCell or cell (serving cell) for which the LBT procedure is configured) (or the procedure of excluding the LBT counter variables (LBT_COUNTER) for the cell group (or PSCell)), or the procedure for resetting other LBT counter variables (LBT_COUNTER) (or LBT counter variables (LBT_COUNTER) for cells other than the PSCell (e.g., SCell or serving cell) or a cell (serving cell) for which the LBT procedure is not configured) may be performed when it is indicated to perform the partial MAC layer reset in the RRC layer, as one operation of the partial MAC layer reset (this is because, in the case that the LBT procedure is continuously used, if the resetting is performed above, the LBT failure detection may be delayed by the reset of the LBT counter variables (LBT_COUNTER)). However, i) when the RRC message including an indicator to deactivate the cell group (or the state of the cell group is configured to the deactivated state) is received, or ii) when the cell group was previously activated, or iii) the UE is in the RRC-connected mode, or iv) if there is no configuration information to perform the LBT procedure in the RRC message or it is not configured to continuously perform the LBT procedure in the RRC message, the above procedure (resetting the LBT counter variables (LBT_COUNTER)) may be performed when it is indicated to perform the partial MAC layer reset in the RRC layer, as one operation of the partial MAC layer reset. In the above, the LBT counter variable (LBT_COUNTER) may mean the LBT counter variables (LBT_COUNTER) related to PSCell, SCell, or serving cell.

When MAC layer reset is performed, when an indicator for partial MAC layer reset is neither included nor indicated, or partial MAC layer reset is not performed, the UE may perform reset for the entire MAC layer, and accordingly the UE may flush all the configured general HARQ process, HARQ process for MBS, or HARQ process for system information.

When, for the UE for which the dual connectivity is configured as proposed in the above, a cell group (or SCG) is configured to a deactivated state, or a beam failure detection is configured, or an RLM procedure is configured via an RRC message. the procedures of a MAC layer to be performed by the UE are proposed in the following of the disclosure. For example, the disclosure proposes that the UE perform different beam failure detection or beam failure recovery procedures depending on whether the state of the cell group configured in the RRC message is the deactivated state or activated state.
1> If the UE receives the RRC message, and the beam failure detection, the first BFR, or the second BFR is configured in the RRC message, or the cell (PSCell or SCell) or cell group for which the beam failure detection is configured is not configured to the deactivated state (or configured to the activated state)
   ▪2> The UE may perform beam failure detection.
   ▪2> If the beam failure is detected in the cell (PSCell or SCell) or cell group,
      ♦3> the first BRF or second BFR proposed by the disclosure may be performed.
   ▪2> If random access problem is detected due to the beam failure,
      ♦3> the UE may report the random access problem due to the beam failure to the base station.
1> Otherwise, if the UE receives the RRC message and the beam failure detection, the first BFR or the second BFR is configured in the RRC message, or the cell (PSCell or SCell) or cell group (or SCG) is configured to the deactivated state, and if the beam failure detection, the first BFR or the second BFR is configured for the cell group, or the cell or cell group for which the beam failure detection is configured is configured to the deactivated state,
   ▪2> The UE may perform the beam failure detection.
   ▪2> If the beam failure is detected for the cell (PSCell or SCell) or cell group,
      ♦3> the first BFR or second BFR proposed by the disclosure may not be performed. This is because the random access may be unnecessarily triggered for the deactivated cell group. The MAC layer may indicate or report that the beam failure has been detected to an upper layer (or RRC layer).
   ▪2> If the beam failure is detected for the deactivated cell group (SCG), cell (PSCell) or MAC layer,
      ♦3> the UE may report the beam failure to the base station (or MCG). For example, the beam failure may be included in an SCG failure report message (SCGFailureInformation) and transmitted to the base station for reporting.
   ▪2> If the random access problem due to the beam failure is detected,
      ♦3> the UE may report the random access problem due to the beam failure to the base station.

In the disclosure, in the case that the beam failure detection is configured in the RRC message, the disclosure proposes a detailed procedure for the beam failure detection of the MAC layer by the UE.
1> If an indication that the beam failure has occurred is received from a lower layer,
   ▪2> a timer (BeamFailureDetectionTimer) for beam failure detection may be started or restarted (the timer may be configured in the RRC message.),
   ▪2> a variable (BFI_COUNTER) for counting the number of beam failures may be increased by 1.
   ▪2> If the variable for counting the number of beam failures is greater than or equal to the maximum number of beam failures (beamFailureInstanceMaxCount) (the maximum number of beam failures may be configured in the RRC message),
      ♦3> if the serving cell (the cell in which the beam failure occurred above) is the SCell,
         •4> the beam failure recovery (BFR) procedure may be triggered or performed for the cell.
      ♦3> Otherwise, if (else if) the serving cell (the cell in which the beam failure occurred above) is PSCell or the cell group (or PSCell) is deactivated (or not activated or in the deactivated state) (e.g., the next procedure is a procedure that can be applied only to the PSCell (a procedure that does not apply to the PCell.)
         •4> the fact that the beam failure occurs with respect to the cell may be indicated to the upper layer (e.g., the RRC layer).
         •4> it may be considered that a TAT timer corresponding to (or related to) the cell group, PSCell or primary timing advance group (PTAG) expires. Alternatively, the TAT timer related to the cell group, PSCell or PTAG may be suspended. This is because it may determine that the TA value is no longer valid if the beam failure occurs with respect to the deactivated cell group or cell, and thus the TAT timer does not need to be run unnecessarily. Alternatively, the RLM procedure may also be suspended or a radio link failure may be declared. This is because if the beam failure occurs for the deactivated cell group or cell, it may be considered that the radio link is no longer valid.
      ♦3> Otherwise (else) (or else if), the serving cell (the cell in which the beam failure occurs above) is SpCell (PCell or PSCell) or the cell group (or SpCell (PCell or PSCell)) is not deactivated (or activated or activated state) (e.g., the following procedure may be applicable to PCell and PSCell, respectively),
         •4> the random access may be started or performed for the SpCell.
1> If a timer for the beam failure detection expires,
1> alternatively, i) if the timer for beam failure detection used for the beam failure detection connected to (or configured to) the cell (or cell group), the number of beam failure detections, or a certain reference signal is reconfigured from the upper layer (RRC layer, upper layer), or ii) when the RRC message including an indicator to deactivate the cell group (or the state of the cell group is configured to the deactivated state) is received, or iii) when the cell group was previously activated, or iv) if the UE is in the RRC connected mode, or v) if there is configuration information to perform the RLM procedure or beam failure detection (BFD) procedure in the RRC message, or vi) if there is configuration information to perform the RLM procedure or beam failure detection (BFD) in the RRC message, and if the configuration information related to the RLM procedure or beam failure detection is not configured to continuously perform the RLM procedure or beam failure detection in the current (or previous) active beam (TCI state) or current (or previous) active bandwidth part (or if it is configured (or changed) from a previously used beam or bandwidth part to a new different beam or new different bandwidth part),
   ▪2> the beam failure counter variables (BFI_COUNTER) may be reset (or configured to 0).

The beam failure recovery (BFR) proposed by the disclosure is as follows.

In the disclosure, the first BFR (e.g., Rel-15 beam failure recovery (BFR)) is possible only for PCell or SpCell. For example, when beam failure occurs in the UE in the connected mode, the UE performs the random access. In the above, the random access depends on whether a preamble for BFR is configured in the RRC message. The preamble may be configured for each beam. In addition, if the preamble for BFR is configured, a search space for BFR may also be configured. In the case that the preamble for BFR is configured as described above, the CFRA may be performed. For example, if a failure occurs in beam 1, the UE searches for a beam, and if it determines that the beam is valid in beam 3, the UE identifies whether the preamble for BFR is configured in beam 3, and if so, the UE may perform the CFRA with the preamble. In addition, the UE may wait for response and monitor the PDCCH in the search space configured above. When the UE performs the random access in the preamble, the base station knows the occurrence of the beam failure, and may schedule (DL assignment or UL grant) to the UE as a PDCCH. Then, the UE continues to transmit or receive data on the beam and the beam can be recovered. (In the CFRA, since the base station accurately knows the beam failure, there is no need to transmit RAR for TA reconfiguration.)

If the preamble for BFR is not configured in the RRC message, the CBRA may be performed. For example, if a failure occurs in beam 1, the UE searches for a beam, and if it determines that the beam is valid in beam 3, the UE identifies whether the preamble for BFR is configured in beam 3, and if the preamble for BFR is not configured, the UE may perform the CBRA. The UE may wait for response and wait for RAR. The base station transmits the RAR without knowing why the UE suddenly performs the random access, and the UE may complete the random access. Then, the UE performs data transmission and reception of the PDCCH indication on the beam, and the beam can be recovered.

Beamfailurerecoveryconfig for the first BFR (e.g., Rel-15 beam failure recovery (BFR)) or SpCell may be configured in UL BWP. This is because when BFR is triggered, a BFR dedicated preamble may be configured.

The second BFR (e.g., Rel-16 beam failure recovery (BFR)) of the disclosure is possible for SpCell as well as SCell. A dedicated scheduling request (SR) (or PUCCH transmission resource) for BFR may be configured for each cell and for each bandwidth part via the RRC message. If the beam failure occurs for a certain bandwidth part of the SCell, a BFR MAC control element (CE) may be generated. In addition, if the beam failure occurs for the bandwidth part and if the dedicated SR is configured (PCell or PUCCH SR), the UE may transmit the SR on PUCCH. In addition, if the beam failure reporting continues to fail in the dedicated SR, the UE may perform the random access with CBRA. In the case that the number of SRs is exceeded, only CBRA may be performed similarly even in the case that legacy sends BSR. In the above, the random access may be performed in the PCell. Therefore, for the SCell, if the UE determines in which SCell the failure occurs when sending the MAC CE through the PCell above, and the UE determines a valid TCI state among the TCI sets (or TCI states) configured by RRC, the UE may optionally report the effective beam for each SCell. In the above, in the case that the UE transmits the MAC CE including a valid beam for the SCell, if a HARQ ACK is received for the MAC PDU including the MAC CE, the UE and the base station use the valid beam for the SCell. If a valid beam is not included in MAC CE for the SCell, the base station may designate a beam as DCI of PDCCH or TCI state MAC CE in response to this.

In addition, in the second BFR (Rel-16 beam failure recovery procedure (BFR)), the BFR for SpCell can also be improved.

For example, the second BFR (Rel-16 beam failure recovery (BFR)) may be performed like Rel-15 for PCell or SpCell. For example, when the beam failure occurs, the UE may perform the random access. In the above, the random access may differ depending on whether the preamble for BFR is configured. The preamble may be configured for each beam. In addition, if the preamble for BFR is configured, the search space for BFR may also be configured. In the case that the preamble for BFR is configured as described above, the UE may perform CFRA with the preamble. For example, if a failure occurs in beam 1, the UE searches for a beam, and if it determines that the beam is valid in beam 3, the UE identifies whether the preamble for BFR is configured in beam 3, and if so, the UE may perform the CFRA. In addition, the UE may wait for beam response and monitor the PDCCH in the search space configured above. When the UE performs the random access in the preamble, the base station determines the occurrence of the beam failure, and may schedule (DL assignment or UL grant) to the UE as a PDCCH. Then, the UE continues to transmit or receive data on the beam and the beam can be recovered (in the CFRA, since the base station accurately determines the beam failure, there is no need to transmit RAR for TA reconfiguration.)

In the case that the preamble for BFR is not configured above, the CBRA may be performed. For example, if a failure occurs in beam 1, the UE searches for a beam, and if it is determined that the beam is valid in beam 3, the UE identifies whether the preamble for BFR is configured in beam 3, and if the preamble for BFR is not configured, the UE may perform the CBRA. The UE may wait for response and wait for RAR. The base station transmits the RAR without knowing why the UE suddenly performs the random access, and the UE receives the RAR and then generates BFR MAC CE, and transmit Msg3. However, the beams valid for SpCell cannot be included in the MAC CE. This is because, unlike SCell, PCell sends BFR MAC CE for the BFR generated in PCell. For example, when the beam failure occurs in the PCell, the UE searches for a valid beam and transmits a preamble for the valid beam, so the base station and the UE already determine the valid beam for the PCell in the random access. Thus, if random access is completed, the UE performs data transmission and reception on beam 3, and the beam can be recovered.

For example, when BFR is triggered for the Rel-16 SpCell, the random access is triggered unconditionally regardless of SR, and the BFR MAC CE is configured (if the preamble for BFR is not configures) and transmitted. In addition, in the RRC message for the Rel-16 BFR or SCell, BeamFailureRecoverySCellConfig is configured to DL BWP. This is to configure candidate RS that can be included in the BFR MAC CE when BFR is triggered. The dedicated SR for the SCell BFR may be included in MAC-CellGroupConfig in the RRC message. Alternatively, the dedicated SR may be configured in schedulingRequestConfig.

In addition, in the RRC message, the base station may configure beam failure RS so that the UE can identify the beam failure. If all of the RSs fail, the UE can detect the beam failure and perform the random access.

In the case that the base station configures the preamble for beam failure recovery in advance, the UE performs the random access with the CFRA, and the base station can determine whether the UE performs the random access for beam recovery, with the preamble.

However, in the case that the base station does not configure the preamble for beam failure recovery in advance, the UE performs CBRA. This is indistinguishable from the point of view of the base station that BSR is triggered and the random access is triggered to transmit uplink data in a state where SR is not configured. However, the base station may determine one of the above two cases by discovering that the UE suddenly performs the random access, receive BSR information if there is the BSR, determines the case as BFR if there is no BSR, read the BSR even in the case that the above two cases are triggered at the same time, determines/identifies the preamble, so that the base station can implicitly determine which case it is. When the UE reads SSB, the UE may determine how many beams there are and which beams are transmitted at which cycle and for which time and frequency resources. In addition, the intensity of the beam may be measured and the random access may be performed on a beam exceeding a predetermined criterion. When a certain beam is selected, the UE may perform the random access on the beam based on the time and frequency resources, or the cycle.

In the following, the disclosure proposes procedures to be performed by the UE in the case that the state of a cell group is configured to the activated state or deactivated state, or the PSCell of the cell group is configured to the activated state or deactivated state. In the above, the UE may receive an indication of an activation state or deactivation state via an RRC message (RRCReconfiguration or RRCResume), MAC control information, or PDCCH DCI for the cell group or cell (PSCell). For example, in the case that the deactivated state is configured in the RRC message (RRCReconfiguration or RRCResume), MAC control information, or PDCCH DCI, the UE may deactivate cell group (or SCG) or cell (or PSCell), and in the case that the deactivated state is not configured (or the activated state is configured) in the RRC message (RRCReconfiguration or RRCResume), MAC control information, or PDCCH DCI, the UE may activate the cell group or cell.

In the disclosure, when an indication to activate the cell group or cell is received (or a case where an instruction to deactivate is not received), or if the cell group was previously deactivated, or if the UE is in an RRC connected mode, the UE may perform the following operations.
If the indication to activate the cell group (or SCG) or cell (or PSCell) is received via the DCI (L1 control signal) of PDCCH, MAC CE or RRC message (or a case where the indication to deactivate is not received) by the UE or if the cell group was previously deactivated, or if the UE is in the RRC-connected mode, the UE may perform one or more of the following operations.
   ▪ The cell group or cell may be activated.
   ▪ The UE performs switching or activation to the uplink bandwidth part or downlink bandwidth part (e.g., first active downlink bandwidth part or first active uplink bandwidth part) configured in the RRC message. As another method, in the case that the cell group or cell is activated by performing random access (or a case in which reconfigurationWithSync is configured, or beam failure is detected, or radio link failure is detected, or a TAT timer is not running (or expires)), the cell group or cell is activated, the UE may perform switching or activation to the uplink bandwidth part or downlink bandwidth part (e.g., first active downlink bandwidth part, first active uplink bandwidth part or newly defined bandwidth part) configured in the RRC message. Alternatively, in the case of performing the random access, the UE may not perform the random access in the bandwidth part. However, the UE may activate the previously (or last) activated bandwidth part without performing the random access (or a case in which the random access is configured not to be performed, or beam failure is not detected, or radio link failure is not detected, or the TAT timer is running (or the TAT timer does not expire).
   ▪ In the activated bandwidth part, the UE transmits a sounding reference signal (SRS) so that the base station can perform channel measurement for an uplink. For example, the UE may transmit the SRS periodically.
   ▪ If PUCCH is configured in the activated bandwidth part, the UE may perform PUCCH transmission.
   ▪ If there is a type 1 configuration transmission resource that is not used, the UE may reset and use the saved type 1 transmission resource as original configured. In the above, the type 1 configuration transmission resource is a periodic transmission resource (uplink or downlink) pre-allocated via the RRC message and may means a transmission resource that can be activated and used via the RRC message.
   ▪ The UE may trigger PHR for the bandwidth part. The PHR may be triggered for MCG or SCG. In addition, the PHR may be reported to the MCG or SCG.
   ▪ In the activated bandwidth part, the UE may report a channel measurement result (CSI, CQI, PMI, RI, PTI, CRI, or the like) according to the configuration of the base station for a downlink.
   ▪ The UE may monitor PDCCH to read an indication from the base station in the activated bandwidth part.
   ▪ The UE may monitor PDCCH to read cross scheduling for the activated bandwidth part.
   ▪ In the above, the UE may start or restart a bandwidth part inactivity timer. As another method, the UE may start or restart the bandwidth part inactivity timer only in the case that a bandwidth part hibernation timer is not configured. In the above, if the bandwidth part hibernation timer can be configured via the RRC message, when the timer expires, the UE may switch the bandwidth part to the dormancy or dormant bandwidth part. For example, the bandwidth part inactivity timer may be started or restarted only in the dormant bandwidth part.

In the disclosure, a UE operation upon receiving an indication to deactivate a cell group or cell is as follows.
If the indication to deactivate the cell group (or SCG) or cell (or PSCell) is received via the DCI (L1 control signal) of PDCCH, MAC CE or RRC message, or if the cell group (or cell) is previously activated, or if the UE is in the RRC connected mode, the UE may perform one or more of the following operations.
   ▪ The UE may deactivate the cell group or cell or the uplink or downlink bandwidth part indicated above.
   ▪ The TAT timer related to the cell (PSCell) or cell group (e.g., the TA timer connected (configured) with a primary timing advance group (PTAG) or a secondary timing advance group (STAG)) is continuously maintained without being suspended, so that the UE may activate the cell or cell group quickly without the random access when activating the cell or cell group again. If the TAT timer related to the cell group expires in the deactivated cell or cell group, the MAC layer may indicate that the TAT expires to an upper layer (e.g., RRC layer). Alternatively, if the TAT timer related to the cell group expires in the deactivated cell or cell group, the UE may suspend the beam failure detection or the RLM procedure (or the UE may consider that beam failure occurs, or radio link is invalid). As another method, if the UE detects the beam failure, the UE may suspend the TAT timer related to the cell group (or the UE may consider that the TAT timer expires) or suspend the RLM procedure. As another method, if the UE detects the radio link failure, the UE may suspend the TAT timer related to the cell group (or the UE may consider that the TAT timer expires) or suspend the beam failure detection (or the UE may consider that the beam failure occurs).
   ▪ The UE may suspend the bandwidth part inactivity timer (e.g., an inactivity timer for a downlink bandwidth part) configured and running in the cell or bandwidth part.
   ▪ A periodic downlink transmission resource (DL SPS or configured downlink assignment) or a periodic uplink transmission resource (UL SPS or configured uplink grant Type 2), configured for the cell or bandwidth part, may be cleared. The clearing of the transmission resource means that the UE stores configuration information, such as period information configured via an RRC message, but removes and no longer uses information on the periodic transmission resource indicated or activated via L1 signaling (e.g., DCI). The periodic transmission resource may be referred to as a type 2 configuration transmission resource. In addition, the operation of clearing the periodic transmission resource may be performed only when the SCell is shifted from an activated state to a deactivated state. This is because when shifting from the dormant state to the deactivated state, a clearing operation is not required because there is no periodic transmission resource in the dormant state. Alternatively, only in the case that the periodic downlink transmission resource or the periodic uplink transmission resource is configured or is configured so as to be used, the periodic transmission resources may be cleared.
   ▪ The periodic uplink transmission resource (configured uplink grant Type 1 configured via RRC) configured for the cell or bandwidth part, may be suspended. The suspending of the transmission resource may mean that the UE stores but no longer uses transmission resource configuration information configured via an RRC message. The periodic transmission resource may be referred as type 1 configuration transmission resource. In addition, the operation of clearing the periodic transmission resource in the above may be performed only when the SCell is shifted from the activated state to the deactivated state. This is because when shifting from the dormant state to the deactivated state, a clearing operation is not required because there is no periodic transmission resource in the dormant state. As another method, only in the case that the periodic downlink transmission resource or the periodic uplink transmission resource is configured or is configured so as to be used, the periodic transmission resources may be cleared.
   ▪ The UE may flush all HARQ buffers configured for the cell or bandwidth part.
   ▪ If there is a PUSCH transmission resource configured for periodic channel measurement reporting (semi-persistent CSI reporting) for the cell or bandwidth part, the UE may perform the PUSCH transmission resource.
   ▪ The UE may not transmit SRS for the cell or bandwidth part.
   ▪ For the cell or bandwidth part, the UE may not perform and report channel measurement (CSI, CQI, PMI, RI, PTI, CRI, or the like) for downlink.
   ▪ The UE may not transmit uplink data through UL-SCH in the cell or bandwidth part.
   ▪ The UE may not perform random access for the cell or bandwidth part.
   ▪ The UE may not monitor PDCCH in the cell or bandwidth part.
   ▪ The UE may not monitor the PDCCH for the cell or bandwidth part. In addition, even in the case of cross-scheduling, the UE may not monitor PDCCH for the cell in the cell to be scheduled.
   ▪ The UE may not perform PUCCH or SPUCCH transmission in the cell or bandwidth part.

First PDCP suspension (or resumption) proposed in the disclosure may include one or more UE operations among the following procedures. The procedure proposed above may be applied or configured to a bearer using the RLC UM mode or a bearer using the RLC AM mode, or the UE may perform the procedure proposed for the bearer using the RLC UM mode or the bearer using the RLC AM mode.
A transmission PDCP layer of the UE may reset a transmission window variable or may configure the transmission window variable to an initial value, or stored data (e.g., PDCP PDU or PDCP SDU) may be discarded. As another method, only a PDCP PDU may be discarded in order to prevent data loss. This is to prevent old data from being transmitted or retransmitted when a secondary cell group is activated or resumed at a later time.
In a reception PDCP layer of the UE, if a reordering timer (t-reordering) (timer for reordering data in ascending order based on PDCP serial numbers or COUNT values) is running, the reordering timer may be suspended or reset. Alternatively, header decompression may be performed on stored data (e.g., PDCP SDU), and the data may be transferred to an upper layer in ascending order of COUNT values. The reception PDCP layer of the UE may reset a reception window variable or may configure the reception window variable to an initial value.

Second PDCP suspension (or resumption) proposed in the disclosure may include one or a plurality of UE operations among the following procedures. The procedure proposed above may be applied or configured to a bearer using the RLC UM mode or a bearer using the RLC AM mode, or the UE may perform the procedure proposed for the bearer using the RLC UM mode or the bearer using the RLC AM mode.
The transmission PDCP layer of the UE may maintain a variable value as it is without resetting a transmission window variable or configuring the transmission window variable to an initial value. The reason for maintaining the variable value (e.g., COUNT value) is to solve a security issue caused by transmitting different data with the same security key (e.g., COUNT value) when the secondary cell group is activated or resumed. The transmission PDCP layer of the UE may discard stored data (e.g., PDCP PDU or PDCP SDU). As another method, only a PDCP PDU may be discarded in order to prevent data loss. This is to prevent old data from being transmitted or retransmitted when a secondary cell group is activated or resumed at a later time. As another method, the transmission PDCP layer may store the transmission window variables and reset the window variables (e.g., configured to 0). In addition, if the security configuration information is changed when resuming or activating the cell group, or if the security configuration information is included in a message indicating resumption or activation of the cell group, or if a security key change is indicated, the above reset window variables may be used. Alternatively, if security configuration information is not changed when resuming or activating the cell group, or if security configuration information is not included in the message indicating resumption or activation of the cell group, or if a security key change is not indicated, the above stored transmission window variables may be restored, or the above stored transmission window variables may be configured, reconfigured, or reset and used as the transmission window variables.
In a reception PDCP layer of the UE, if a reordering timer (t-reordering) (timer for reordering data in ascending order based on PDCP serial numbers or COUNT values) is running, the reordering timer may be suspended or reset. Alternatively, header decompression may be performed on stored data (e.g., PDCP SDU), and the data may be transferred to an upper layer in ascending order of COUNT values. The reception PDCP layer of the UE may maintain a variable value without resetting a reception window variable or configuring the reception window variable to an initial value. The reason for maintaining the variable value (e.g., COUNT value) is to solve a security issue caused by transmitting different data with the same security key (e.g., COUNT value) when the secondary cell group is activated or resumed. As another method, when the UE activates or resumes the secondary cell group, or receives data, the UE may configure or update an RX_NEXT window variable (variable indicating a COUNT value of data expected to be received next) to a value of an RX DELIV window variable (variable indicating a COUNT value corresponding to the next data of data transferred to an upper layer) or a COUNT value of data that the UE receives for the first time, in order to prevent the reordering timer from being immediately triggered even if there is no COUNT value or no PDCP serial number gap. As another method, when a reordering timer value is configured via the message or when an indicator is received from an upper layer, an RX_REORD (variable indicating a COUNT value of the next data of data having triggered the reordering timer) window variable may be configured or updated to a variable value of the RX_NEXT window variable, or the reordering timer may be suspended or restarted. As another method, the reception PDCP layer may store the reception window variables and reset the window variables (e.g., configured to 0). In addition, if the security configuration information is changed when resuming or activating the cell group, or if the security configuration information is included in a message indicating resumption or activation of the cell group, or if a security key change is indicated, the above reset window variables may be used. Alternatively, if security configuration information is not changed when resuming or activating the cell group, or if security configuration information is not included in the message indicating resumption or activation of the cell group, or if a security key change is not indicated, the above stored reception window variables may be restored, or the above stored reception window variables may be configured, reconfigured, or reset and used as the reception window variables.

When the UE receives an indicator (e.g., via DCI of PDCCH, MAC control information, or an RRC message) or configuration information for releasing, deactivating, reconfiguring, or suspending dual connectivity, a cell group (e.g., secondary cell group), or a cell, and the UE performs the proposed UE operations, if data to be transmitted by the UE via an uplink is occurred or generated, the UE may transmit a scheduling request (SR) or MAC control information (or indicator, buffer amount, or buffer state report) to a master base station or secondary base station in a PUCCH transmission resource configured via an RRC message so as to request an uplink transmission resource or request configuration, addition, deactivation, resumption, change, or reconfiguration of the dual connectivity, the cell group (e.g., secondary cell group), or the cell. As another method, when the UE receives an indicator (e.g., via DCI of PDCCH, MAC control information, or an RRC message) or configuration information for releasing, deactivating, reconfiguring, or suspending dual connectivity, a cell group (e.g., a secondary cell group), or a cell, and the UE performs the proposed UE operations, if data to be transmitted by the UE via an uplink is occurred or generated, the UE may generate an RRC message and transmit the RRC message to a master base station or a secondary base station so as to request an uplink transmission resource, or request configuration, addition, activation, resumption, change, or reconfiguration of the dual connectivity, the cell group (e.g., a secondary cell group), or the cell.

The procedures proposed in the disclosure may be extended to multi-connectivity. For example, configuration information of a plurality of cell groups may be configured for the UE via an RRC message, one or more cell groups (or cells) among the configured plurality of cell groups may be activated or resumed via an indicator of PDCCU, MAC control information, or an RRC message, or one or more cell groups may be suspended or deactivated.

Hereinafter, as proposed in the disclosure, when a secondary cell group or a PSCell of a secondary cell group is deactivated or suspended by deactivation or suspension of the cell group or cell, and when uplink data for the secondary cell group (or in bearers belonging to the secondary cell group) is generated in the UE, a UE operation for reactivating or resuming the cell group or cell is proposed.

If, as proposed in the disclosure, a cell group or a cell is deactivated or suspended, since the UE is unable to transmit or receive data, if uplink data is generated in the secondary cell group (or in bearers belonging to the secondary cell group) of the UE, the cell group or cell may need to be reactivated or resumed. Requesting reactivation or resumption of a cell group or a cell from the base station (maser base station or secondary base station) by the UE may be performed according to one of the following method or a method extended by a combination or application of the following methods.
First method: The UE configures a message (e.g., RRC message) for requesting reactivation or resumption of a secondary cell group or a cell, and transmits the configured message to a master base station. When the message is received, the master base station, as in the first signaling of FIG. 11 proposed in the disclosure, may request resumption and receive a response from a secondary base station, and may configure a message (e.g., RRC message) indicating reactivation or resumption of the secondary cell group, so as to transmit the configured message to the UE. As another method, as in the second signaling of FIG. 12, a master base station may configure a message (e.g., RRC message) indicating reactivation or resumption of a secondary cell group and may transmit the configured message to the UE, and then the UE may indicate activation or resumption to the secondary base station. As another method, as in the third signaling of FIG. 13, the UE may configure a message (e.g., RRC message) for requesting reactivation or resumption of a secondary cell group or a cell and may transmit the configured message to the secondary base station via SRB3, and the secondary base station may configure a message (e.g., RRC message) indicating reactivation or resumption of the secondary cell group and may transmit the configured message to the UE, and then activation or resumption may be indicated to a master base station.
Second method: The UE configures a message (e.g., MAC control information) for requesting reactivation or resumption of a secondary cell group or a cell, and transmits the configured message to a master base station. When the message is received, the master base station, as in the first signaling of FIG. 11 proposed in the disclosure, may request resumption and receive a response from a secondary base station, and may configure a message (e.g., RRC message or MAC control information) indicating reactivation or resumption of the secondary cell group, so as to transmit the configured message to the UE. As another method, as in the second signaling of FIG. 12, a master base station may configure a message (e.g., RRC message or MAC control information) indicating reactivation or resumption of a secondary cell group and may transmit the configured message to the UE, and then the UE may indicate activation or resumption to the secondary base station. As another method, as in the third signaling of FIG. 13, the UE may configure a message (e.g., MAC control information) for requesting reactivation or resumption of a secondary cell group or a cell and may transmit the configured message to the secondary base station via SRB3, and the secondary base station may configure a message (e.g., RRC message or MAC control information) indicating reactivation or resumption of the secondary cell group and may transmit the configured message to the UE, and then activation or resumption may be indicated to a master base station. When cell group activation or resumption is requested or indicated via MAC control information, the MAC control information may be newly defined and designed. As another method, a new value (field value or identifier value) may be defined and indicated or a new field (or indicator) may be defined in existing MAC control information (e.g., buffer state report).
Third method: The UE configures a message (e.g., physical signal of a PHY layer) for requesting reactivation or resumption of a secondary cell group or a cell, and transmits the configured message to a master base station. When the message is received, the master base station, as in the first signaling of FIG. 11 proposed in the disclosure, may request resumption and receive a response from a secondary base station, and may configure a message (e.g., RRC message or physical signal of a PHY layer) indicating reactivation or resumption of the secondary cell group, so as to transmit the configured message to the UE. As another method, as in the second signaling of FIG. 12, a master base station may configure a message (e.g., RRC message or physical signal of a PHY layer) indicating reactivation or resumption of a secondary cell group and may transmit the configured message to the UE, and then the UE may indicate activation or resumption to the secondary base station. As another method, as in the third signaling of FIG. 13, the UE may configure a message (e.g., physical signal of a PHY layer) for requesting reactivation or resumption of a secondary cell group or a cell and may transmit the configured message to the secondary base station via SRB3, and the secondary base station may configure a message (e.g., RRC message or physical signal of a PHY layer) indicating reactivation or resumption of the secondary cell group and may transmit the configured message to the UE, and then activation or resumption may be indicated to a master base station.

When cell group activation or resumption is requested or indicated via a physical signal of a PHY layer, the physical signal of the PHY layer may be defined and designed with a new transmission resource (e.g., new scheduling request (SR) transmission resource (e.g., PUCCH transmission resource of a PCell or PSCell) for the secondary cell group, or new field of DCI (PDCCH transmission resource transmitted from a PSCell or transmitted from a PCell) of PDCCH). As another method, a new field (or indicator) may be defined, or a new value (field value or identifier value) may be defined and indicated in a physical signal (e.g., scheduling request (SR) transmission resource (e.g., PUCCH transmission resource of a PCell or PSCell) or field (PDCCH transmission resource transmitted from a PSCell or transmitted from a PCell) of DCI of PDCCH) of an existing PHY layer. As another method, when the UE performs PDCCH monitoring with a long cycle for the PSCell of the secondary cell group by applying second DRX configuration information, or when the secondary cell group of the UE is deactivated or suspended, if random access is triggered for the UE in the PSCell via DCI of PDCCH, the UE may interpret the indication as activation or resumption of the secondary cell group. In the above, the physical transmission resource may mean a transmission resource for random access, and the UE may perform random access when uplink data for the secondary cell group is generated while the secondary cell group is suspended or deactivated as described above. As another method, if uplink data for the secondary cell group is generated while the secondary cell group is suspended or deactivated, the SR transmission resource may be transmitted to the master cell group or secondary cell group in the case that the SR transmission resource is configured (or the TA timer is running) In the case that the SR transmission is not configured (or if the TA timer expires), the UE may perform random access. In the above, the random access may be performed with contention based random access (CBRA). As another method, if the random access configuration information (dedicated RACH config or dedicated preamble) specified in the above message indicating suspension or deactivation of the cell group (or previously received message) is configured (or included), contention free random access (CFRA) may be performed. Alternatively, if the random access configuration information (dedicated RACH config or dedicated preamble) specified in the message indicating deactivation or suspension of the cell group (or previously received message) is not configured (or included), the contention based random access (CBRA) may be performed. In the above, the UE may indicate the base station with an indicator (e.g., buffer state reporting (MAC control information (MAC control element)) that uplink data is generated during the random access or after completing the random access. Upon receiving the indicator or completing the random access, the base station (e.g., secondary base station or master base station) may transmit a message indicating the UE to resume or activate the secondary cell group to the UE to resume or activate the secondary cell group, so that data transmission or reception can be performed again.

As proposed by the disclosure, if the cell group or cell is deactivated or suspended, the UE cannot transmit or receive data, so if the uplink data is generated in the deactivated secondary cell group (or PSCell) of the UE (or bearers (e.g., SCG DRB) belonging to the secondary cell group), the UE may perform the first method, second method, or third method proposed above in order to request the network (or base station or MCG or SCG) to reactivate or resume the cell group or cell. Hereinafter, the disclosure proposes specific conditions for performing or triggering the first method, the second method, or the third method.

Hereinafter, the disclosure proposes a first embodiment of the specific condition for performing or triggering the first method, second method or third method proposed above in order for the UE to request the reactivation or resumption of the cell group (e.g., SCG) or cell to the network (or base station or MCG or SCG) as follows.

In the first embodiment proposed by the disclosure, if the uplink data is generated in the deactivated secondary cell group (or PSCell) of the UE (or bearers (e.g., SCG DRB) belonging to the deactivated secondary cell group), an RRC layer or upper layer (or application layer or PDCP layer) of the UE identifies the generation of the uplink data and performs or triggers the first method, second method or third method proposed by the disclosure. Therefore, in the case that the secondary cell group (or PSCell) of the UE is deactivated, the RRC layer or upper layer (or application layer or PDCP layer) of the UE identifies whether the uplink data is generated (or occurred) in the above cell group (or bearers (e.g., SCG DRB) belonging to the secondary cell group), and if it is generated, may perform or trigger the first method, second method, or third method proposed by the disclosure.

Hereinafter, the disclosure proposes a second embodiment of the specific condition for performing or triggering the first method, second method or third method proposed above in order for the UE to request the reactivation or resumption of the cell group (e.g., SCG) or cell to the network (or base station or MCG or SCG) as follows.

In the second embodiment proposed by the disclosure, if the uplink data is generated in the deactivated secondary cell group (or PSCell) of the UE (or bearers (e.g., SCG DRB) belonging to the deactivated secondary cell group), a MAC layer (or MAC layer (SCG MAC) corresponding to the secondary cell group) of the UE identifies the generation of the uplink data and performs or triggers the first method, second method or third method proposed by the disclosure. In the case that the secondary cell group (or PSCell) of the UE is deactivated, the MAC layer (or MAC layer (SCG MAC) corresponding to the secondary cell group) of the UE identifies whether the uplink data is generated (or occurred) in the above cell group (or bearers (e.g., SCG DRB) belonging to the secondary cell group). In the case that the uplink data is generated, the specific conditions for performing or triggering the first method, second method, or third method proposed by the disclosure are as follows. The condition of the second embodiment is that when data is generated for a certain logical channel regardless of which logical channel belongs to which logical channel group, the first method, second method, or third method proposed by the disclosure can be performed or triggered. This is a condition for considering all cases in which uplink data occurs because even if a logical channel is configured, the logical channel may be configured not to belong to any logical channel group.
1> If uplink data is generated for a certain logical channel in the MAC layer corresponding to the deactivated secondary cell group (or configured in the MAC layer), and if there is no uplink data that can be transmitted on any logical channel (or other logical channels) among the logical channels (for example, if UL data for a logical channel becomes available to the MAC entity associated with deactivated SCG and none of the logical channels contains any available UL data or If the MAC entity is SCG MAC entity and the SCG is deactivated, it shall upon UL data arrival, for a logical channel, becomes available to the MAC entity and none of the logical channels contains any available UL data for the MAC entity),
   ▪2> the MAC layer corresponding to the secondary cell group may indicate an upper layer (or RRC layer) with an indicator that uplink data is occurred for the deactivated secondary cell group, or request the upper layer (or RRC layer) to report an indication that the uplink data is occurred (for example, the SCG MAC entity shall request upper layers to provide indication of UL data arrival for deactivated SCG). Based on this, the UE may perform or trigger the first method, second method, or third method proposed by the disclosure.

In the above, configuration information for each logical channel or each logical channel (LCH) (e.g., logical channel identifier, information on a logical channel group to which the logical channel identifier belongs (or logical channel group (LCG) identifier), priority, Bj value or maximum bucket value required for the LCP procedure, or the like) may be configured to the UE via the RRC message (e.g., RRCReconfiguration) proposed by the disclosure.

Hereinafter, the disclosure proposes a third embodiment of the specific condition for performing or triggering the first method, second method or third method proposed above in order for the UE to request the reactivation or resumption of the cell group (e.g., SCG) or cell to the network (or base station or MCG or SCG) as follows.

In the third embodiment proposed by the disclosure, if the uplink data is generated in the deactivated secondary cell group (or PSCell) of the UE (or bearers (e.g., SCG DRB) belonging to the deactivated secondary cell group), a MAC layer (or MAC layer (SCG MAC) corresponding to the secondary cell group) of the UE identifies the generation of the uplink data and performs or triggers the first method, second method or third method proposed by the disclosure. In the case that the secondary cell group (or PSCell) of the UE is deactivated, the UE identifies whether the uplink data is generated (or occurred) in the above cell group (or bearers (e.g., SCG DRB) belonging to the secondary cell group), and in the case of the generation of the uplink data, the specific conditions for performing or triggering the first method, second method, or third method proposed by the disclosure are as follows. The condition of the third embodiment is that the first method, second method, or third method proposed by the disclosure may be performed or triggered only when data is generated in a certain logical channel belonging to a certain logical channel group. This is a condition for considering only the case where uplink data occurs in a logical channel belonging to a certain logical channel group because even if a logical channel is configured, the logical channel may be configured not to belong to any logical channel group. The above condition is that the UE reports the amount of uplink data corresponding to the logical channel group in units of logical channel groups when performing the buffer status report (BSR), so only the data included in the buffer status report is considered as data requiring immediate transmission.
1> If uplink data is generated for a certain logical channel belonging to a certain logical channel group in the MAC layer corresponding to the deactivated secondary cell group (or configured in the MAC layer), and if there is no uplink data that can be transmitted on any logical channel (or other logical channels) among the logical channels belonging to a certain logical channel group (for example, if the MAC entity is SCG MAC entity and the SCG is deactivated, it shall upon UL data arrival, for a logical channel which belongs to an LCG, becomes available to the MAC entity and none of the logical channels which belong to an LCG contains any available UL data for the MAC entity),
   ▪2> the MAC layer corresponding to the secondary cell group may indicate an upper layer (or RRC layer) with an indicator that uplink data is occurred for the deactivated secondary cell group, or request the upper layer (or RRC layer) to report an indication that the uplink data is occurred (for example, the SCG MAC entity shall request upper layers to provide indication of UL data arrival for deactivated SCG). Based on this, the UE may perform or trigger the first method, second method, or third method proposed by the disclosure.

In the above, configuration information for each logical channel or each logical channel (LCH) (e.g., logical channel identifier, information on a logical channel group to which the logical channel identifier belongs (or logical channel group (LCG) identifier), priority, Bj value or maximum bucket value required for the LCP procedure, or the like) may be configured to the UE via the RRC message (e.g., RRCReconfiguration) proposed by the disclosure.

Hereinafter, the disclosure proposes a fourth embodiment of the specific condition for performing or triggering the first method, second method or third method proposed above in order for the UE to request the reactivation or resumption of the cell group (e.g., SCG) or cell to the network (or base station or MCG or SCG) as follows.

In the fourth embodiment proposed by the disclosure, if the uplink data is generated in the deactivated secondary cell group (or PSCell) of the UE (or bearers (e.g., SCG DRB) belonging to the deactivated secondary cell group), a MAC layer (or MAC layer (SCG MAC) corresponding to the secondary cell group) of the UE identifies the generation of the uplink data and performs or triggers the first method, second method or third method proposed by the disclosure.

In the case that the secondary cell group (or PSCell) of the UE is deactivated, the MAC layer (or MAC layer (SCG MAC) corresponding to the secondary cell group) of the UE identifies whether the uplink data is generated (or occurred) in the above cell group (or bearers (e.g., SCG DRB) belonging to the secondary cell group), and in the case of the generation of the uplink data, the specific conditions for performing or triggering the first method, second method, or third method proposed by the disclosure are as follows. The condition of the fourth embodiment is that the UE reports the amount of uplink data corresponding to the logical channel group in units of logical channel groups when performing the buffer status report (BSR), so only the data included in the buffer status report is considered as data requiring immediate transmission, and the UE performs and triggers the first method, second method or third method proposed by the disclosure. Even if a logical channel is configured, the logical channel may be configured not to belong to any logical channel group, so this is the condition that considers only the case where uplink data occurs in a logical channel belonging to a certain logical channel group
1> If regular buffer status report or periodic buffer status report is triggered in the MAC layer corresponding to the deactivated secondary cell group (for example, if the MAC entity is SCG MAC entity and the SCG is deactivated and if a Regular BSR (or a periodic BSR) is triggered for this MAC entity),
   ▪2> the MAC layer corresponding to the secondary cell group may indicate an upper layer (or RRC layer) with an indicator that uplink data is occurred for the deactivated secondary cell group, or request the upper layer (or RRC layer) to report an indication that the uplink data is occurred (for example, the SCG MAC entity shall request upper layers to provide indication of UL data arrival for deactivated SCG). Based on this, the UE may perform or trigger the first method, second method, or third method proposed by the disclosure.

Hereinafter, the disclosure proposes a method for allowing the UE to perform (or trigger) the proposed first method or second method and restricting the UE to perform or triggering the proposed third method in order to reactivate or resume the cell group or cell when the secondary cell group or the PSCell of the secondary cell group is deactivated by the deactivation or suspension of the cell group or cell, so the uplink data is generated for the secondary cell group (or bearers belonging to the secondary cell group) in the UE. This is because in the first method or the second method, the UE transmits a message (or indicator) requesting activation (or deactivation or release) of the secondary cell group to the network (or base station, MCG, or SCG) to request for the activation (or deactivation or release) of the secondary cell group, and the UE waits for an indication (or response or command) from the network accordingly. Therefore, in the first method or the second method, since the operation of the UE is determined according to the indication of the network, the network can easily control the UE. On the other hand, in the third method, the UE performs the procedure for activating the cell group by itself regardless of the indication (or response or command) of the network (e.g., because the UE transmits SR or performs random access), so the network may have difficulty controlling the UE. Therefore, in order to solve this problem, various embodiments that can be performed by the UE in the MAC layer corresponding to the secondary cell group are proposed.

As described above, the first embodiment in which the first or second method proposed by the disclosure is allowed and the third method proposed by the disclosure is restricted in order for the network to easily control the UE is as follows. The first embodiment proposes a method in which when the secondary cell group or the PSCell of the secondary cell group is deactivated by the deactivation or suspension of the cell group or cell in the disclosure, even if uplink data for the secondary cell group (or in bearers belonging to the secondary cell group) is generated in the UE, the regular buffer status report (regular BSR) is not triggered, so that scheduling request (SR) is not transmitted via PUCCH transmission resources or the random access is not performed. Specific conditions of the first embodiment are as follows.
1> If any of the following events (e.g., event 1/event 2) occurs, a buffer status report (BSR) may be triggered. If any of the following events occurs in the case that the cell group (or secondary cell group) is not deactivated (or the deactivated cell group is excluded) or in the case that the MAC layer does not correspond to the deactivated cell group (or secondary cell group), the buffer status reporting may be triggered. For example, even if any of the following events occurs in the MAC layer corresponding to the deactivated cell group (or secondary cell group), the buffer status reporting may not be triggered (for example, A BSR shall be triggered if any of the following events occur, except for deactivated SCG)
   ▪2> Event 1: If uplink data can be transmitted to the MAC layer for a certain logical channel belonging to a certain logical channel group (or if the uplink date occurs), or the MAC layer is not connected to the deactivated cell group (or secondary cell group) (for example, UL data, for a logical channel which belongs to an LCG, becomes available to the MAC entity not associated with deactivated SCG, and either), and in one of the following cases: buffer status reporting can be triggered.
      ♦3> In the case that the uplink data belongs to a certain logical channel that belongs to a certain logical channel group and has a higher priority than a certain logical channel having uplink data to be transmitted, the buffer status reporting may be triggered (for example, this UL data belongs to a logical channel with higher priority than the priority of any logical channel containing available UL data which belong to any LCG, or), or
      ♦3> In the case that none of the logical channels belonging to any logical channel group include uplink data to be transmitted, the buffer status reporting may be triggered (for example, none of the logical channels which belong to an LCG contains any available UL data.)
      ♦3> In the case that the buffer status reporting is triggered by event 1, the buffer status report may be referred to as a regular buffer status report (Regular BSR) (for example, in which case the BSR is referred below to as ‘Regular BSR’).
   ▪2> Event 2: If the timer configured to retransmit the buffer status report configured in the RRC message expires and at least one logical channel among the logical channels belonging to a certain logical channel group includes uplink data to be transmitted, the buffer status reporting can be triggered. In the case that the buffer status reporting is triggered by event 2, the buffer status report may be referred to as a regular buffer status report (Regular BSR) (for example, retxBSR-Timer expires, and at least one of the logical channels which belong to an LCG contains UL data in which case the BSR is referred below to as ‘Regular BSR’).

As another embodiment, a second embodiment in which in order for the network to easily control the UE as described, the first method or second method proposed by the disclosure is allowed, and the third method is restricted is as follows. The second embodiment proposes a method in which when the secondary cell group or the PSCell of the secondary cell group is deactivated by the deactivation or suspension of the cell group or cell in the disclosure, if uplink data for the secondary cell group (or in bearers belonging to the secondary cell group) is generated in the UE, the regular buffer status report (regular BSR) is triggered, but scheduling request (SR) is not transmitted via PUCCH transmission resources or the random access is not performed. Specific conditions of the second embodiment are as follows.
1> If any of the following events (e.g., event 1/event 2) occurs, a buffer status report (BSR) may be triggered. If any of the following events occurs regardless of whether the cell group (or secondary cell group) is deactivated (or activated), the buffer status reporting may be triggered. For example, even if any of the following events occurs in the MAC layer corresponding to the deactivated cell group (or secondary cell group), the buffer status reporting may be triggered.
   ▪2> Event 1: If uplink data can be transmitted to the MAC layer for a certain logical channel belonging to a certain logical channel group (or if the uplink date occurs) (for example, UL data, for a logical channel which belongs to an LCG, becomes available to the MAC entity, and either), and in one of the following cases: buffer status reporting can be triggered.
      ♦3> In the case that the uplink data belongs to a certain logical channel that belongs to a certain logical channel group and has a higher priority than a certain logical channel having uplink data to be transmitted, the buffer status reporting may be triggered (for example, this UL data belongs to a logical channel with higher priority than the priority of any logical channel containing available UL data which belong to any LCG, or), or
      ♦3> In the case that none of the logical channels belonging to any logical channel group include uplink data to be transmitted, the buffer status reporting may be triggered (for example, none of the logical channels which belong to an LCG contains any available UL data.)
      ♦3> In the case that the buffer status reporting is triggered by event 1, the buffer status report may be referred to as a regular buffer status report (Regular BSR) (for example, in which case the BSR is referred below to as ‘Regular BSR’).
   ▪2> Event 2: If the timer configured to retransmit the buffer status report configured in the RRC message expires and at least one logical channel among the logical channels belonging to a certain logical channel group includes uplink data to be transmitted, the buffer status reporting can be triggered. In the case that the buffer status reporting is triggered by event 2, the buffer status report may be referred to as a regular buffer status report (Regular BSR) (for example, retxBSR-Timer expires, and at least one of the logical channels which belong to an LCG contains UL data in which case the BSR is referred below to as ‘Regular BSR’).
1> In the above, if the buffer status reporting decides (or determines) that at least one buffer status reporting is triggered or is not canceled (for example, if the Buffer Status reporting procedure determines that at least one BSR has been triggered and not cancelled),
   ▪2> if there is a transmission resource of an uplink data channel for new transmission and if the transmission resource can include MAC control information and MAC subheader for buffer status reporting as a result of the LCP procedure (for example if UL-SCH resources are available for a new transmission and the UL-SCH resources can accommodate the BSR MAC CE plus its subheader as a result of logical channel prioritization),
      ♦3> the MAC layer may indicate to generate MAC control information for the buffer status reporting in the multiplexing and assembly procedure of the MAC layer (for example, instruct the multiplexing and assembly procedure to generate the BSR MAC CE(s)),
      ♦3> the timer configured to periodically transmit buffer status reports in RRC messages may be started or restarted in the case that the buffer status reports generated above are not long buffer status reports (BSRs) or short truncated buffer status reports (BSRs) (for example, start or restart periodicBSR-Timer except when all the generated BSRs are long or short Truncated BSRs),
      ♦3> the timer configured to retransmit buffer status reports in RRC messages may be started or restarted (for example, start or restart retxBSR-Timer.).
   ▪2> If any regular buffer status report is triggered, and the timer configured for SR transmission delay in the RRC message is not running, or if the MAC layer is not connected (or not configured) to the deactivated cell group (or secondary cell group) (for example, if a Regular BSR has been triggered and logicalChannelSR-DelayTimer is not running and if the MAC entity is not associated with deactivated SCG)
      ♦3> if there is no uplink data channel transmission resource for new transmission (for example, if there is no UL-SCH resource available for a new transmission), or
      ♦3> if the MAC layer is configured with a preset uplink transmission resource (configured uplink grant), and if the regular buffer status report is configured for the mask (distinguishment) (logicalChannelSR-Mask) for SR transmission of the logical channel, or
      ♦3> if the uplink data channel transmission resource for new transmission does not meet (or satisfy) the restrictions of the logical channel prioritization (LCP) procedure for the logical channel that triggered the buffer status reporting (for example, if the UL-SCH resources available for a new transmission do not meet the LCP mapping restrictions configured for the logical channel that triggered the BSR),
         •4> a procedure for scheduling request transmission may be triggered (trigger a Scheduling Request).

As proposed in the disclosure, when the UE activates or resumes a cell group (e.g., a secondary cell group) or a cell (e.g., PSCell) according to an indicator of an RRC message, MAC control information, or PDCCH, activation or resumption of the cell group or cell may be completed at a first time point. The first time point may be configured via an RRC message as proposed in the disclosure. For example, the RRC message may include time information (e.g., information indicating timing (e.g., X time unit, subframe unit, time slot unit, or symbol unit)) indicating when to activate, resume, deactivate, or suspend dual connectivity, a cell group (e.g., a secondary cell group), or a cell (PSCell or SCG SCell). For example, if the RRC message, MAC control information, or PDCCH indicating activation, resumption, deactivation, or suspension of the cell group (e.g., a secondary cell group) or cell (e.g., PSCell) is received in an nth time unit, time information indicating that the activation, resumption, deactivation, or suspension of the cell group or cell should be completed in an (n+X)th time unit may be configured. As another method, the time information (e.g., X) may not be configured by the base station, but may be predetermined and defined, and a fixed value may be used. For another example, after reception of the RRC message, MAC control information, or PDCCH indicating activation, resumption, deactivation, or suspension of the cell group (e.g., a secondary cell group) or cell (e.g., PSCell), when random access is started (or when a preamble is transmitted) or random access is successfully completed in an nth time unit, time information indicating that the activation, resumption, deactivation, or suspension of the cell group or cell should be completed in an (n+X)^{th} time unit may be configured. As another method, the time information (e.g., X) may not be configured by the base station, but may be predetermined and defined, and a fixed value may be used. When activation, suspension, deactivation, or resumption of the cell group or cell is completed, the UE may perform proposed UE operations according to a state (e.g., active, dormant, or deactivated) of each cell or bandwidth part, proposed in the disclosure. In addition, when activation or resumption of the cell group or cell is completed, a DRX operation of the UE may be started or restarted, or when deactivation or suspension of the cell group or cell is completed, the DRX operation of the UE may be suspended or deactivated.

As proposed in the disclosure, when the UE activates a cell group (e.g., a master cell group or a secondary cell group) or a cell (e.g., PSCell or SCell) according to an indication of MAC control information, activation of the cell may be completed at a second time point. The second time point may be configured via an RRC message as proposed in the disclosure. For example, the RRC message may include time information (e.g., information indicating timing (e.g., X time unit, subframe unit, time slot unit, or symbol unit)) indicating when to activate or deactivate frequency carrier aggregation, dual connectivity, a cell group (e.g., master cell group or secondary cell group), or a cell (MCG SCell or SCG SCell). For example, if MAC control information indicating activation or deactivation of a cell (e.g., SCell) is received in an nth time unit, time information indicating that the activation or deactivation of the cell should be completed in an (n+X)^{th} time unit may be configured. As another method, the time information (e.g., X) may not be configured by the base station, but may be predetermined and defined, and a fixed value may be used. For another example, after reception of MAC control information indicating activation or deactivation of a cell (e.g., SCell or PSCell), when random access is started (or when a preamble is transmitted) or random access is successfully completed in an nth time unit, time information indicating that the activation or deactivation of the cell should be completed in an (n+X)^{th} time unit may be configured. As another method, the time information (e.g., X) may not be configured by the base station, but may be predetermined and defined, and a fixed value may be used. When activation, suspension, deactivation, or resumption of the cell group or cell is completed, the UE may perform proposed UE operations according to a state (e.g., active, dormant, or deactivated) of each cell or bandwidth part, proposed in the disclosure. In addition, when activation or resumption of the cell group or cell is completed, a DRX operation of the UE may be started or restarted, or when deactivation or suspension of the cell group or cell is completed, the DRX operation of the UE may be suspended or deactivated.

As proposed in the disclosure, when the UE activates a cell group (e.g., master cell group or secondary cell group) or a cell (e.g., PSCell or SCell) according to an indication of an RRC message, activation of the cell may be completed at a third time point. The third time point may be configured via an RRC message as proposed in the disclosure. For example, the RRC message may include time information (e.g., information indicating timing (e.g., X time unit, subframe unit, time slot unit, or symbol unit)) indicating when to activate or deactivate frequency carrier aggregation, dual connectivity, a cell group (e.g., master cell group or secondary cell group), or a cell (MCG SCell, SCG SCell, or PSCell). For example, if the RRC message indicating activation or deactivation of a cell (e.g., SCell) is received in an nth time unit, time information indicating that the activation or deactivation of the cell should be completed in an (n+X)^{th} time unit may be configured. As another method, the time information (e.g., X) may not be configured by the base station, but may be predetermined and defined, and a fixed value may be used. For another example, after reception of the RRC message indicating activation or deactivation of a cell (e.g., SCell or PSCell), when random access is started (or when a preamble is transmitted) or random access is successfully completed in an nth time unit, time information indicating that the activation or deactivation of the cell should be completed in an (n+X)^{th} time unit may be configured. As another method, the time information (e.g., X) may not be configured by the base station, but may be predetermined and defined, and a fixed value may be used. X may be configured or predetermined based on a slot number, or may be configured or predetermined based on a shortest slot length among the configured PCell, PSCell, or SCells. When activation, suspension, deactivation, or resumption of the cell group or cell is completed, the UE may perform proposed UE operations according to a state (e.g., active, dormant, or deactivated) of each cell or bandwidth part, proposed in the disclosure. In addition, when activation or resumption of the cell group or cell is completed, a DRX operation of the UE may be started or restarted, or when deactivation or suspension of the cell group or cell is completed, the DRX operation of the UE may be suspended or deactivated.

The concept of a cell group proposed in the disclosure may be extended to a sub-cell group. For example, in the disclosure, in order to configure dual connectivity for a UE, a first cell group and a secondary cell group are configured, the first and secondary cell groups are applied as a master cell group and a secondary cell group to configure dual connectivity, and data transmission or reception may be performed with two base stations. However, if the concept of the cell group is extended to a sub-cell group, a plurality of sub-cell groups may be configured for the cell group, or a sub-cell group identifier may be configured for each sub-cell group, with respect to a UE connected to one base station. The UE performs data transmission or reception with one base station, but as proposed in the disclosure, activation, suspension, resumption, or deactivation may be extended and applied via an RRC message, MAC control information, or PDCCH for different frequencies or cells for each sub-cell group. For example, when the UE communicates with one base station via a plurality of frequencies or cells, the base station may configure, for the UE, a plurality of sub-cell groups to allow the UE to apply frequency carrier aggregation with respect to the plurality of frequencies or cells of the base station corresponding to the cell group (master cell group), fields indicating the respective sub-cell groups may be defined in an RRC message, MAC control information, or PDCCH, and thus the respective fields may indicate activation, deactivation, suspension, or resumption of the respective sub-cell groups. The UE may apply activation, suspension, resumption, or deactivation via an RRC message, MAC control information, or PDCCH, as proposed in the disclosure, for different frequencies or cells for each sub-cell group. As another method, the proposed sub-cell group may be implemented via introduction of downlink or uplink logical channel restriction for each cell. For example, configuration information that restricts logical channels belonging to one cell group to transmit or receive data only for a specific frequency or cell may be included in an RRC message so as to be configured for the UE. As described above, logical channels (e.g., logical channel identifiers) are configured by mapping to respective cells or frequencies, grouped, and regarded as the proposed sub-cell groups, fields indicating the respective cells may be defined in an RRC message, MAC control information, or PDCCH, and the respective fields may indicate activation, deactivation, suspension, or resumption of the respective cell.

In the disclosure, when the UE, for which dual connectivity has been configured, performs data transmission or reception with a master cell group or a secondary cell group, or when the secondary cell group is suspended or deactivated, if the master cell group detects a radio link failure, the UE may report the radio link failure to the secondary cell group or to the master cell group via the secondary cell group. For example, an RRC message for radio link failure reporting may configured, and the radio link failure may be transmitted and reported via split SRB1 or SRB3. When split SRB1 is configured, the radio link failure may be always reported via split SRB1. As another method, when the UE, for which dual connectivity has been configured, performs data transmission or reception with a master cell group or a secondary cell group, or when the secondary cell group is suspended or deactivated, if the master cell group detects a radio link failure, the UE may declare a radio link failure and may perform RRC connection re-establishment.

In the disclosure, when the UE, for which dual connectivity has been configured, performs data transmission or reception with a master cell group or a secondary cell group, or when the secondary cell group is suspended or deactivated, if the secondary cell group detects a radio link failure, the UE may report the radio link failure to the master cell group or to the secondary cell group via the master cell group. For example, an RRC message for radio link failure reporting may configured, and the radio link failure may be transmitted and reported via SRB1, split SRB1, or SRB3. When SRB1 or split SRB1 is configured, the radio link failure may be always reported via split SRB1.

In the disclosure, when dual connectivity is configured for the UE, releasing a secondary cell group means releasing the connection (data transmission or reception) with the secondary cell group or discarding or releasing configuration information of the secondary cell group (or bearer configuration information or protocol layer configuration information (PHY layer, MAC layer, RLC layer, PDCP layer or SDAP layer). On the other hand, suspending or deactivating the secondary cell group in the above means releasing or suspending the connection (data transmission or reception) with the secondary cell group, but maintaining, suspending or storing the configuration information of the secondary cell group (or bearer configuration information or protocol layer configuration information (PHY layer, MAC layer, RLC layer, PDCP layer or SDAP layer), or quickly resuming or activating the connection with the secondary cell group later, based on the stored configuration information of the secondary cell group.

Hereinafter, the disclosure proposes that in the case that the frequency measurement procedure or the frequency measurement reporting procedure is configured to the UE via the RRC message of the disclosure (e.g., RRCReconfiguration), or the dual connectivity is configured to the UE, or the frequency measurement procedure or the frequency measurement reporting procedure is configured for the cell group (or SCG), the UE prioritizes SRB3 and reports the frequency measurement result via SRB3, and only in the case that SRB3 is not configured, the UE reports the frequency measurement result via SRB1 (or SRB of MCG). However, the disclosure proposes that the UE does not perform measurement reporting via SRB3 in the case that the cell group (SCG) is deactivated. For example, the disclosure proposes that if SRB3 is configured only in the case that the cell group is not deactivated, the UE performs the frequency measurement result reporting via SRB3, or in the case that the cell group is deactivated, the UE performs the frequency measurement result reporting via SRB1 (or SRB of MCG). This is because if the cell group (SCG) is deactivated and the frequency measurement result is transmitted via SRB3, the cell group must be activated unnecessarily. The specific procedure of the UE is as follows.
1> If the UE is configured with a frequency measurement procedure or a frequency measurement reporting procedure,
   ▪2> if the UE is configured to (NG)EN-DC (or a case where the frequency measurement procedure or the frequency measurement reporting procedure is configured for the cell group (or SCG)),
      ♦3> if SRB3 is configured in the UE and the state of the cell group (SCG) is not configured to the deactivated state,
         •4> the UE transmits the frequency measurement result report message to the lower layer for transmission via SRB3.
      ♦3> otherwise,
         •4> the UE transmits the frequency measurement result report message to the lower layer for transmission via SRB1 (or MCG (E-UTRA) [symbol] SRB).
   ▪2> if the UE is configured to NR-DC or a case where the frequency measurement procedure or the frequency measurement reporting procedure is configured for the cell group (or SCG),
      ♦3> if SRB3 is configured in the UE and the state of the cell group (SCG) is not configured to the deactivated state,
         •4> the UE transmits the frequency measurement result report message to the lower layer for transmission via SRB3.
      ♦3> otherwise,
         •4> the UE transmits the frequency measurement result report message to the lower layer for transmission via SRB1 (or SRB of MCG (E-UTRA)).

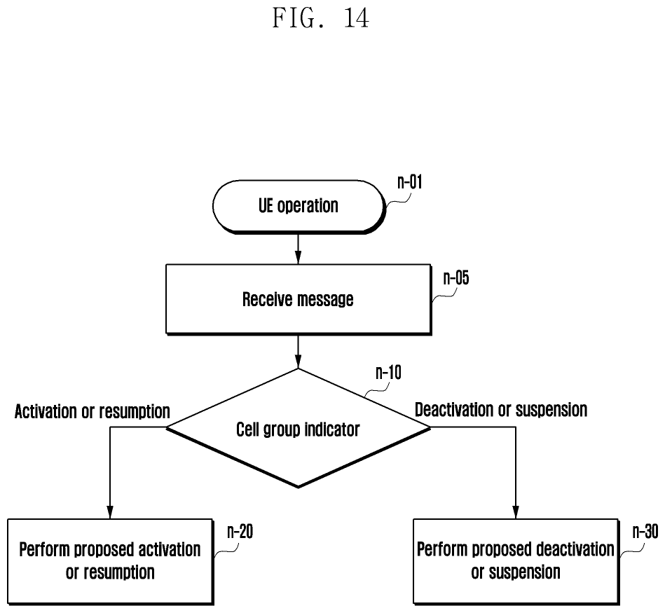

FIG. 14 is a diagram illustrating an operation of a UE according to an embodiment of the disclosure.

Referring to FIG. 14, a UE n-01 may receive a message (e.g., DCI of PDCCH, MAC control information, or RRC message) from a base station, n-05. In the case that the message includes cell group configuration information, a cell group state, or a cell group indicator, the UE may determine n-10 whether configuration, addition, activation, or resumption of a cell group is indicated, or whether releasing, deactivation, or suspension of the cell group is indicated. If configuration, addition, activation, or resumption of the cell group is indicated, cell group configuration, addition, activation, or resumption, proposed in the disclosure, may be performed in operation n-20, and if releasing, deactivation, or suspension of the cell group is indicated, cell group releasing, deactivation, or suspension, proposed in the disclosure, may be performed in operation n-30.

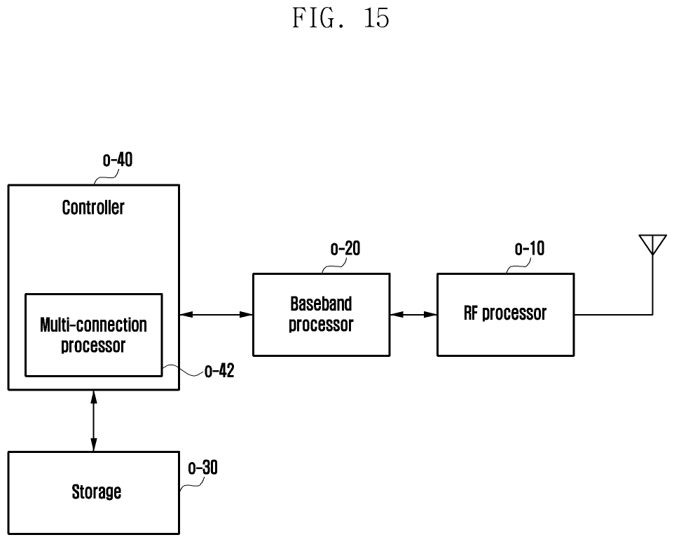

FIG. 15 illustrates a structure of a UE to which according to an embodiment of the disclosure.

Referring to FIG. 15, the UE may include a radio frequency (RF) processor o-10, a baseband processor o-20, a storage unit o-30, and a controller o-40.

The RF processor o-10 performs a function for transmitting or receiving a signal via a radio channel, such as signal band transform and signal amplification. For example, the RF processor o-10 up-converts a baseband signal provided from the baseband processor o-20 into an RF band signal, transmits the converted RF band signal via an antenna, and then down-converts the RF band signal received via the antenna into a baseband signal. For example, the RF processor o-10 may include a transmission filter, a reception filter, an amplifier, a mixer, an oscillator, a digital-to-analog convertor (DAC), an analog-to-digital convertor (ADC), and the like. In the drawing, only one antenna is illustrated, but the UE may have multiple antennas. The RF processor o-10 may include a plurality of RF chains. The RF processor o-10 may perform beamforming. For the beamforming, the RF processor o-10 may adjust a phase and a magnitude of each of signals transmitted or received via a plurality of antennas or a plurality of antenna elements. In addition, the RF processor may perform MIMO, and may receive a plurality of layers when performing MIMO operations. The RF processor o-10 may perform reception beam sweeping by appropriately configuring the plurality of antennas or antenna elements under the control of the controller, or may adjust the direction and beam width of a reception beam so that the reception beam is coordinated with a transmission beam.

The baseband processor o-20 performs conversion between a baseband signal and a bitstream according to a physical layer specification of a system. For example, during data transmission, the baseband processor o-20 generates complex symbols by encoding and modulating a transmission bitstream. In addition, when data is received, the baseband processor o-20 reconstructs a reception bitstream via demodulation and decoding of the baseband signal provided from the RF processor o-10. For example, in a case of conforming to an orthogonal frequency division multiplexing (OFDM) scheme, during data transmission, the baseband processor o-20 generates complex symbols by encoding and modulating a transmission bitstream, maps the complex symbols to sub-carriers, and then configures OFDM symbols by performing an inverse fast Fourier transform (IFFT) operation and cyclic prefix (CP) insertion. Further, during data reception, the baseband processor o-20 divides the baseband signal provided from the RF processor o-10 in units of OFDM symbols, reconstructs the signals mapped to the sub-carriers via a fast Fourier transform (FFT) operation, and then reconstructs the reception bitstream via demodulation and decoding.

The baseband processor o-20 and the RF processor o-10 transmit and receive signals as described above. Accordingly, the baseband processor o-20 and the RF processor o-10 may be referred to as a transmitter, a receiver, a transceiver, or a communication unit. Moreover, at least one of the baseband processor o-20 and the RF processor o-10 may include a plurality of communication modules to support a plurality of different radio access technologies. Further, at least one of the baseband processor o-20 and the RF processor o-10 may include different communication modules to process signals in different frequency bands. For example, the different radio access technologies may include an LTE network, an NR network, and the like. The different frequency bands may include a super high frequency (SHF) (e.g., 2.5 GHz and 5 GHz) band and a millimeter wave (e.g., 60 GHz) band.

The storage unit o-30 stores data, such as a default program, an application program, and configuration information, for operation of the UE. The storage unit o-30 provides stored data in response to a request of the controller o-40.

The controller o-40 may include a multi-connection processor 0-42 and controls overall operations of the UE. For example, the controller o-40 transmits or receives a signal via the baseband processor o-20 and the RF processor o-10. The controller o-40 records and reads data in the storage unit o-30. To this end, the controller o-40 may include at least one processor. For example, the controller o-40 may include a communication processor (CP) configured to perform control for communication and an application processor (AP) configured to control an upper layer, such as an application program.

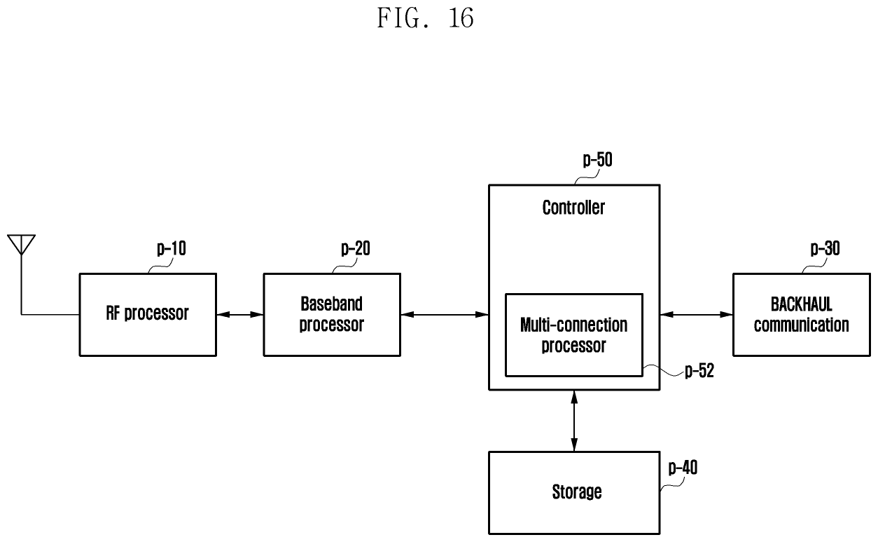

FIG. 16 is a block diagram illustrating a structure of a base station in a communication system to which according to an embodiment of the disclosure.

Referring to FIG. 16, the base station may be constituted to include an RF processor p-10, a baseband processor p-20, a backhaul communication unit p-30, a storage unit p-40, and a controller p-50.

The RF processor p-10 performs a function for transmitting or receiving a signal via a radio channel, such as signal band transform and signal amplification. For example, the RF processor p-10 up-converts a baseband signal provided from the baseband processor p-20 into an RF band signal, transmits the converted RF band signal via an antenna, and then down-converts the RF band signal received via the antenna into a baseband signal. For example, the RF processor p-10 may include a transmission filter, a reception filter, an amplifier, a mixer, an oscillator, a DAC, an ADC, and the like. In the drawing, only one antenna is illustrated, but a first access node may include a plurality of antennas. Further, the RF processor p-10 may include a plurality of RF chains. Moreover, the RF processor p-10 may perform beamforming. For the beamforming, the RF processor p-10 may adjust a phase and a magnitude of each of signals transmitted or received via the plurality of antennas or antenna elements. The RF processor may perform downlink MIMO by transmitting one or more layers.

The baseband processor p-20 performs a function of conversion between a baseband signal and a bitstream according to a physical layer specification of a first radio access technology. For example, during data transmission, the baseband processor p-20 generates complex symbols by encoding and modulating a transmission bitstream. Further, when data is received, the baseband processor p-20 reconstructs a reception bitstream via demodulation and decoding of the baseband signal provided from the RF processor p-10. For example, in a case of conforming to an OFDM scheme, during data transmission, the baseband processor p-20 generates complex symbols by encoding and modulating a transmission bitstream, maps the complex symbols to sub-carriers, and then configures OFDM symbols by performing IFFT operation and CP insertion. Further, during data reception, the baseband processor p-20 divides the baseband signal provided from the RF processor p-10 in units of OFDM symbols, reconstructs the signals mapped to the sub-carriers via an FFT operation, and then reconstructs the reception bitstream via demodulation and decoding. The baseband processor p-20 and the RF processor p-10 transmit and receive signals as described above. Accordingly, the baseband processor p-20 and the RF processor p-10 may be referred to as a transmitter, a receiver, a transceiver, a communication unit, or a wireless communication unit.

The communication unit p-30 provides an interface configured to perform communication with other nodes within a network.

The storage unit (memory) p-40 stores data, such as a default program, an application program, configuration information, for operation of the main base station. Particularly, the storage unit p-40 may store information on a bearer assigned to a connected UE, a measurement result reported from the connected UE, and the like. Further, the storage unit p-40 may store information serving as a criterion for determining whether to provide the UE with multi-connectivity or to suspend multi-connectivity. The storage unit p-40 provides stored data in response to a request of the controller p-50.

The controller p-50 may include a multi-connection processor p-52 and controls overall operations of the main base station. For example, the controller p-50 transmits or receives a signal via the baseband processor p-20 and the RF processor p-10 or via the backhaul communication unit p-30. Further, the controller p-50 records and reads data in the storage unit p-40. To this end, the controller p-50 may include at least one processor.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying whether an uplink (UL) data for a logical channel which belongs to a logical channel group (LCG) becomes available to a medium access control (MAC) entity associated with an activated cell group;
identifying whether the UL data belongs to a first logical channel with higher priority than a priority of at least one logical channel containing available UL data which belongs to at least one LCG, in case that the UL data becomes available to the MAC entity associated with the activated cell group; and
determining that a buffer state report (BSR) is triggered, in case that the UL data belongs to the first logical channel.

2. The method of claim 1, further comprising:
identifying that the at least one logical channel which belongs to the at least one LCG does not contain available UL data, in case that the UL data becomes available to the MAC entity associated with the activated cell group; and
determining that the BSR is triggered, in case that the at least one logical channel which belongs to the at least one LCG does not contain available UL data.

3. The method of claim 1, further comprising:
identifying that a retransmission BSR timer is expired;
identifying that the at least one logical channel which belongs to the at least one LCG contains the available UL data; and
determining that the BSR is triggered, in case that the retransmission BSR timer is expired and the at least one logical channel which belongs to the at least one LCG contains the available UL data.

4. The method of claim 3, wherein the retransmission BSR timer is configured based on a radio resource control (RRC) message.

5. The method of claim 1, wherein the triggered BSR is a regular BSR.

6. The method of claim 1, wherein the BSR is not triggered for a deactivated cell group even if the UL data becomes available to the MAC entity.

7. A terminal in a wireless communication system, the terminal comprising:
at least one processor configured to:
identify whether an uplink (UL) data for a logical channel which belongs to a logical channel group (LCG) becomes available to a medium access control (MAC) entity associated with an activated cell group,
identify whether the UL data belongs to a first logical channel with higher priority than a priority of at least one logical channel containing available UL data which belongs to at least one LCG, in case that the UL data becomes available to the MAC entity associated with the activated cell group, and
determine that a buffer state report (BSR) is triggered, in case that the UL data belongs to the first logical channel.

8. The terminal of claim 7, wherein the at least one processor is further configured to:
identify that the at least one logical channel which belongs to the at least one LCG does not contain available UL data, in case that the UL data becomes available to the MAC entity associated with the activated cell group, and
determine that the BSR is triggered, in case that the at least one logical channel which belongs to the at least one LCG does not contain available UL data.

9. The terminal of claim 7, wherein the at least one processor is further configured to:
identify that a retransmission BSR timer is expired,
identify that the at least one logical channel which belongs to the at least one LCG contains the available UL data, and
determine that the BSR is triggered, in case that the retransmission BSR timer is expired and the at least one logical channel which belongs to the at least one LCG contains the available UL data.

10. The terminal of claim 9, wherein the retransmission BSR timer is configured based on a radio resource control (RRC) message.

11. The terminal of claim 7, wherein the triggered BSR is a regular BSR.

12. The terminal of claim 7, wherein the BSR is not triggered for a deactivated cell group even if the UL data becomes available to the MAC entity.
